(19) United States
(12) Patent Application Publication
(10) Pub. No.: US 2024/0286177 A1
(43) Pub. Date: Aug. 29, 2024

(54) SUBMERSIBLE ROBOT SYSTEM

(71) Applicant: Bristola, LLC, Waukee, IA (US)

(72) Inventor: Jared Burma, Waukee, IA (US)

(21) Appl. No.: 18/588,214

(22) Filed: Feb. 27, 2024

Related U.S. Application Data
(60) Provisional application No. 63/487,183, filed on Feb. 27, 2023.

(51) Int. Cl. B08B 9/08; F04D 1/00; F04D 13/08; F04D 29/42

(52) U.S. Cl. CPC B08B 9/083; F04D 1/00; F04D 13/086; F04D 29/426; B08B 2209/08

(57) ABSTRACT

In one or more arrangements, a submersible robot system is presented with a head assembly having a motor, a pump assembly having a motor, a first drive member assembly having a motor, and a second drive member assembly having a motor. In one or more arrangements, the pump assembly is configured to pull material through the head of the assembly, and the first and second drive member assemblies are configured to drive the submersible robot system around a floor of an enclosed system to clean the floor of the closed system. In one or more arrangements, the submersible robot system is configured to enter the enclosed system through an opening in a wall of the enclosed system. In one or more arrangements, the opening is a circular, 24-inch diameter opening.

### CROSS-REFERENCE TO RELATED APPLICATIONS

This application claims priority to U.S. Provisional Application No. 63/487,183 entitled SUBMERSIBLE ROBOT SYSTEM, and filed on Feb. 27, 2023, the entirety of which is hereby incorporated by reference herein, including any figures, tables, drawings, and other information.

### FIELD OF THE DISCLOSURE

This disclosure relates to removal of waste material from floors. More specifically, this disclosure relates to a submersible robot system configured to clean and remove waste material from inaccessible floors.

### OVERVIEW OF THE DISCLOSURE

Removal of waste material from floors that are inaccessible during operation (inaccessible floors) conventionally requires halting operations to remove the waste material. For example, a floor may be inaccessible due to coverage with liquid, such as the floor of an anaerobic digester tank or anaerobic lagoon. Often times, tanks or lagoons have manholes near the exterior ground level to provide access into the tank or lagoon. These manholes are often times circular openings that measure approximately 24 inches in diameter, presenting a difficult, if not impossible, constraint for inserting materials or equipment into the tank or lagoon through the manholes.

For optimal performance, waste accumulation on the inaccessible floor is removed. Waste accumulates on an inaccessible floor under normal operating conditions. For example, with respect to inaccessible floors of anaerobic digester tanks or lagoons, the process of anaerobic digestion produces waste. During anaerobic digestion microorganisms (e.g. acetogenic bacteria, archaea) breakdown organic matter into biogas (e.g. methane, carbon dioxide) and solid and liquid digested material (e.g. waste) having elemental nutrients, such as nitrogen, phosphorus, and potassium. Biogas is used as a fuel for combustion and energy product. The waste may be further processed for other uses (e.g. fertilizer), may be recycled back into the digester, or may be discarded.

As an anaerobic digestion is carried out in the closed system of an anaerobic digester tank or lagoon that is sealed from the presence of oxygen, the anaerobic digester tank or lagoon fills with waste. This leads to reduced volume for anaerobic digestion to take place, with volume for anaerobic digestion reducing continuously as anaerobic digestion continues. Eventually anaerobic digester tank or lagoon require cleaning to remove the waste to maximize volume for anaerobic digestion to take place and to maintain the health of the microorganisms carrying out anaerobic digestion.

Conventional methods for cleaning anaerobic digester tanks and lagoons typically require manual cleaning, whereby production is first shut down, and the anaerobic digester tank or lagoon is vented and drained. After venting and draining, manual cleaning requires that a human enter the tank or lagoon to assist raking digested contents toward a vacuum where they can be removed. This manual process is both time consuming and hazardous.

The manual process of cleaning an anaerobic digester tank or lagoon can take at least two weeks, with additional time required to re-seed the anaerobic digester tank or lagoon with microorganisms to start anaerobic digestion. Not only does production cease all together during this cleaning period, but because cleaning requires shutting down the entire digester operation, anaerobic digester tanks and lagoons tend to be cleaned less frequently. Less frequent cleaning means that the anaerobic digester tank or lagoon operates at sub-optimal volume.

The manual process of cleaning an anaerobic digester tank or lagoon anaerobic digester tank or lagoon is hazardous for humans. Venting the anaerobic digester tank or lagoon requires releasing explosive and hazardous gasses that may be poisonous to humans (sulfuric acid and ammonia). Moreover, it is dangerous to put a human in a digester tank, as they encounter hazards in a confined space handling mechanical equipment.

Therefore, for all the reasons stated above, and the reasons stated below, there is a need in the art for an improved cleaning system for cleaning inaccessible floors without requiring shutting down operations to increase operational production. Thus, it is a primary objective of the disclosure to provide a submersible robot system which improves upon the state of the art.

Another objective of the disclosure is to provide a submersible robot system which is safe to operate.

Yet another objective of the disclosure is to provide a submersible robot system which is relatively easy to build.

Another objective of the disclosure is to provide a submersible robot system which is relatively friendly to build.

Yet another objective of the disclosure is to provide a submersible robot system which can be built relatively quickly and efficiently.

Another objective of the disclosure is to provide a submersible robot system which is easy to operate.

Yet another objective of the disclosure is to provide a submersible robot system which is relatively cost friendly to manufacture.

Another objective of the disclosure is to provide a submersible robot system which is relatively easy to transport.

Yet another objective of the disclosure is to provide a submersible robot system which is aesthetically appealing.

Another objective of the disclosure is to provide a submersible robot system which is robust.

Another objective of the disclosure is to provide a submersible robot system which is relatively inexpensive.

Yet another objective of the disclosure is to provide a submersible robot system which is not easily susceptible to wear and tear.

Another objective of the disclosure is to provide a submersible robot system which has a long useful life.

Yet another objective of the disclosure is to provide a submersible robot system which is efficient to use and operate.

These and other objects, features, or advantages of the disclosure will become apparent from the specification, figures, and claims.

### BRIEF DESCRIPTION OF THE DRAWINGS

FIG. 1 is a perspective view of a tank system with inaccessible floors, the tank system having a box system attached in order to facilitate the insertion and removal of a submersible robot system into the tank system to clean the inaccessible floors.

FIG. 2 is a perspective view of a lagoon system with inaccessible floors, the tank system having a box system attached in order to facilitate the insertion and removal of a submersible robot system into the lagoon system to clean the inaccessible floors.

FIG. 3 is a perspective view of a box system configured to be attached to a closed system with inaccessible floors; the box system configured to house and facilitate the insertion and removal of a submersible robot system into the closed system to clean the inaccessible floors.

FIG. 4 is a perspective view of a hose system configured to connect to a submersible robot system to facilitate the removal of materials from an inaccessible floor of a closed system being cleaned by the submersible robot system.

FIG. 5 is a perspective view of a hose connector of a hose system configured to connect the hose system to a submersible robot system to facilitate the removal of materials from an inaccessible floor of a closed system being cleaned by the submersible robot system.

FIG. 6 is a perspective view of a submersible robot system configured to clean an inaccessible floor of a closed system; the view showing the submersible robot system having a head assembly, a pump assembly, and drive member assemblies.

FIG. 7 is a side perspective view of a submersible robot system configured to clean an inaccessible floor of a closed system; the view showing the submersible robot system having a head assembly, a pump assembly, and drive member assemblies.

FIG. 8 is a front perspective view of a submersible robot system configured to clean an inaccessible floor of a closed system; the view showing the submersible robot system having a head assembly, a pump assembly, and drive member assemblies.

FIG. 9 is a side perspective view of a submersible robot system configured to clean an inaccessible floor of a closed system; the view showing the submersible robot system having a head assembly, a pump assembly, and drive member assemblies.

FIG. 10 is an exploded view of a submersible robot system configured to clean an inaccessible floor of a closed system; the view showing the submersible robot system having a first drive member assembly, a second drive member assembly, a head assembly, and a pump assembly.

FIG. 11 is another exploded view of a submersible robot system configured to clean an inaccessible floor of a closed system; the view showing the submersible robot system having a first drive member assembly, a second drive member assembly, a head assembly, and a pump assembly.

FIG. 12 is another exploded view of a submersible robot system configured to clean an inaccessible floor of a closed system; the view showing the submersible robot system having a first drive member assembly, a second drive member assembly, a head assembly, and a pump assembly.

FIG. 13 is a front perspective view of a head assembly of a submersible robot system; the view showing the head assembly having a frame, a motor assembly, and a cleaning attachment which, in the arrangement shown, is an auger member.

FIG. 14 is a side perspective view of a head assembly of a submersible robot system; the view showing the head assembly having a frame, a motor assembly, and a cleaning attachment which, in the arrangement shown, is an auger member.

FIG. 15 is a front elevation view of a head assembly of a submersible robot system; the view showing the head assembly having a cleaning attachment which, in the arrangement shown, is an auger member; the view also showing the head assembly having a motor assembly.

FIG. 16 is an exploded view of a head assembly of a submersible robot system; the view showing the head assembly having a frame, a motor assembly, and a cleaning attachment which, in the arrangement shown, is an auger member.

FIG. 17 is another exploded view of a head assembly of a submersible robot system; the view showing the head assembly having a frame, a motor assembly, and a cleaning attachment which, in the arrangement shown, is an auger member.

FIG. 18 is another exploded view of a head assembly of a submersible robot system; the view showing the head assembly having a frame, a motor assembly, and a cleaning attachment which, in the arrangement shown, is an auger member.

FIG. 19 is another exploded view of a head assembly of a submersible robot system; the view showing the head assembly having a frame, a motor assembly, and a cleaning attachment which, in the arrangement shown, is an auger member.

FIG. 20 is an exploded perspective view of a motor assembly of a head assembly of a submersible robot system; the view showing the motor assembly having a housing and a motor; the view showing the housing having a first end plate, a first coupler, a main tube, and a second end plate.

FIG. 21 is an exploded elevation view of a motor assembly of a head assembly of a submersible robot system; the view showing the motor assembly having a housing and a motor; the view showing the housing having a first end plate, a first coupler, a main tube, and a second end plate.

FIG. 22 is a perspective view of a pump assembly of a submersible robot system; the view showing the pump assembly having a pump, an exhaust assembly, a motor assembly, and a pump frame.

FIG. 23 is a front elevation view of a pump assembly of a submersible robot system; the view showing the pump assembly having a pump, an exhaust assembly, and a pump frame.

FIG. 24 is a perspective view of a pump assembly of a submersible robot system; the view showing the pump assembly having a pump, a motor assembly, and a pump frame.

FIG. 25 is another perspective view of a pump assembly of a submersible robot system; the view showing the pump assembly having a pump, a motor assembly, and a pump frame.

FIG. 26 is another perspective view of a pump assembly of a submersible robot system; the view showing the pump assembly having a pump, a motor assembly, and a pump frame.

FIG. 27 is an exploded view of an exhaust assembly of a pump assembly of a submersible robot system; the view showing the exhaust assembly having a base plate, a conduit, a coupling, and a connection member with tabs.

FIG. 28 is another exploded view of an exhaust assembly of a pump assembly of a submersible robot system; the view showing the exhaust assembly having a base plate, a conduit, a coupling, and a connection member with tabs.

FIG. 29 is a perspective view of a drive member assembly of a submersible robot system; the view showing the drive member assembly being a track assembly; the view showing the track assembly having a track system and a frame with an exterior wall.

FIG. 30 is a perspective view of a drive member assembly of a submersible robot system; the view showing the drive member assembly being a track assembly; the view showing the track assembly having a track system, a motor assembly, and a frame with an interior wall.

FIG. 31 is an elevation view of a drive member assembly of a submersible robot system; the view showing the drive member assembly being a track assembly; the view showing the track assembly having a track system, a motor assembly, and a frame.

FIG. 32 is an exploded view of a drive member assembly of a submersible robot system; the view showing the drive member assembly being a track assembly; the view showing the track assembly having a frame, a motor assembly, and a track system.

FIG. 33 is another exploded view of a drive member assembly of a submersible robot system; the view showing the drive member assembly being a track assembly; the view showing the track assembly having a frame, a motor assembly, and a track system.

FIG. 34 is another exploded view of a drive member assembly of a submersible robot system; the view showing the drive member assembly being a track assembly; the view showing the track assembly having a frame, a motor assembly, and a track system.

FIG. 35 is a perspective view of a motor assembly of a drive member assembly of a submersible robot system; the view showing the motor assembly having a housing and a gear assembly.

FIG. 36A is a side elevation view of a motor assembly of a drive member assembly of a submersible robot system; the view showing the motor assembly having a housing and a gear assembly.

FIG. 36B is a section view of a motor assembly of a drive member assembly of a submersible robot system; the view showing the motor assembly having a housing, a motor, and a gear assembly.

FIG. 37 is an exploded view of a motor assembly of a drive member assembly of a submersible robot system; the view showing the motor assembly having a housing, a motor, and a gear assembly.

FIG. 38 is another exploded view of a motor assembly of a drive member assembly of a submersible robot system; the view showing the motor assembly having a housing, a motor, and a gear assembly.

FIG. 39 is a perspective view of a robot control box configured to facilitate remote control of a submersible robot system configured to clean inaccessible floors of a closed system.

FIG. 40 is another perspective view of a robot control box configured to facilitate remote control of a submersible robot system configured to clean inaccessible floors of a closed system.

FIG. 41 is a wiring diagram of a robot control box configured to facilitate remote control of a submersible robot system configured to clean inaccessible floors of a closed system.

FIG. 42 is a perspective view of a pump control box configured to facilitate remote control of a submersible robot system configured to clean inaccessible floors of a closed system.

FIG. 43 is another perspective view of a pump control box configured to facilitate remote control of a submersible robot system configured to clean inaccessible floors of a closed system.

FIG. 44 is another perspective view of a pump control box configured to facilitate remote control of a submersible robot system configured to clean inaccessible floors of a closed system.

FIG. 45 is another perspective view of a pump control box configured to facilitate remote control of a submersible robot system configured to clean inaccessible floors of a closed system.

FIG. 46 is a wiring diagram of a pump control box configured to facilitate remote control of a submersible robot system configured to clean inaccessible floors of a closed system.

FIG. 47 is a perspective view of a remote controller configured to facilitate control of a submersible robot system configured to clean inaccessible floors of a closed system.

FIG. 48 is another perspective view of a remote controller configured to facilitate control of a submersible robot system configured to clean inaccessible floors of a closed system.

FIG. 49 is a wiring diagram of a remote controller configured to facilitate control of a submersible robot system configured to clean inaccessible floors of a closed system.

### SUMMARY OF THE DISCLOSURE

In one or more arrangements, a submersible robot system is presented with a head assembly having a motor, a pump assembly having a motor, a first drive member assembly having a motor, and a second drive member assembly having a motor. In one or more arrangements, the pump assembly is configured to pull material through the head of the assembly, and the first and second drive member assemblies are configured to drive the submersible robot system around a floor of an enclosed system to clean the floor of the closed system. In one or more arrangements, the submersible robot system is configured to enter the enclosed system through an opening in a wall of the enclosed system. In one or more arrangements, the opening is a circular, 24-inch diameter opening. In one or more arrangements, the motor of the pump assembly is sealed in a first housing, the motor of the head assembly is sealed in a second housing, the motor of the first drive member is sealed in a third housing, and the motor of the second drive member assembly is sealed in a fourth housing.

In one or more arrangements, a single electrical cable provides power to each of the motor of the pump assembly, the motor of the head assembly, the motor of the first drive member assembly, and the motor of the second drive member assembly.

In one or more arrangements, the motor of the first drive member includes a drive shaft and the motor of the second drive member includes a drive shaft. In one or more arrangements, an axis of rotation of the drive shaft of the motor of the first drive member is perpendicular to an axis of rotation of the first drive member. In one or more arrangements, an axis of rotation of the drive shaft of the motor of the second drive member is perpendicular to an axis of rotation of the second drive member.

In one or more arrangements, the pump assembly is removably attached to the head assembly and the first and second drive member assemblies. In one or more arrangements, when the head assembly is removed from the head assembly and the first and second drive member assemblies, a hose may be attached to the head assembly. In one or more arrangements, the hose is configured to pull material through the head assembly.

In one or more arrangements, the submersible robot system includes a controller assembly configured to control operation of the submersible robot system.

In one or more arrangements, the submersible robot system includes a hose system. In one or more arrangements, the hose system has an outer hose and an inner hose positioned within the outer hose. In one or more arrangements, a single electrical cable extends through the hose system and is positioned at least partially within the outer hose and outside of the inner hose. In one or more arrangements, the inner hose is configured to fluidly connect to the pump assembly. In one or more arrangements, the outer hose is configured to be filled within a gas to allow the hose system to be at least partially buoyant.

### DETAILED DESCRIPTION OF THE DISCLOSURE

In the following detailed description of the embodiments, reference is made to the accompanying drawings which form a part hereof, and in which is shown by way of illustration specific embodiments in which the disclosure may be practiced. The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure. It will be understood by those skilled in the art that various changes in form and details may be made without departing from the principles and scope of the invention. It is intended to cover various modifications and similar arrangements and procedures, and the scope of the appended claims therefore should be accorded the broadest interpretation so as to encompass all such modifications and similar arrangements and procedures. For instance, although aspects and features may be illustrated in or described with reference to certain figures or embodiments, it will be appreciated that features from one figure or embodiment may be combined with features of another figure or embodiment even though the combination is not explicitly shown or explicitly described as a combination. In the depicted embodiments, like reference numbers refer to like elements throughout the various drawings.

It should be understood that any advantages and/or improvements discussed herein may not be provided by various disclosed embodiments, or implementations thereof. The contemplated embodiments are not so limited and should not be interpreted as being restricted to embodiments which provide such advantages or improvements. Similarly, it should be understood that various embodiments may not address all or any objects of the disclosure or objects of the invention that may be described herein. The contemplated embodiments are not so limited and should not be interpreted as being restricted to embodiments which address such objects of the disclosure or invention. Furthermore, although some disclosed embodiments may be described relative to specific materials, embodiments are not limited to the specific materials or apparatuses but only to their specific characteristics and capabilities and other materials and apparatuses can be substituted as is well understood by those skilled in the art in view of the present disclosure.

It is to be understood that the terms such as “left, right, top, bottom, front, back, side, height, length, width, upper, lower, interior, exterior, inner, outer, and the like as may be used herein, merely describe points of reference and do not limit the present invention to any particular orientation or configuration.

As used herein, “and/or” includes all combinations of one or more of the associated listed items, such that “A and/or B” includes “A but not B,” “B but not A,” and “A as well as B,” unless it is clearly indicated that only a single item, subgroup of items, or all items are present. The use of “etc.” is defined as “et cetera” and indicates the inclusion of all other elements belonging to the same group of the preceding items, in any “and/or” combination(s). As used herein, the singular forms “a,” “an,” and “the” are intended to include both the singular and plural forms, unless the language explicitly indicates otherwise. Indefinite articles like “a” and “an” introduce or refer to any modified term, both previously-introduced and not, while definite articles like “the” refer to a same previously-introduced term; as such, it is understood that “a” or “an” modify items that are permitted to be previously-introduced or new, while definite articles modify an item that is the same as immediately previously presented. It will be further understood that the terms “comprises,” “comprising,” “includes,” and/or “including,” when used herein, specify the presence of stated features, characteristics, steps, operations, elements, and/or components, but do not themselves preclude the presence or addition of one or more other features, characteristics, steps, operations, elements, components, and/or groups thereof, unless expressly indicated otherwise. For example, if an embodiment of a system is described as comprising an article, it is understood the system is not limited to a single instance of the article unless expressly indicated otherwise, even if elsewhere another embodiment of the system is described as comprising a plurality of articles.

It will be understood that when an element is referred to as being “connected,” “coupled,” “mated,” “attached,” “fixed,” etc. to another element, it can be directly connected to the other element, and/or intervening elements may be present. In contrast, when an element is referred to as being “directly connected,” “directly coupled,” “directly engaged” etc. to another element, there are no intervening elements present. Other words used to describe the relationship between elements should be interpreted in a like fashion (e.g., “between” versus “directly between,” “adjacent” versus “directly adjacent,” “engaged” versus “directly engaged,” etc.). Similarly, a term such as “operatively”, such as when used as “operatively connected” or “operatively engaged” is to be interpreted as connected or engaged, respectively, in any manner that facilitates operation, which may include being directly connected, indirectly connected, electronically connected, wirelessly connected or connected by any other manner, method or means that facilitates desired operation. Similarly, a term such as “communicatively connected” includes all variations of information exchange and routing between two electronic devices, including intermediary devices, networks, etc., connected wirelessly or not. Similarly, “connected” or other similar language particularly for electronic components is intended to mean connected by any means, either directly or indirectly, wired and/or wirelessly, such that electricity and/or information may be transmitted between the components.

It will be understood that, although the ordinal terms “first,” “second,” etc. may be used herein to describe various elements, these elements should not be limited to any order by these terms unless specifically stated as such. These terms are used only to distinguish one element from another; where there are “second” or higher ordinals, there merely must be a number of elements, without necessarily any difference or other relationship. For example, a first element could be termed a second element, and, similarly, a second element could be termed a first element, without departing from the scope of example embodiments or methods.

Similarly, the structures and operations discussed herein may occur out of the order described and/or noted in the figures. For example, two operations and/or figures shown in succession may in fact be executed concurrently or may sometimes be executed in the reverse order, depending upon the functionality/acts involved. Similarly, individual operations within example methods described below may be executed repetitively, individually or sequentially, to provide looping or other series of operations aside from single operations described below. It should be presumed that any embodiment or method having features and functionality described below, in any workable combination, falls within the scope of example embodiments.

As used herein, various disclosed embodiments may be primarily described in the context of the removal of waste from inaccessible floors. However, the embodiments are not so limited. It is appreciated that the embodiments may be adapted for use in other applications which may be improved by the disclosed structures, arrangements and/or methods. The system is merely shown and described as being used in the context of the removal of waste from inaccessible floors for ease of description and as one of countless examples.

### Submersible Robot System

With reference to the figures, a submersible robot system (or simply “system 10”) is presented. System 10 is formed of any suitable size, shape, and design and is configured to facilitate cleaning of a floor of an enclosed space. In the arrangement shown, as one example, system 10 has a forward end 12, a rearward end 14, opposing left and right sides 16 (or simply “sides 16”), a top side 18, and a bottom side 20. In the arrangement shown, as one example, system 10 includes a head assembly 24, a pump assembly 26, drive member assemblies 28, and a control assembly 30, among other components as shown and described herein. While system 10 has been described according to the arrangement shown, as one example, any combination or arrangement may be used and is hereby contemplated for use.

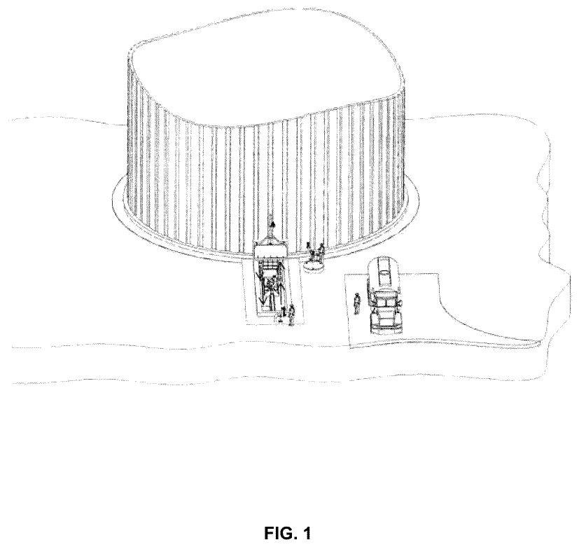

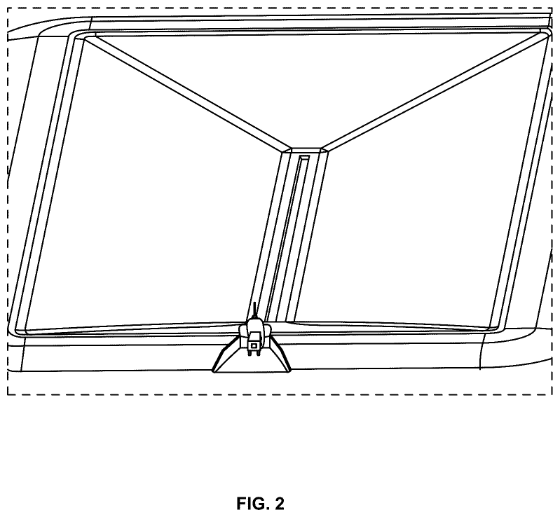

In the arrangement shown, as one example, system 10 is configured to clean the floors of an enclosed system. FIG. 1 shows an enclosed tank system, such as an anaerobic digester tank, which is one system where system 10 may be used. Additional or alternative enclosed tank systems where system 10 may be used include food and/or beverage storage tanks, wastewater tanks and water treatment tanks, renewable energy tanks, industrial and commercial tanks, and any other type of enclosed tank system. FIG. 2 shows a lagoon which is configured to be filled with liquids or other materials, which may subsequently be covered. System 10 may also be used to clean lagoons such as those shown in FIG. 2, which may be an anaerobic digester lagoon, a lagoon used in agricultural settings such as a manure lagoon, wastewater lagoons or water treatment lagoons, storage lagoons, or any other type of lagoon or similar body of liquid or other material with a floor. FIGS. 1 and 2 are provided as examples of the types of environments where system 10 may be used, however system 10 may be used in various other systems and environments in order to clean floors of such environments or systems.

In various arrangements, tanks or lagoons have 24-inch diameter manhole openings near the exterior ground level where the tank or lagoon is located. System 10 is configured to be inserted through the 24-inch diameter manhole opening. In various alternative arrangements, as examples, other sizes and shapes of manhole openings could be present in the tanks or lagoons. However, it is typical for these tanks or lagoons to have 24-inch diameter manhole openings at a minimum. Therefore, to facilitate insertion and removal from as many tanks or lagoons as possible, system 10 is configured to fit through the 24-inch manhole openings.

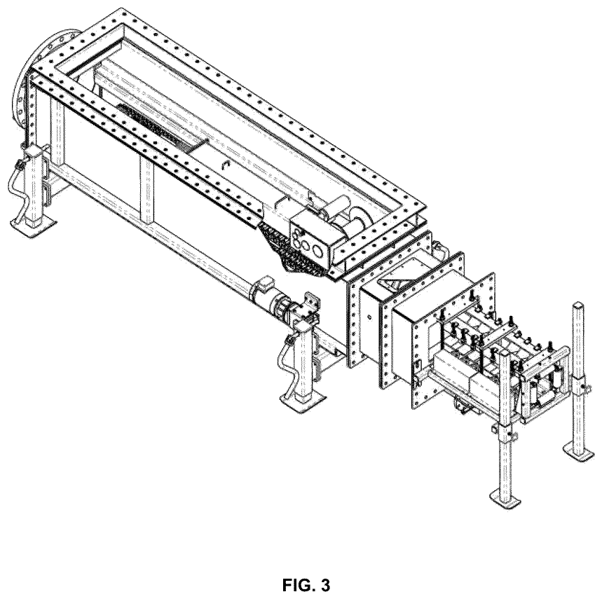

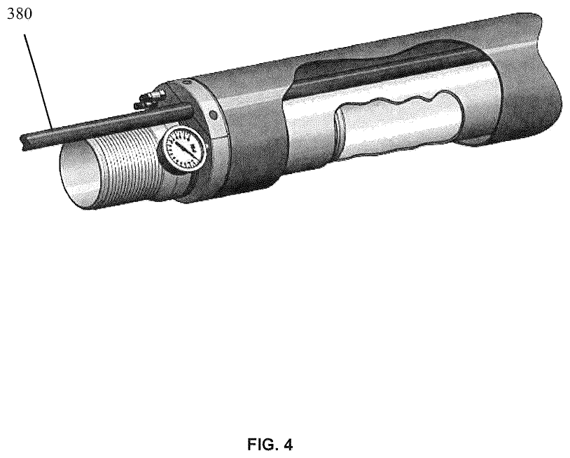

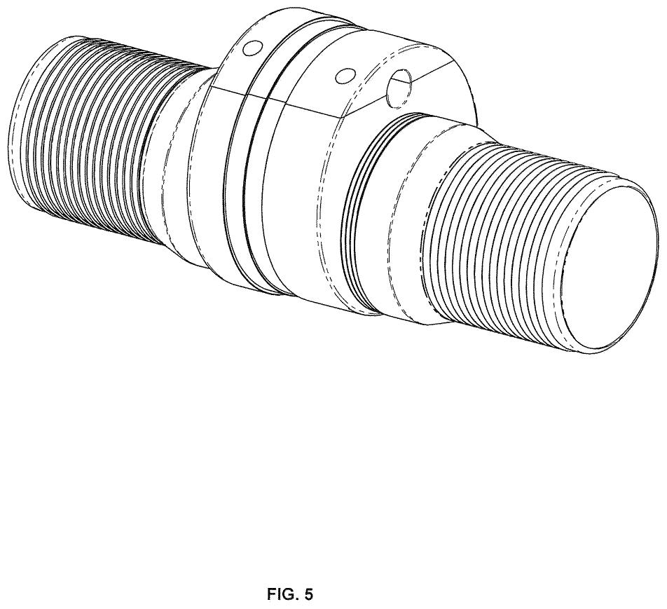

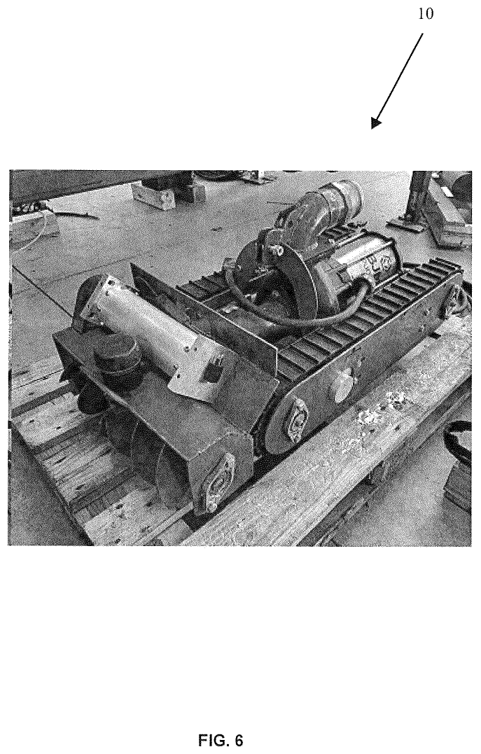

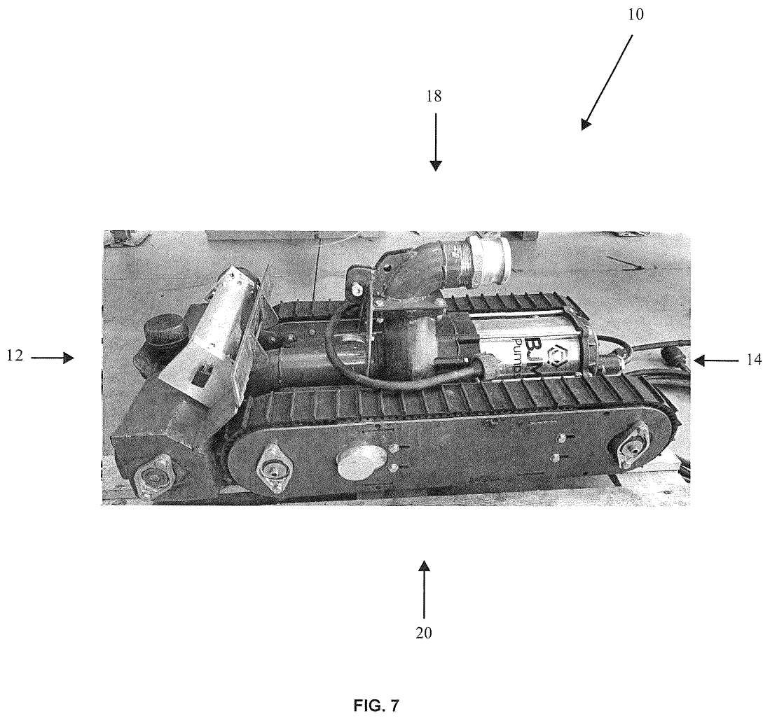

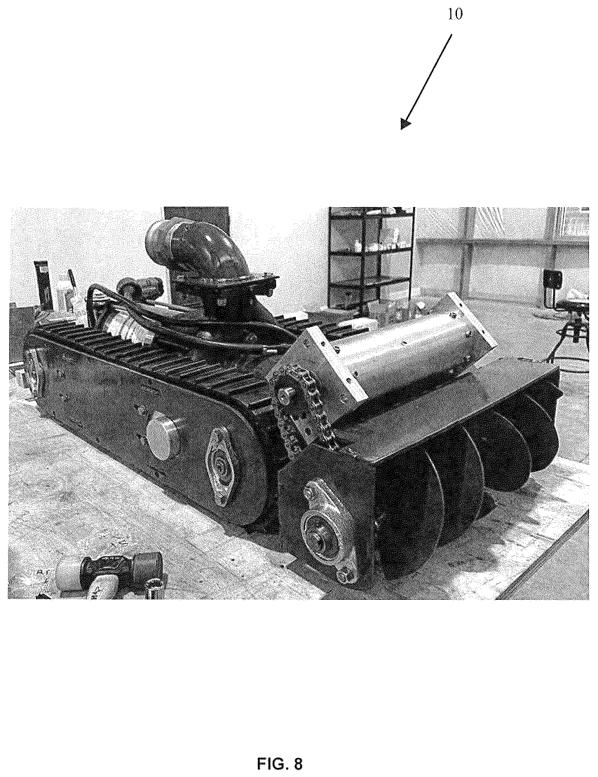

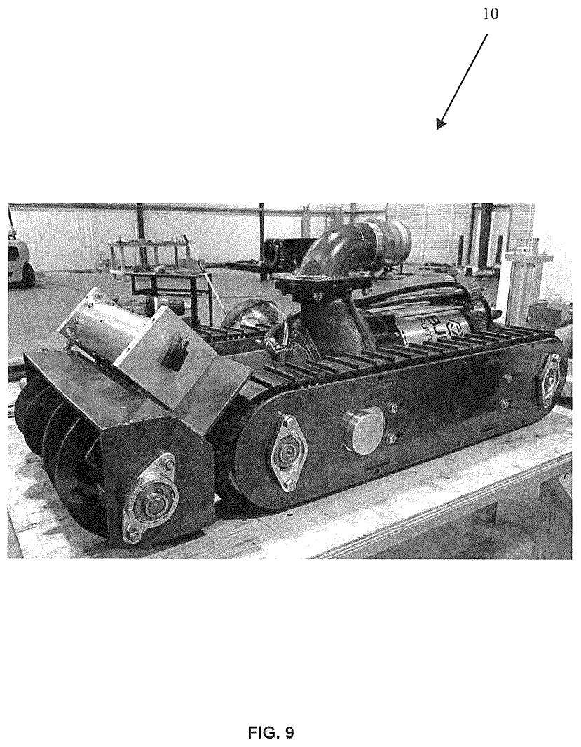

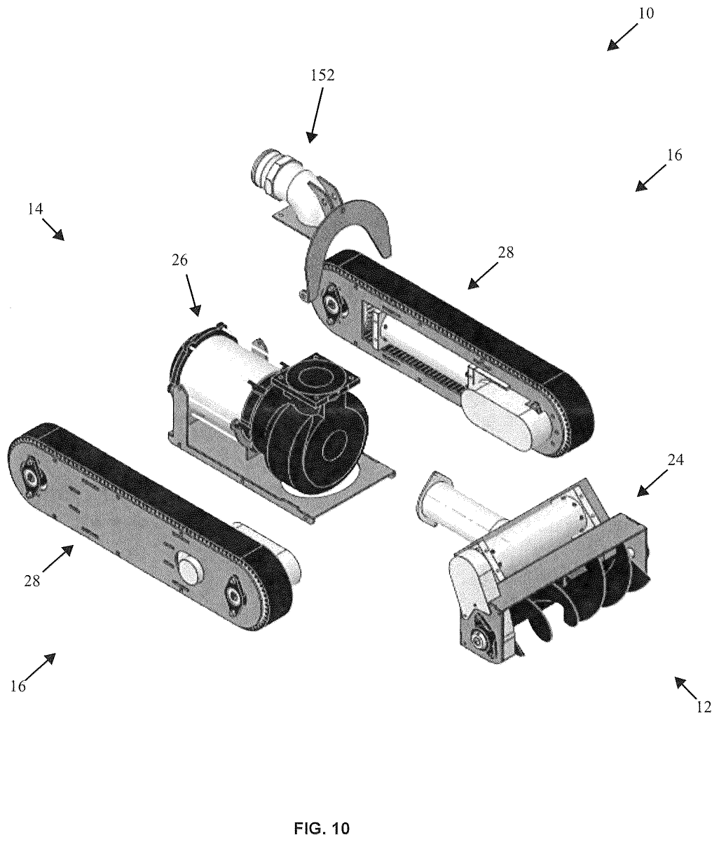

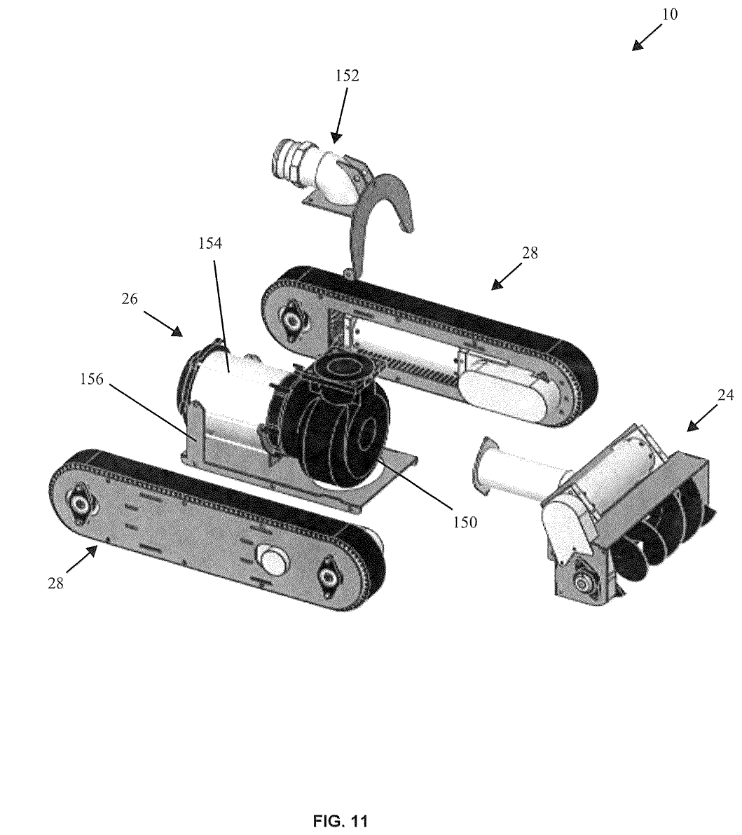

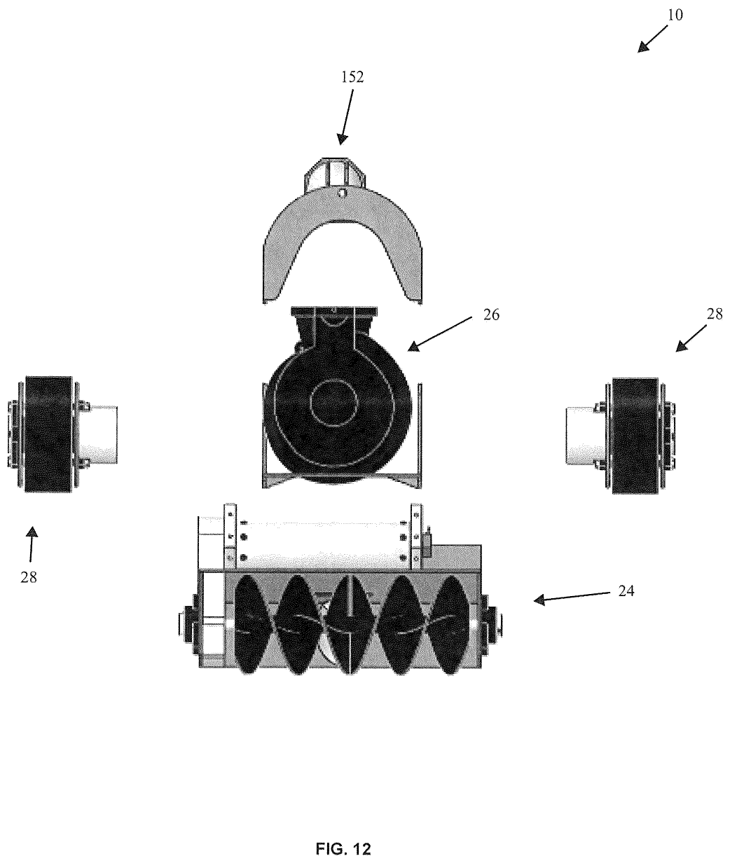

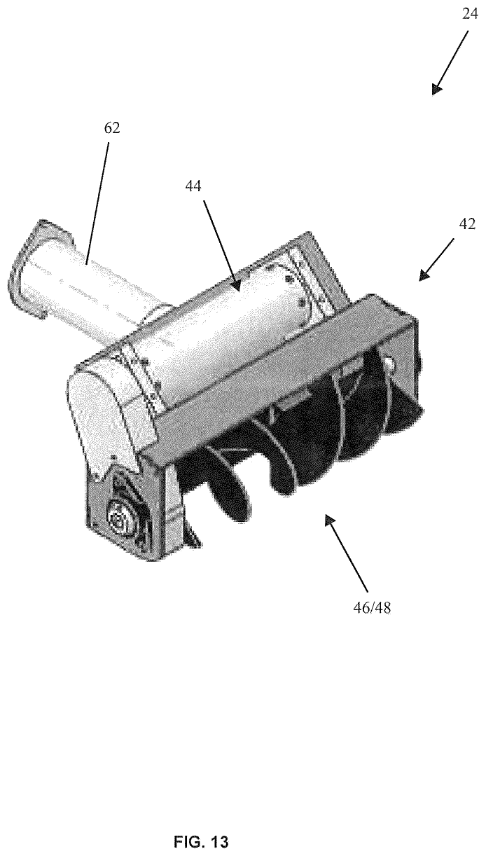

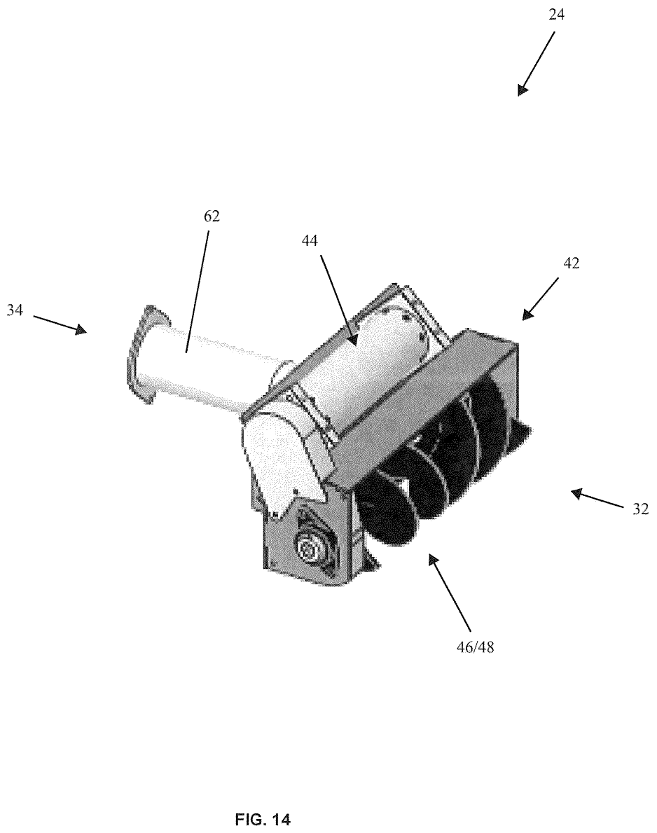

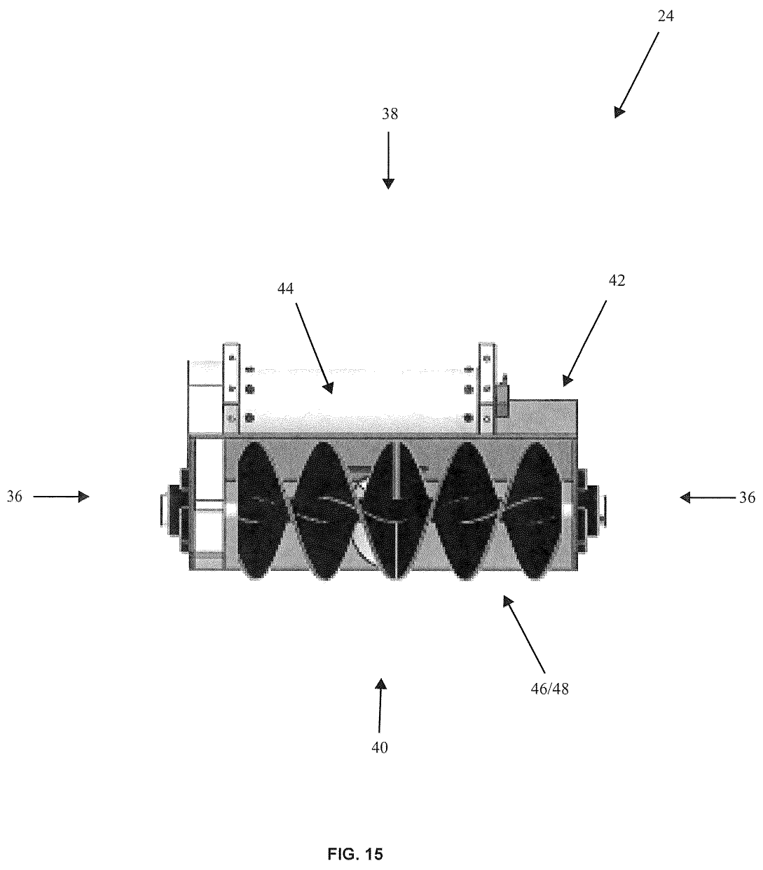

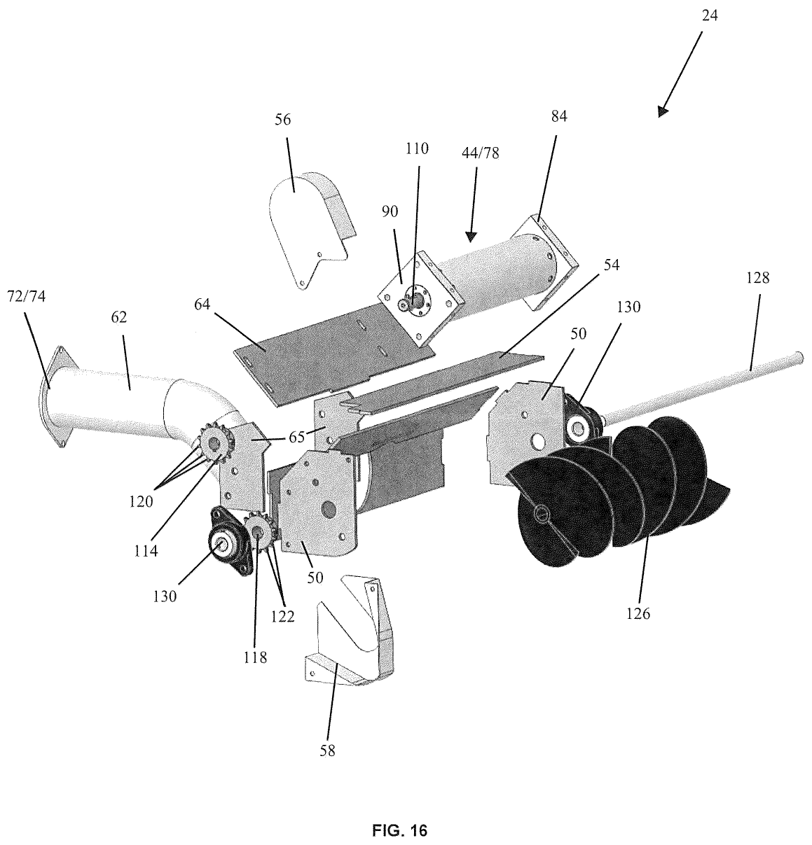

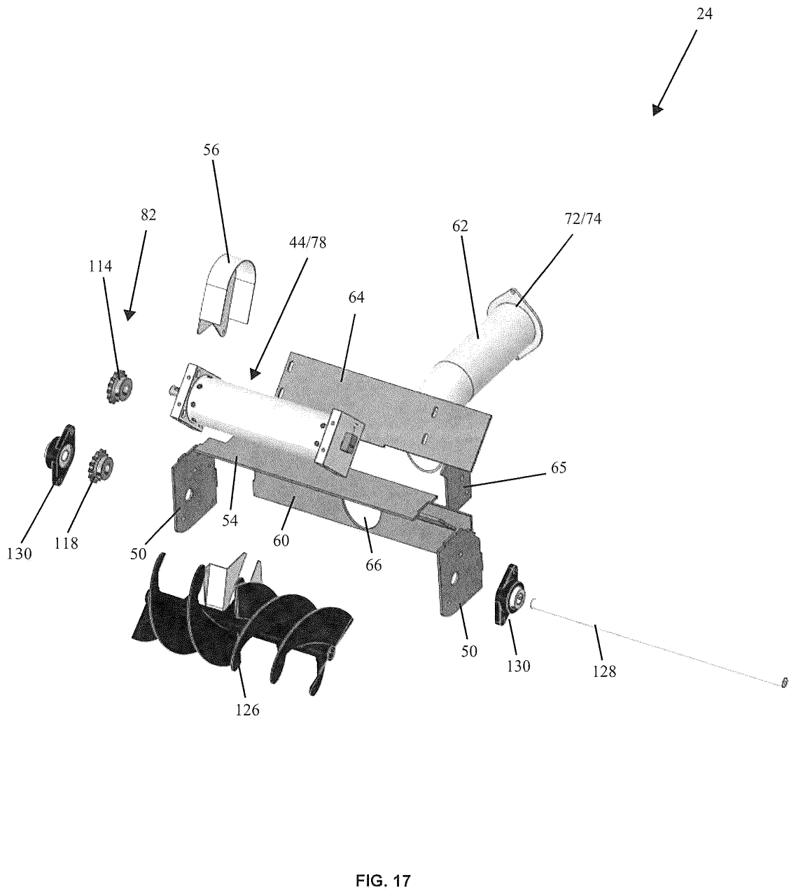

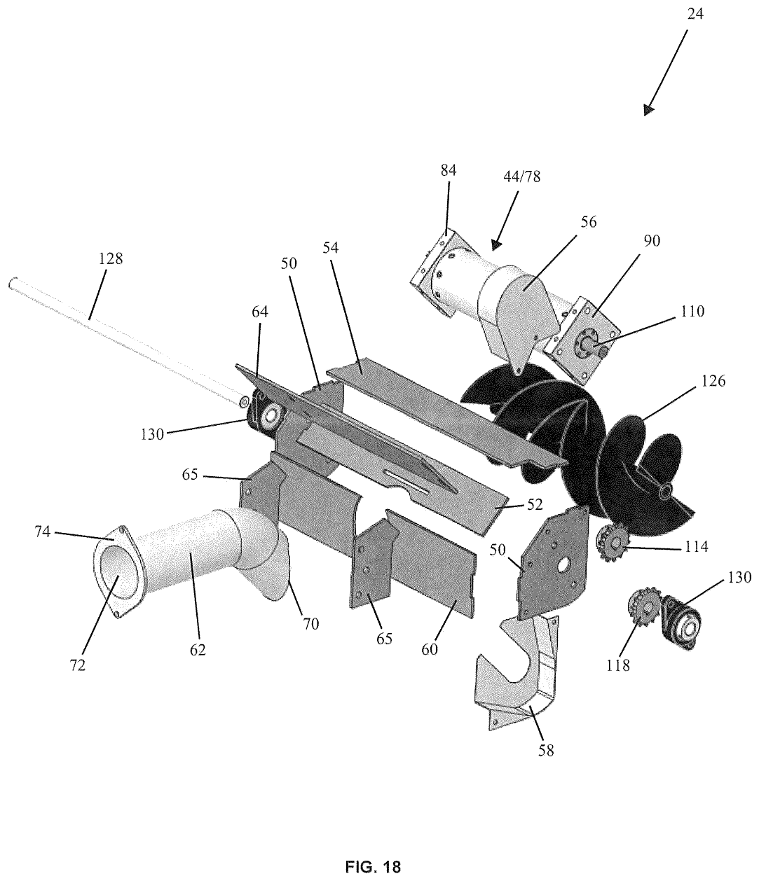

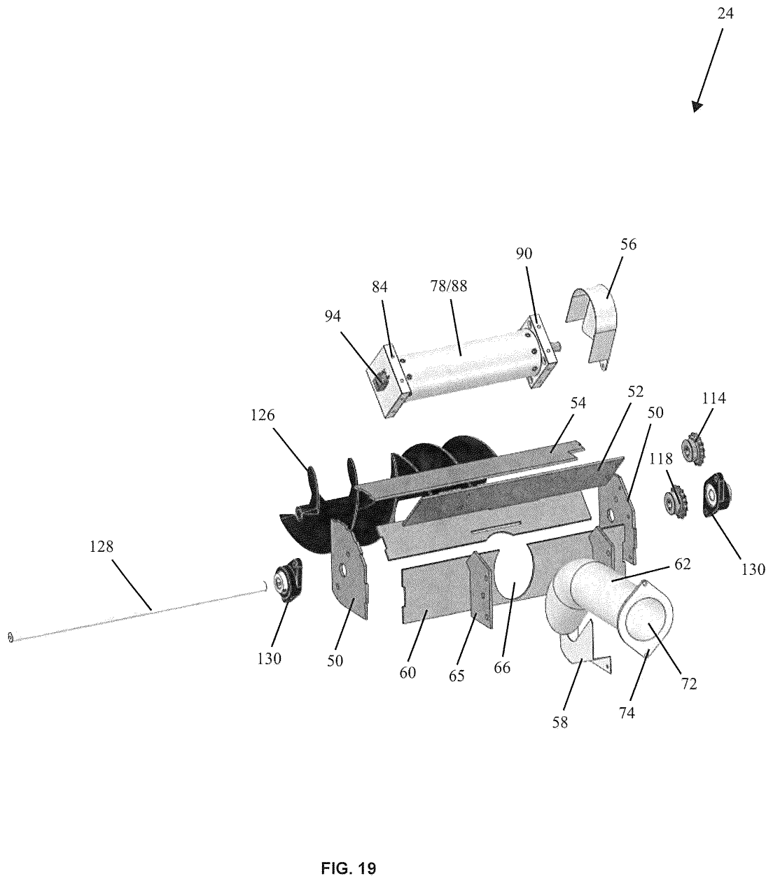

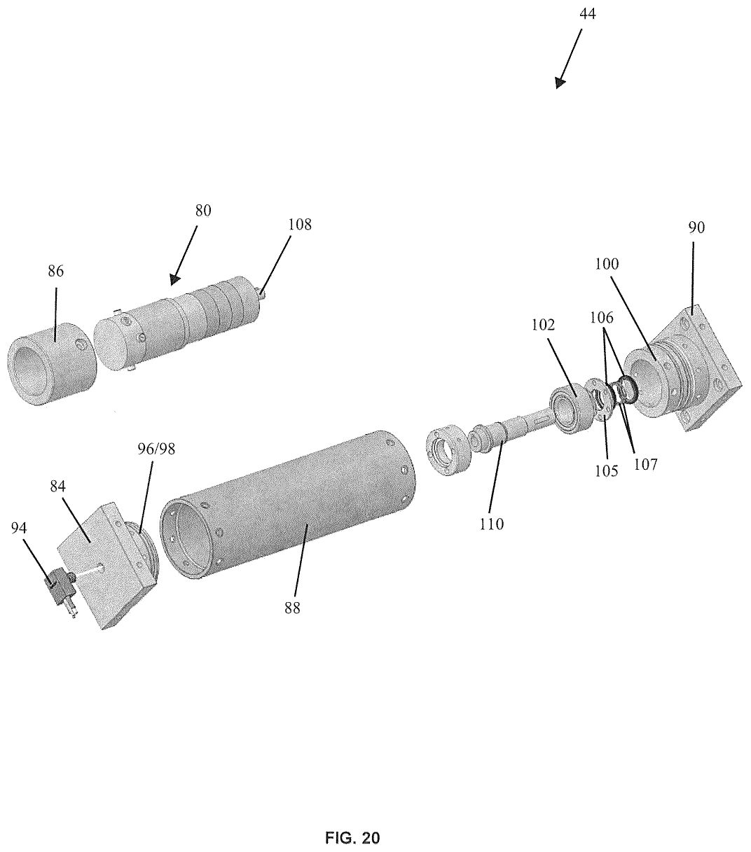

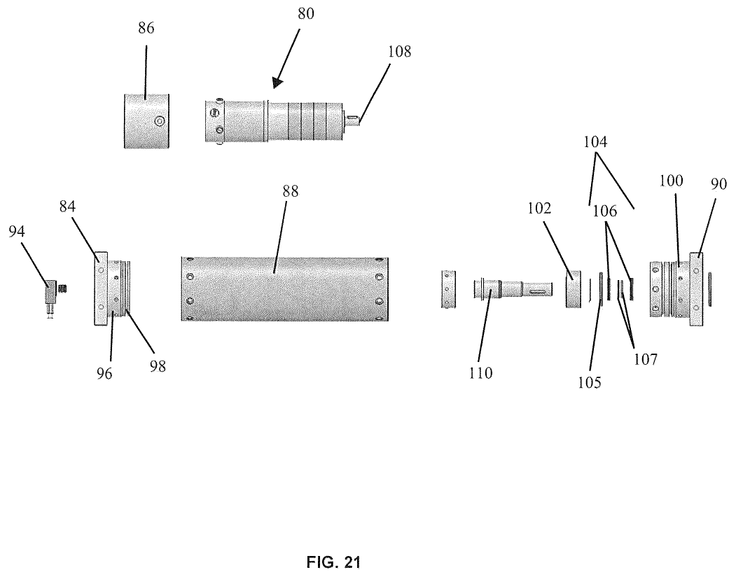

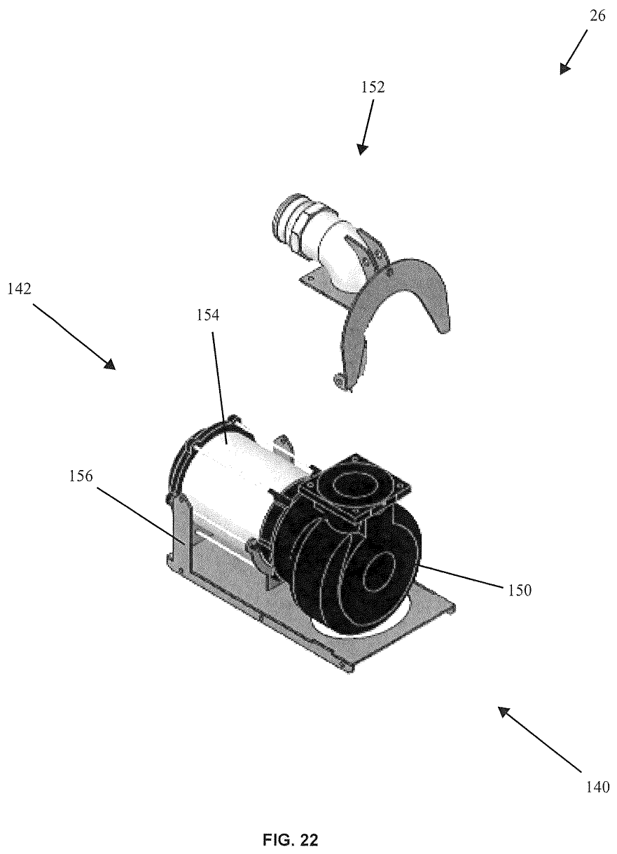

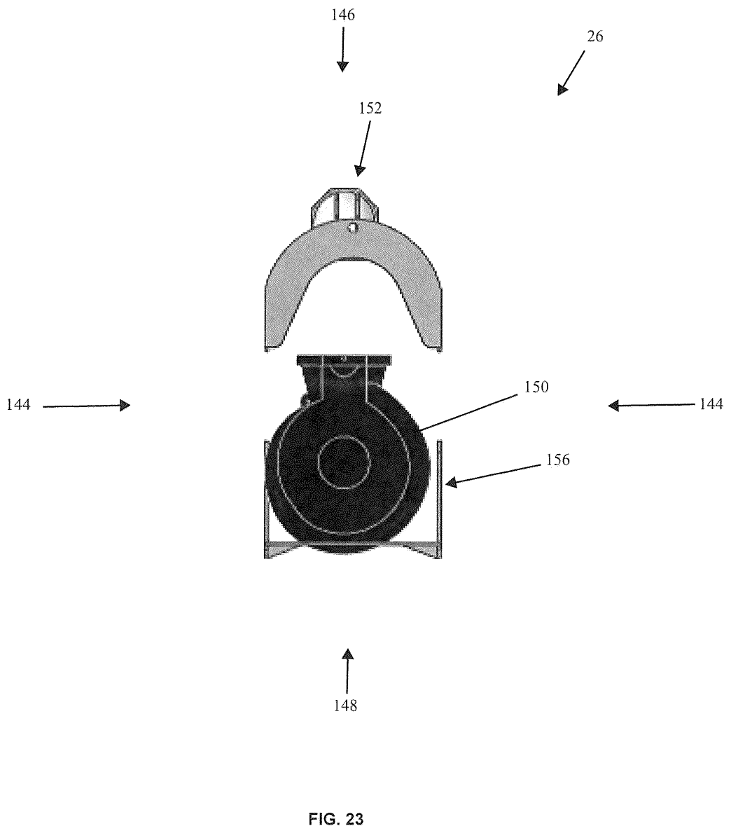

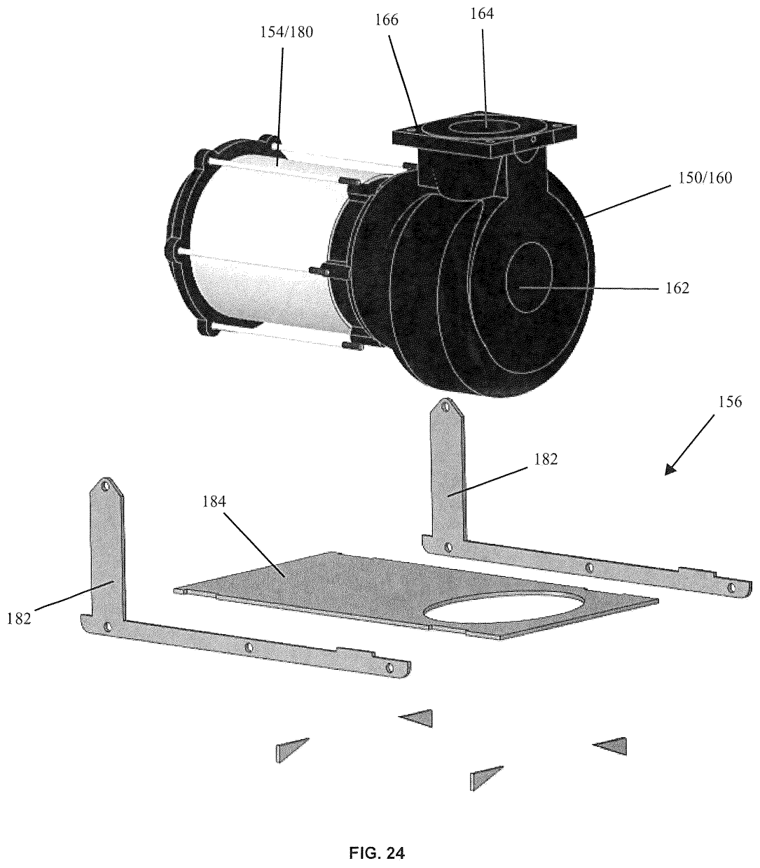

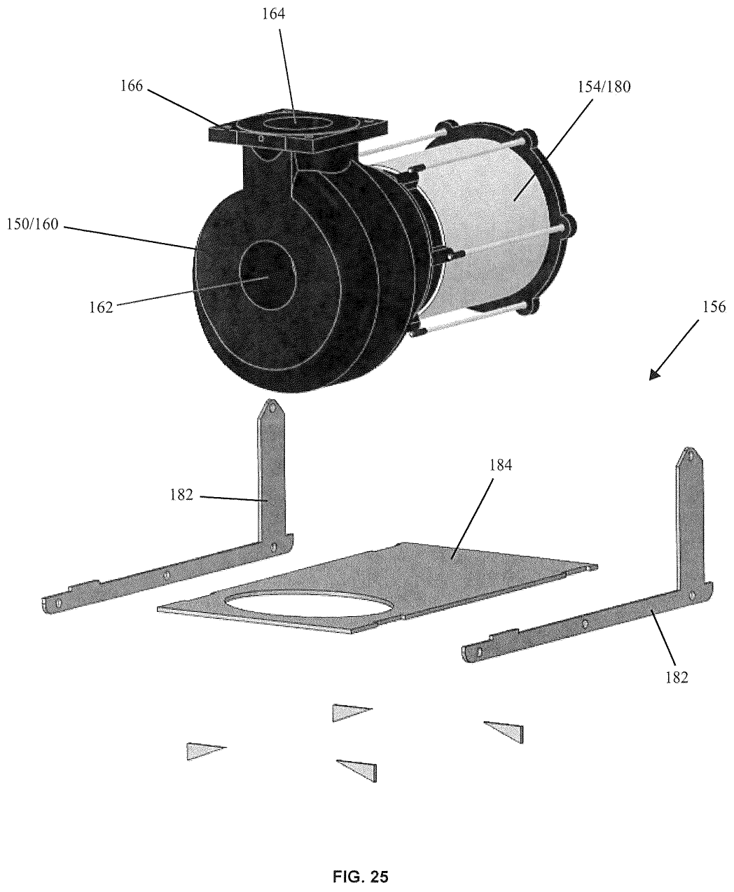

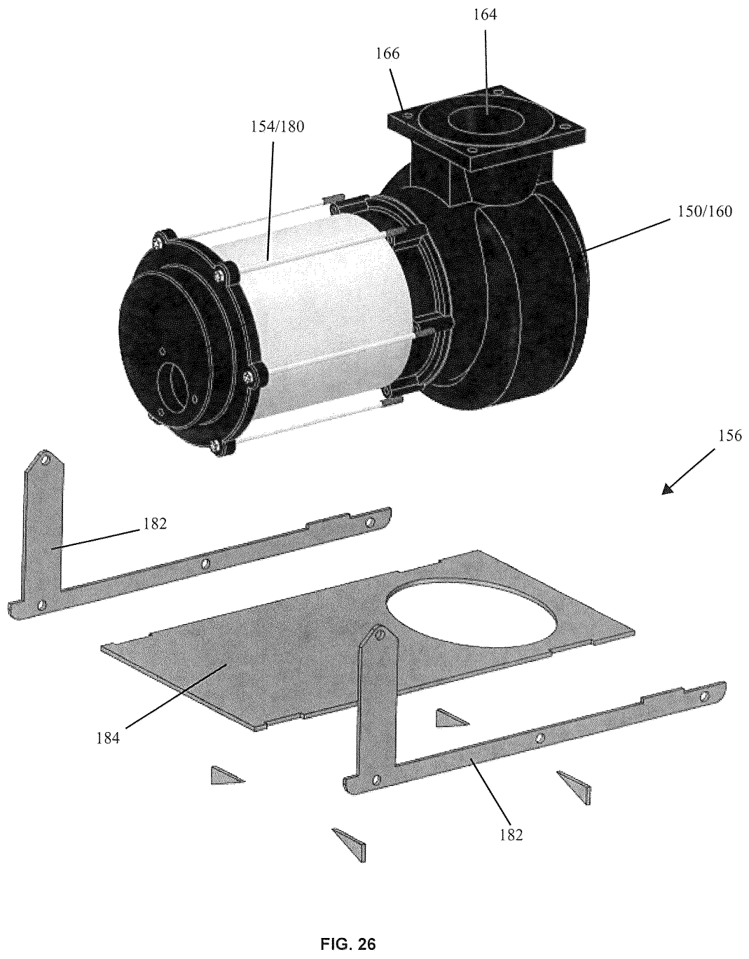

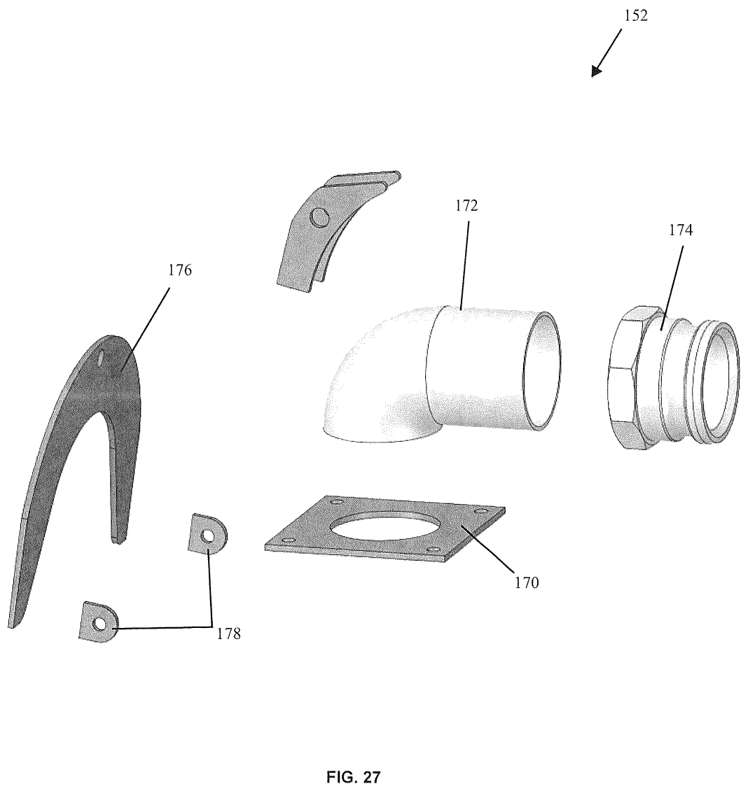

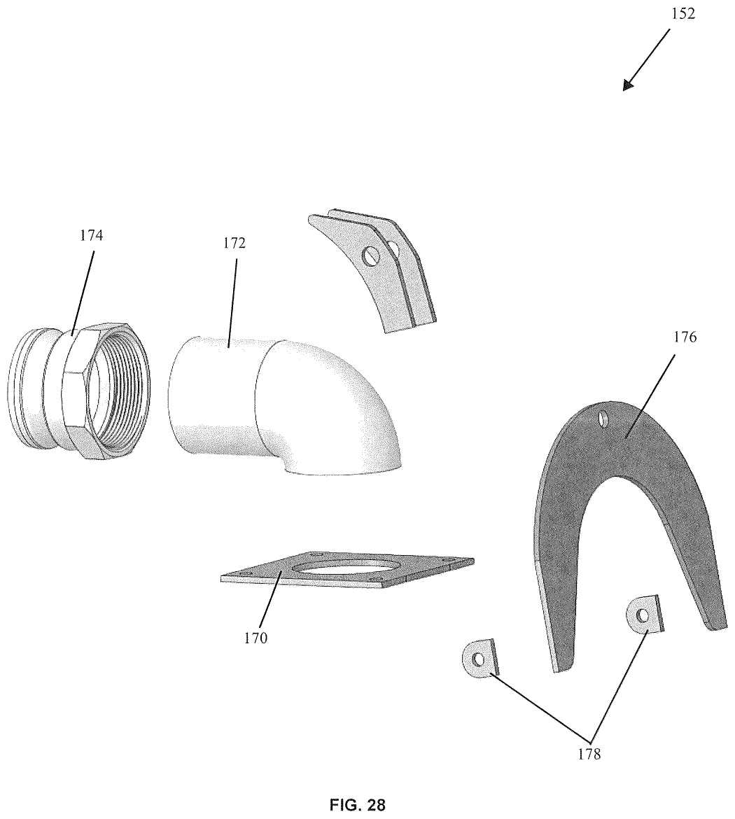

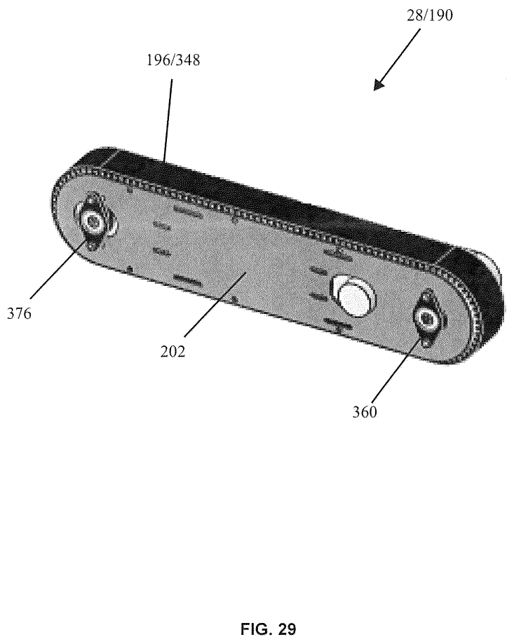

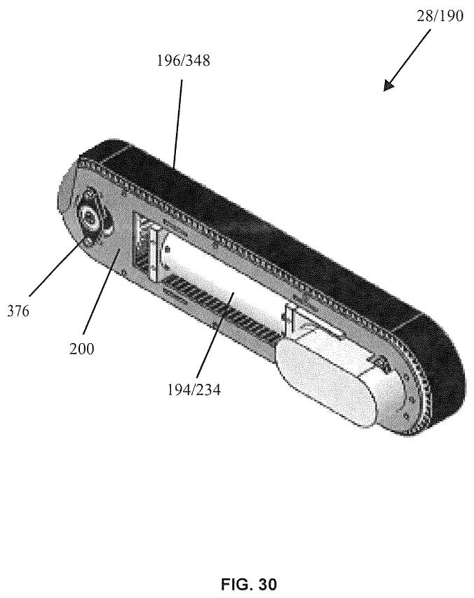

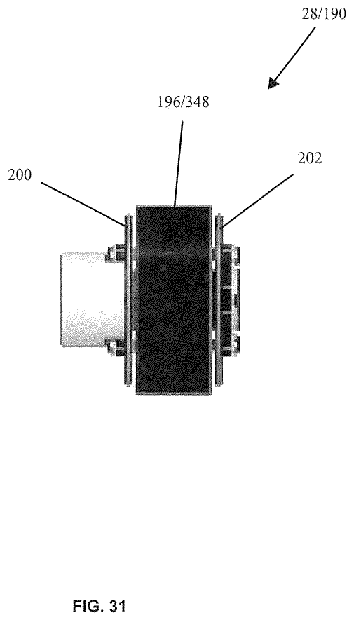

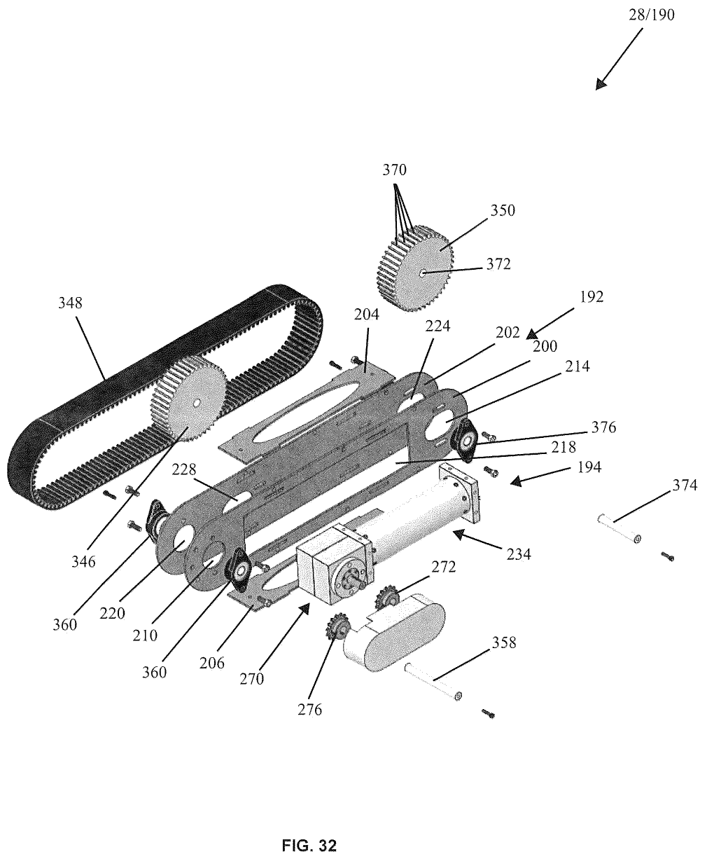

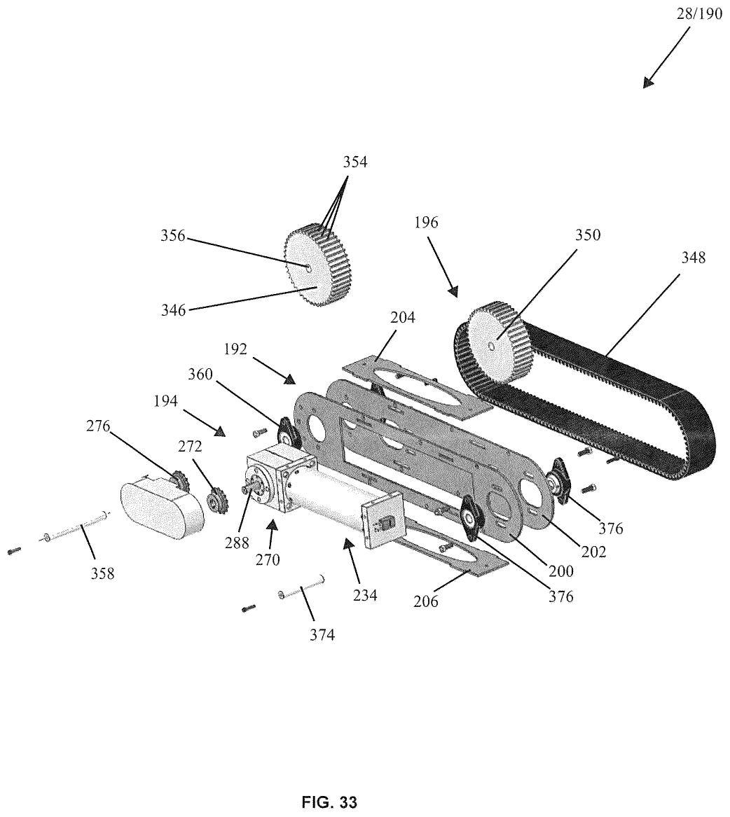

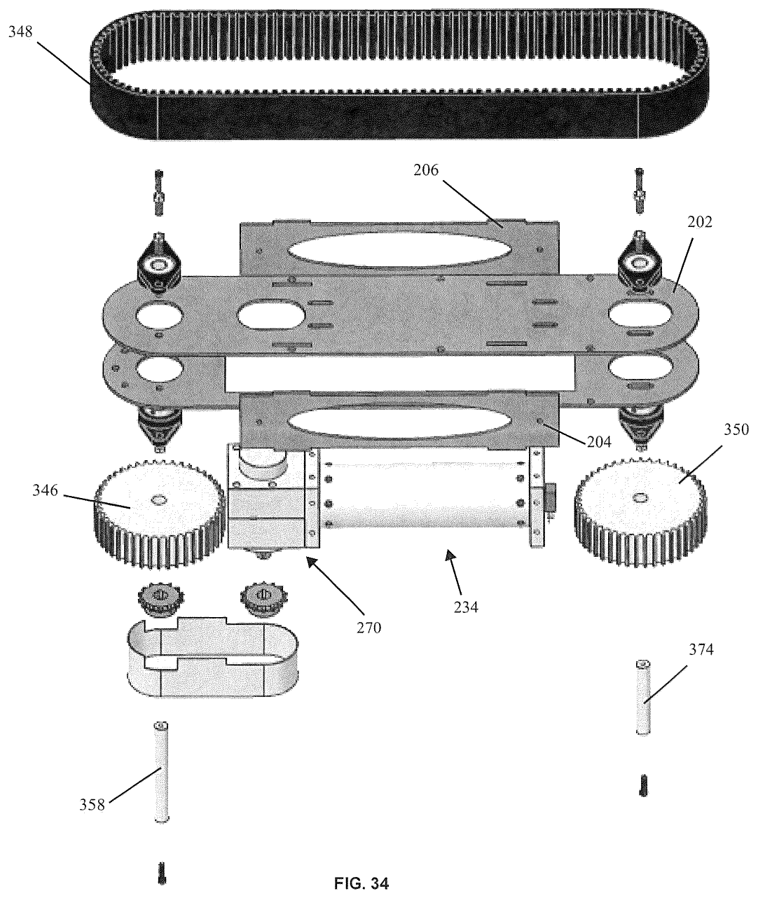

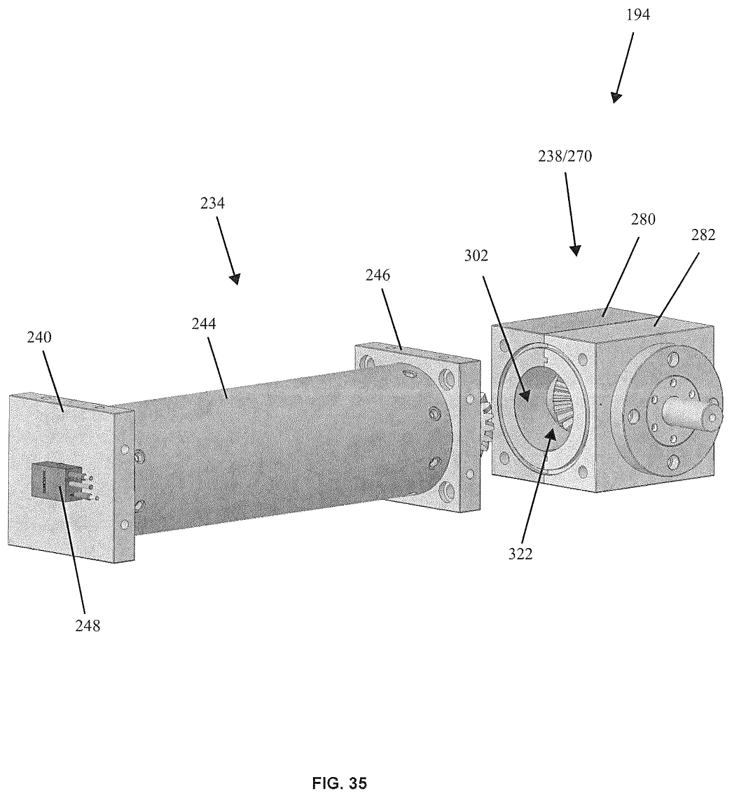

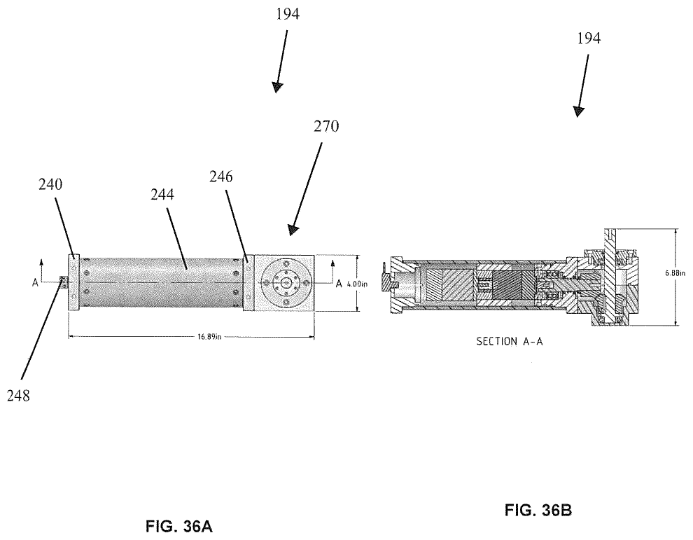

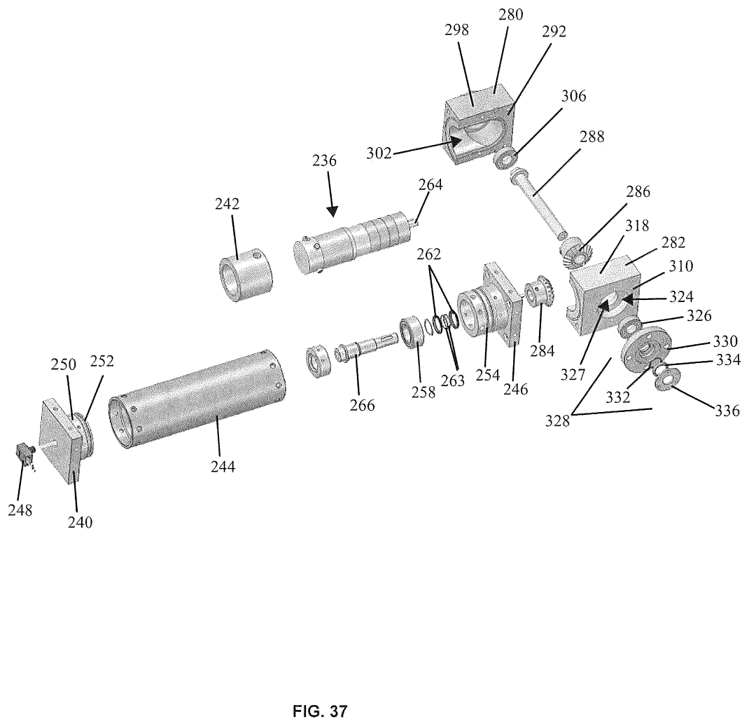

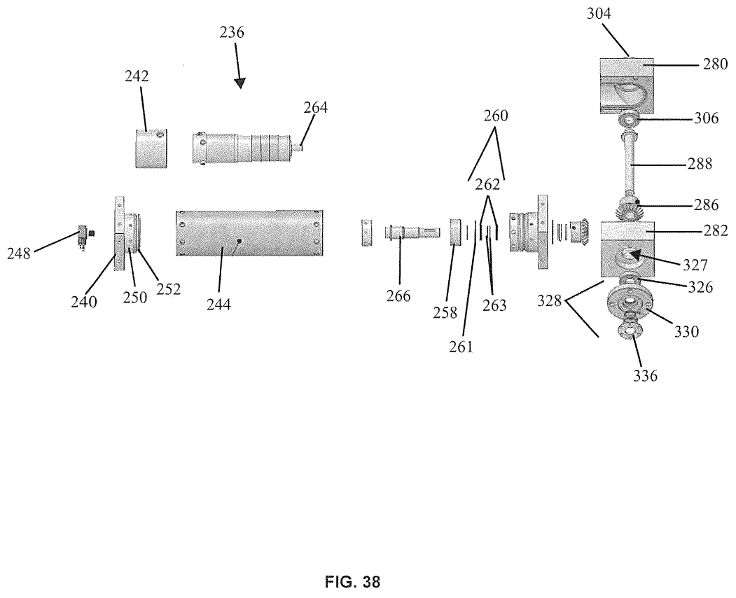

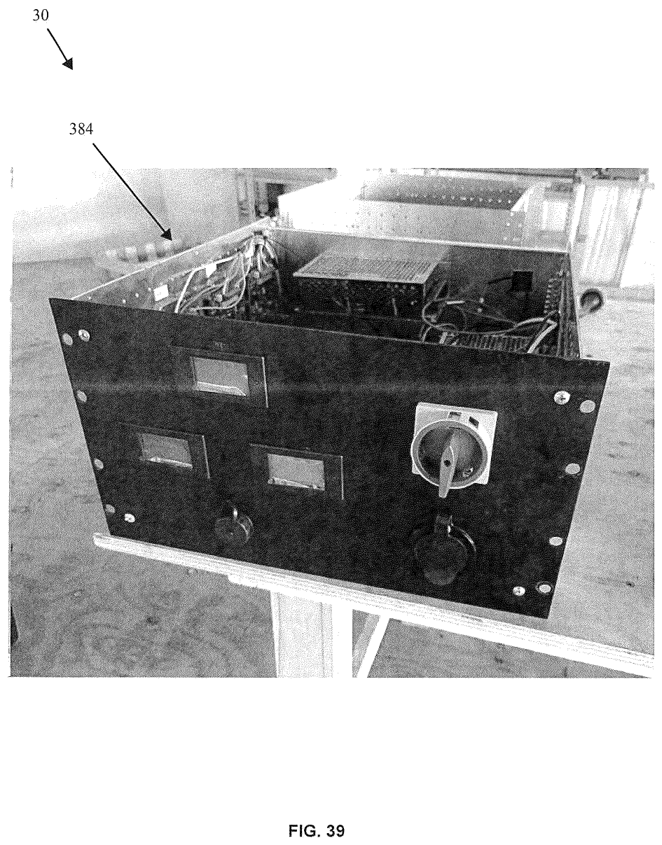

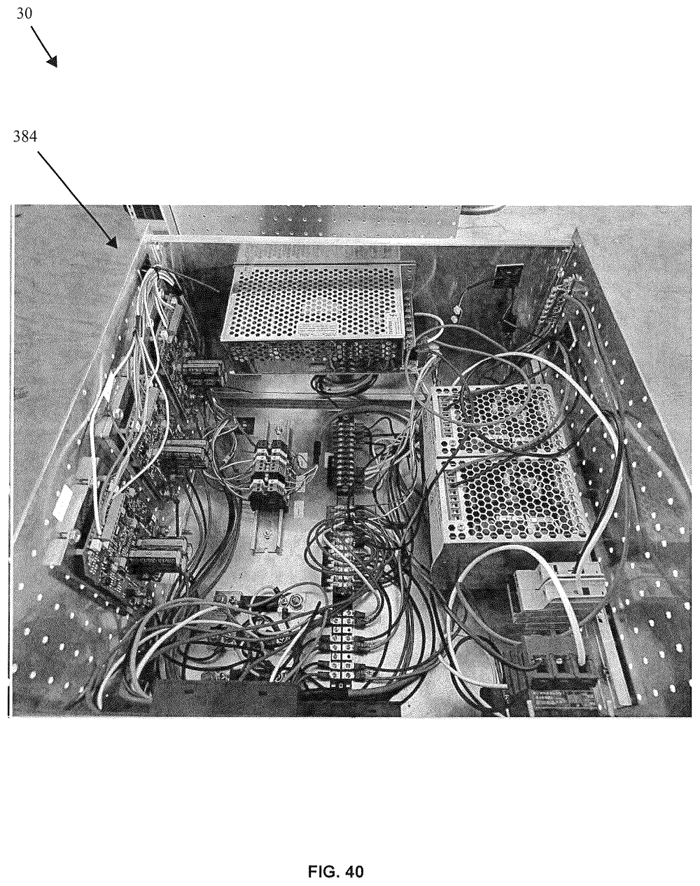

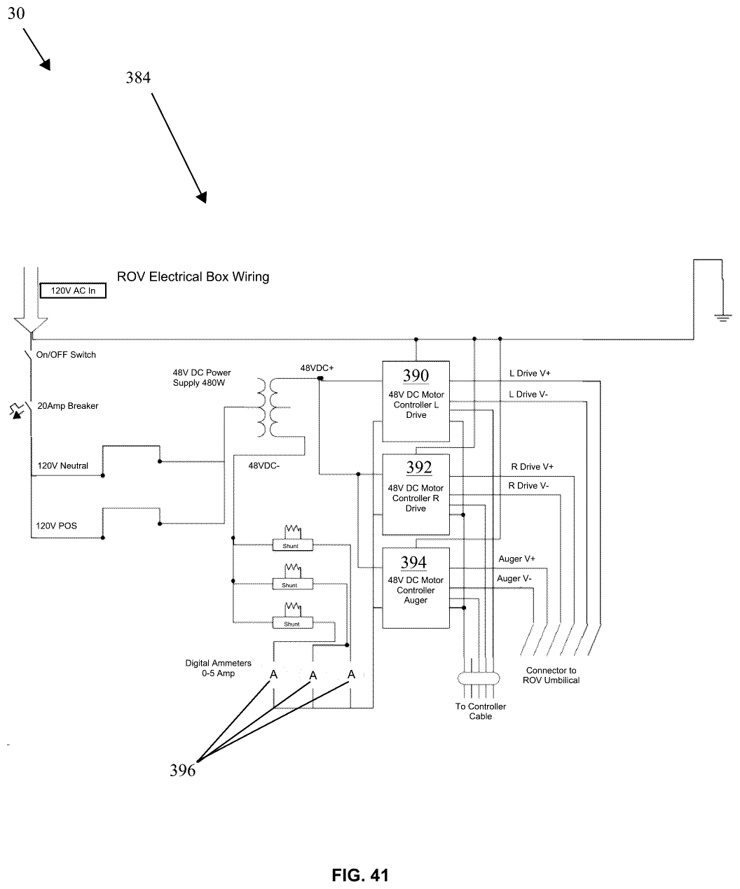

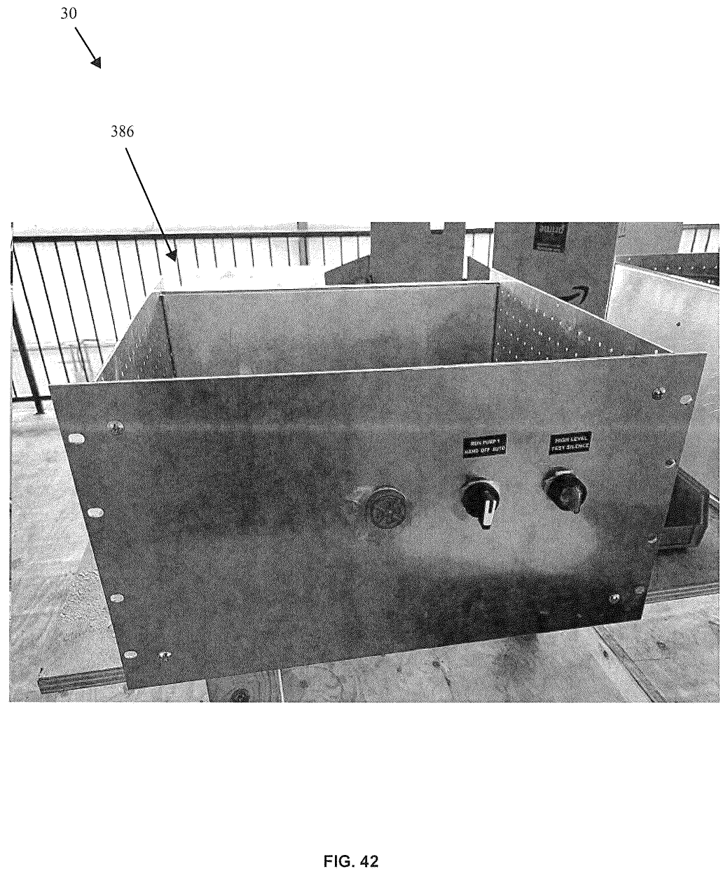

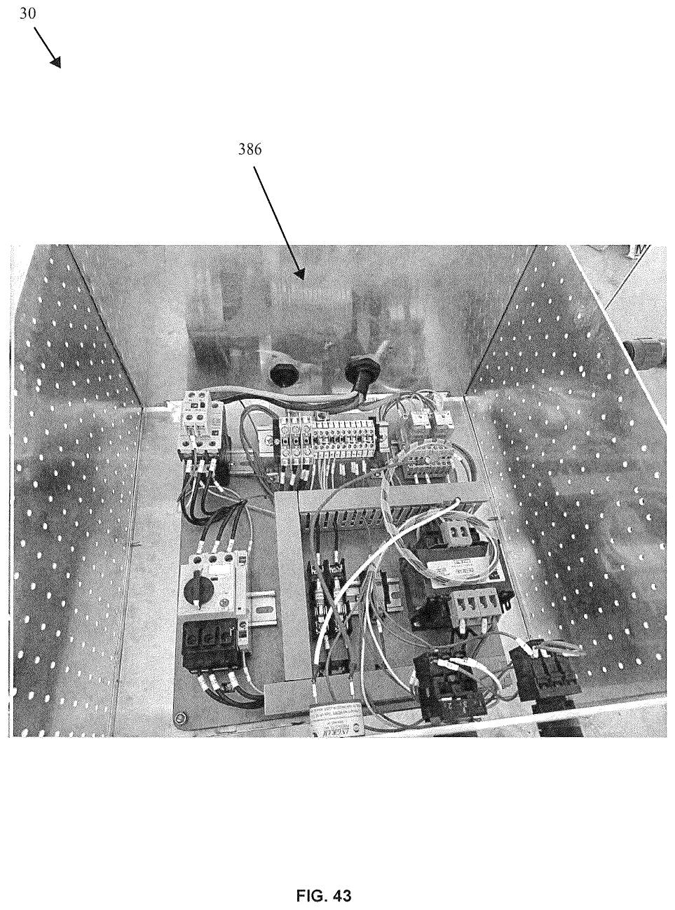

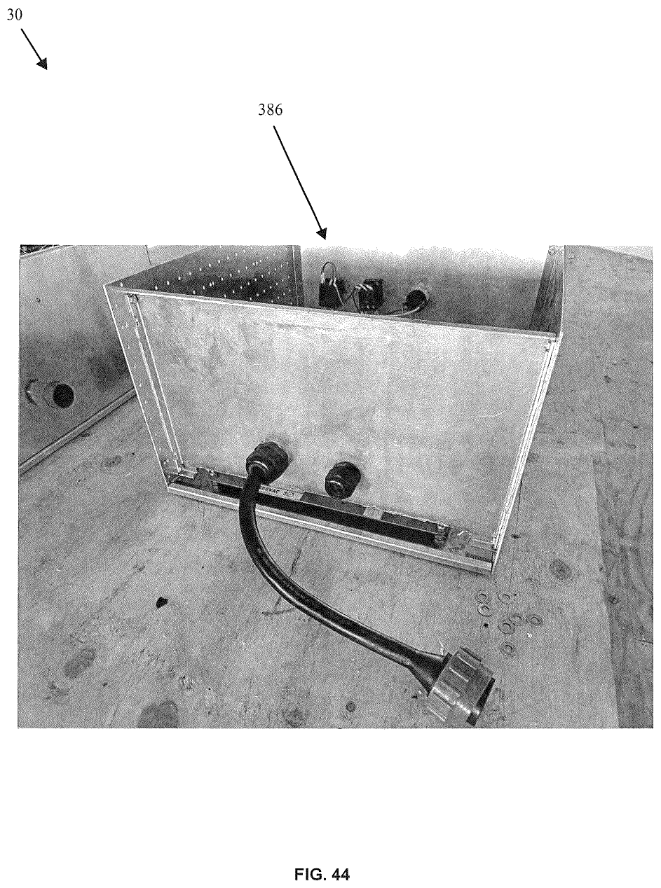

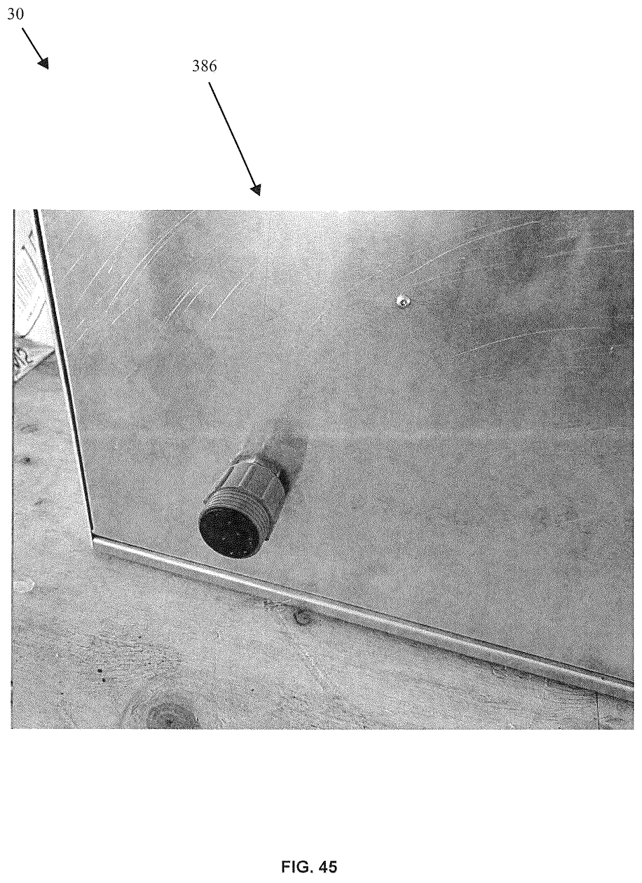

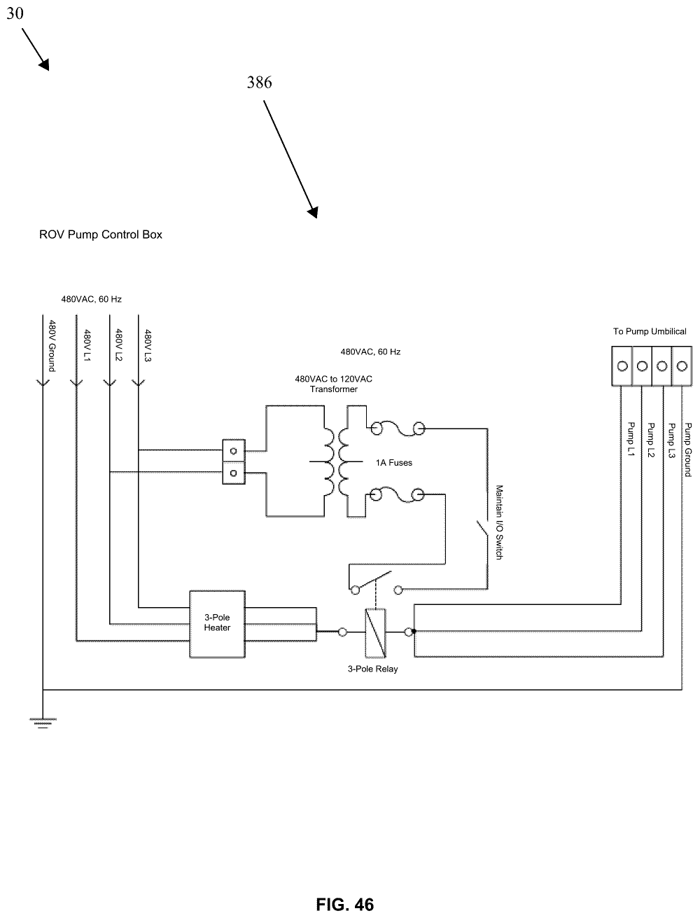

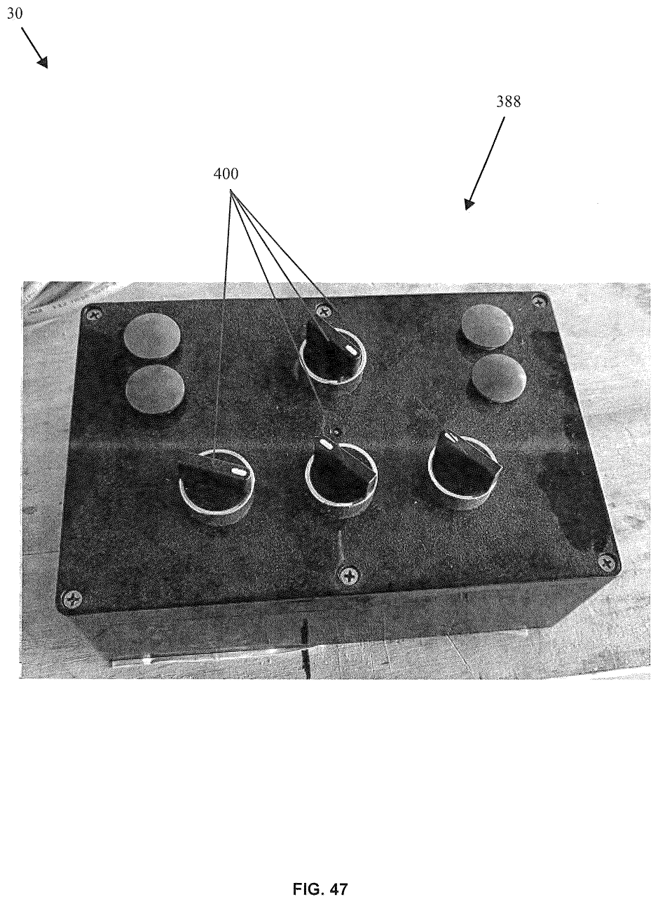

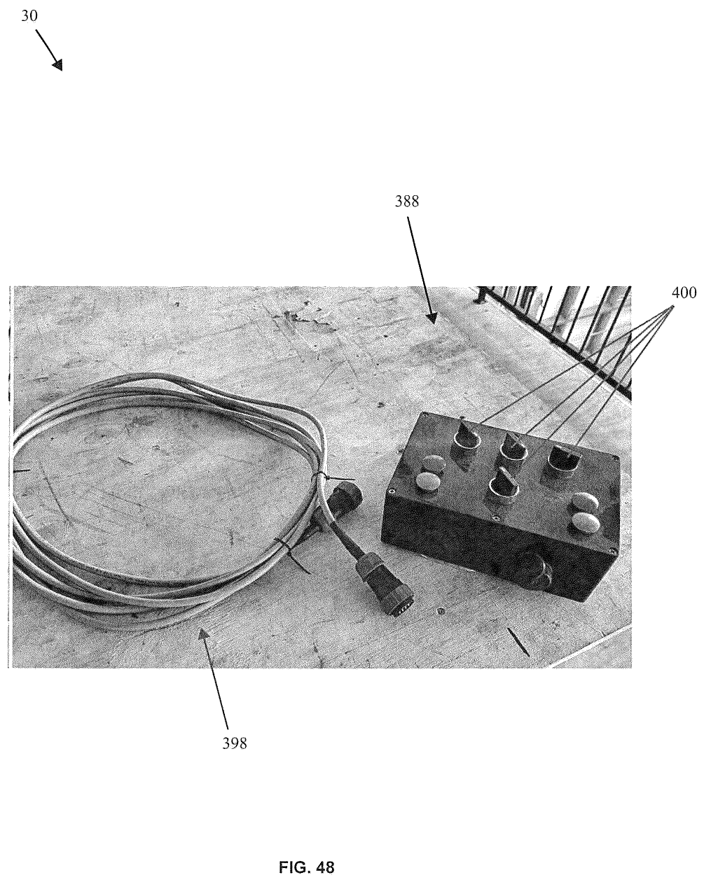

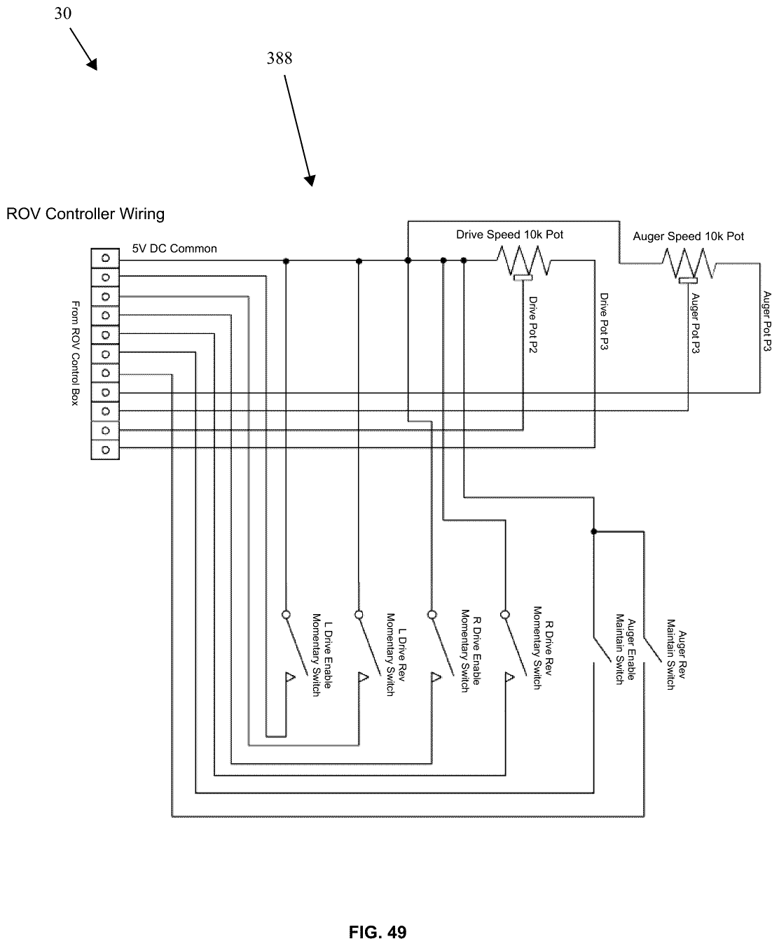

In the arrangement shown, as one example, system 10 is configured to be used in connection with a cleaning system such as the system shown in FIG. 3, which is further shown and disclosed in U.S. patent application Ser. No. 18/460,130 titled “CLEANING SYSTEM” filed on Sep. 1, 2023 (hereinafter “the '130 application”), which is hereby incorporated by reference in its entirety. In the arrangement shown, as one example, system 10 is configured to connect to a hose, such as the hose system shown in FIGS. 4 and 5 and shown and disclosed in further detail in the '130 application. Additionally or alternatively, system 10 may be configured to be used in connection with the retrofit box system shown and disclosed in U.S. patent application Ser. No. 17/982,656 titled “RETROFIT BOX SYSTEM FOR CLEANING INACCESSIBLE FLOORS” filed on Nov. 8, 2022, which is a continuation of U.S. patent application Ser. No. 16/868,140, now U.S. Pat. No. 11,534,045, titled “RETROFIT BOX SYSTEM FOR CLEANING INACCESSIBLE FLOORS” filed on May 6, 2020, which are hereby incorporated by reference in their entireties. While system 10 has been described, in various arrangements as examples, as being used in connection with the cleaning systems or retrofit box systems incorporated by reference herein, system 10 is not so limited and it will be understood by those skilled in the art that system 10 may be used in connection with any other type of cleaning system, hose system (including, but not limited to, a suction hose or hose connected to a pump), vacuum system (including, but not limited to, a vacuum truck), suction system, or any other system capable of causing material to flow through system 10.

Additionally or alternatively, as examples, system 10 may be used without any additional cleaning system or suction system. In these arrangements, as examples, system 10 may be used to move material from one location to another without sucking material through head assembly 24 or system 10. That is, system 10 may be used to push material from one location to another without sucking the material up. In various arrangements, as described herein, this may be done by connecting different cleaning attachments to head assembly 24, such as a blade or squeegee, as examples. It will be understood that even though in various arrangements shown and described herein, system 10 may be used in connection with various cleaning systems, vacuum systems, suction systems, or similar systems, system 10 is not so limited and system 10 may be used in connection with other types of systems or without any other additional systems.

### Head Assembly 24:

In the arrangement shown, as one example, system 10 includes head assembly 24. Head assembly 24 is formed of any suitable size, shape, and design and is configured to facilitate cleaning of the floor of an enclosed space. In the arrangement shown, as one example, head assembly 24 has a forward end 32, a rearward end 34, opposing left and right sides 36 (or simply “sides 36”), a top side 38, and a bottom side 40. In the arrangement shown, as one example, head assembly 24 includes a frame 42, a motor assembly 44, and a cleaning attachment 46, among other components described herein.

### Frame 42:

In the arrangement shown, as one example, head assembly 24 includes frame 42. Frame 42 is formed of any suitable size, shape, and design and is configured to facilitate connection between the various components of head assembly 24 and facilitate connection between head assembly 24 and pump assembly 26. In the arrangement shown, as one example, frame 42 includes end plates 50, angled plate 52, top plate 54, first cover member 56 and second cover member 58, rear plate 60, outlet pipe 62, mounting plate 64, and connection plate 65.

In various arrangements, as examples, frame 42 of head assembly 24 is formed of a single, unitary member that is formed in a manufacturing process such as machining. More specifically, in various arrangements, as examples, frame 42 of head assembly 24 is formed by using a CNC milling machine or CNC laser machine which removes portions from a solid block of material to form frame 42. Once frame 42 of head assembly 24 is completed, then additional components of head assembly 24, such as the motor assembly 44 and cleaning attachment 46, may be connected to frame 42. Alternatively, frame 42 may be formed of multiple pieces that are connected or assembled to one another through welding, or any other means of connecting or assembling the multiple pieces of frame 42 including bolting, screwing, friction fitting, adhesion, or the like. In the arrangement shown, as one example, frame 42 is formed primarily of aluminum, however any other metallic material may be used such as steel, stainless steel, brass, copper, chromium, or any other metallic material, alloy, and/or composite thereof. Alternatively, frame 42 may be formed of a non-metallic material such as a plastic material, a fiberglass material, or any other non-metallic material and/or composite thereof.

In the arrangement shown, as one example, frame 42 includes end plates 50, angled plate 52, and top plate 54. End plates 50, angled plate 52, and top plate 54 are formed of any suitable size, shape, and design and are configured to help facilitate the enclosure of the cleaning attachment 46. In the arrangement shown, as one example, end plates 50 are generally square or rectangular, planar members which are positioned on both sides 16, thereby partially enclosing cleaning attachment 46. In the arrangement shown, as one example, end plates 50 include an angled edge close to the top side of end plates 50 and angled plate 52 connects to the angled edge on each end plate 50. In the arrangement shown, as one example, angled plate 52 is a generally rectangular and planar member which extends between opposing ends and between a bottom edge and an upper edge. In the arrangement shown, as one example, angled plate 52 is attached at its upper edge to top plate 54. In the arrangement shown, as one example, top plate 54 is also a generally rectangular and planar member which extends between opposing ends and between a rear edge and a forward edge. In the arrangement shown, as one example, top plate 54 attaches at each of its ends to the top surface of end plates 50 and at its rear edge to angled plate 52.

In the arrangement shown, as one example, end plates 50 are positioned on either side of cleaning attachment 46 and angled plate 52 attaches at each of its opposing ends to end plates 50 and extends upward and forward to help enclose a portion of the cleaning attachment 46. In the arrangement shown, as one example, the bottom edge of angled plate 52 is connected to rear plate 60, and the upper edge of angled plate 52 is connected to top plate 54. In the arrangement shown, as one example, top plate extends forward from angled plate 52, which covers the top of cleaning attachment 46. With rear plate 60, the connection between end plates 50, angled plate 52, and top plate 54 help enclose all but the front side of cleaning attachment 46, which allows cleaning attachment 46 to be at least mostly inaccessible, so that the chances of any individual being accidentally injured by the cleaning attachment 46 is reduced.

Cover Members: In the arrangement shown, as one example, frame 42 also includes a first cover member 56 and a second cover member 58. First cover member 56 and second cover member 58 are formed of any suitable size, shape, and design and are configured to at least partially enclose the gear assembly 82 of motor assembly 44 of head assembly 24. In the arrangement shown, as one example, first cover member 56 and second cover member 58 are configured to fit together, and when fitted together there is a slot through which a shaft may extend, such as shaft 128 of auger member 48 and operably connect to gear assembly 82 of motor assembly 44. That is, when first cover member 56 and second cover member 58 cover gear assembly 82 of motor assembly 44 is housed within first cover member 56 and second cover member 58, but gear assembly 82 of motor assembly 44 is still able to facilitate operation of cleaning attachment 46 due to the slot which is formed when first cover member 56 and second cover member 58 are brought together.

Rear Plate: In the arrangement shown, as one example, frame 42 also includes a rear plate 60. Rear plate 60 is formed of any suitable size, shape, and design and is configured to help facilitate the partial enclosure of cleaning attachment 46 and allow material to move through to the rear side of head assembly 24. In the arrangement shown, as one example, rear plate 60 is a generally rectangular, planar member which extends between opposing ends and between a top edge and a bottom edge. In the arrangement shown, as one example, each end of rear plate 60 connects to an end plate 50 and the top edge of rear plate 60 connects to angled plate 52. In the arrangement shown, as one example when connected to end plates 50 and angled plate 52, rear plate 60 helps to facilitate partial enclosure of cleaning attachment 46. In the arrangement shown, as one example, rear plate 60 also includes an opening 66.

When cleaning attachment 46 is in use, its purpose is to remove material from the floor of an enclosed space. In order to do so, the material removed by cleaning attachment 46 is moved. In one arrangement, as one example, cleaning attachment 46 may simply push material to a new location to be removed. However, in various other examples, and in the arrangement shown as one example, the material removed by the cleaning attachment 46 is configured to be pumped away. In order to facilitate the pumping away of said material, an opening 66 is present in rear plate 60. Opening 66 is formed of any suitable size, shape, and design and is configured to allow material to move through rear plate 60 in order to be pumped away from head assembly 24.

Outlet Pipe: In the arrangement shown, as one example, frame 42 also includes outlet pipe 62. Outlet pipe 62 is formed of any suitable size, shape, and design and is configured to connect to rear plate 60 and provide a conduit to facilitate the pumping away of material removed by cleaning attachment 46. In the arrangement shown, as one example, outlet pipe 62 is a generally cylindrical, hollow tube which extends between first end 70 and second end 72. In the arrangement shown, as one example, outlet pipe 62 connects to rear plate 60 at first end 70 and outlet pipe 62 connects to pump assembly 26 at second end 72. In the arrangement shown, as one example, first end 70 of outlet pipe 62 is connected adjacent rear plate 60 and positioned such that the opening in first end 70 of outlet pipe 62 is aligned with the opening 66 in rear plate 60. In the arrangement shown, as one example, second end 72 of outlet pipe 62 includes flange 74. Flange 74 is formed of any suitable size, shape, and design and is configured to facilitate connection between outlet pipe 62 and pump assembly 26. In the arrangement shown, as one example, fasteners are used to bolt or otherwise fasten flange 74 to pump assembly 26, however any other means of connecting outlet pipe 62 to pump assembly 26 may be used including, but not limited to, welding, adhesion, or the like.

In this arrangement, as one example, the pump assembly 26 pulls material removed by cleaning attachment 46 rearward through the opening 66 of rear plate 60 and into and through outlet pipe 62. In this way, outlet pipe 62 provides a conduit to facilitate the pumping away of material removed by cleaning attachment 46.

Mounting Plate: In the arrangement shown, as one example, frame 42 also includes mounting plate 64. Mounting plate 64 is formed of any suitable size, shape, and design and is configured to support motor assembly 44 and facilitate connection between motor assembly 44 and frame 42. In the arrangement shown, as one example, mounting plate 64 is a generally rectangular, planar member which extends between opposing ends and between a top edge and a bottom edge. In the arrangement shown, as one example, the bottom edge of mounting plate 64 is configured to connect to top plate 54 of frame 42. In the arrangement shown, as one example, mounting plate 64 is also configured to connect to the housing 78 of motor assembly 44.

Connection Plates: In the arrangement shown, as one example, frame 42 also includes connection plates 65. Connection plates 65 are formed of any suitable size, shape, and design and are configured to facilitate connection between head assembly 24 and drive member assemblies 28. In the arrangement shown, as one example, connection plates 65 are generally rectangular or planar members which extend rearward from rear plate 60 of frame 42 near each of the opposing left and right sides 36 of head assembly 24. In the arrangement shown, as one example, each of the connection plates 65 include openings in order to receive a fastener, such as a bolt, which is configured to connect head assembly 24 and drive member assemblies 28.

While frame 42 and its various components have been described according to the arrangement shown, as one example, it will be understood by those skilled in the art that any other configuration of frame 42 and its components may be used in order to facilitate connection between the various components of head assembly 24 and facilitate connection between head assembly 24 and pump assembly 26.

### Motor Assembly 44:

In the arrangement shown, as one example, head assembly 24 includes motor assembly 44. Motor assembly 44 is formed of any suitable size, shape, and design and is configured to provide power to cleaning attachment 46. In the arrangement shown, as one example, motor assembly 44 includes a housing 78, a motor 80, and a gear assembly 82, among other components described herein.

Housing: In the arrangement shown, as one example motor assembly 44 includes housing 78. Housing 78 is formed of any suitable size, shape, and design and is configured to enclose motor 80 and facilitate operable connection to frame 42. More specifically, in the arrangement shown, as one example, housing 78 is configured to hermetically seal motor 80 therein in order to allow motor 80 to function while system 10 is submerged under a liquid or other material, and housing 78 is configured to operably connect to mounting plate 64 of frame 42. In the arrangement shown, as one example, housing 78 includes a first end plate 84, a first coupler 86, a main tube 88, and a second end plate 90, among other components described herein.

In the arrangement shown, as one example, housing 78 includes a first end plate 84. First end plate 84 is formed of any suitable size, shape, and design and is configured to help enclose and seal motor 80 within housing 78. In the arrangement shown, as one example, first end plate 84 is a generally square or rectangular member with an exterior side and an interior side, and an aperture extending through first end plate 84 from the exterior side to the interior side. In the arrangement shown, as one example, the exterior side of first end plate 84 includes an electrical connector 94. Electrical connector 94 is formed of any suitable size, shape, and design and is configured to connect to single electrical cable 380 and to motor 80 in order to transfer the electricity moving through single electrical cable 380 to motor 80.

In the arrangement shown, as one example, first end plate 84 has a connection member 96 extending outward from the interior side of first end plate 84. Connection member 96 is formed of any suitable size, shape, and design and is configured to facilitate operable connection between first end plate 84 and motor 80. In the arrangement shown, as one example, connection member 96 is a generally cylindrical member extending outward from the interior side of first end plate 84. In the arrangement shown, as one example, connection member 96 includes a threaded portion 98. In the arrangement shown, as one example, connection member 96 is generally sized such that first coupler 86 may be threaded onto the threaded portion 98 of connection member 96 and the threaded portion 98 is able to rest within close and tight tolerances in the hollow center of first coupler 86.

In the arrangement shown, as one example, housing 78 includes first coupler 86. First coupler 86 is formed of any suitable size, shape, and design and is configured to facilitate operable connection between first end plate 84 and motor 80. In the arrangement shown, as one example, first coupler 86 is a generally cylindrical member that has a hollow center and an internally threaded portion (not shown). In this arrangement, as one example, first coupler 86 may be threaded onto connection member 96 of first end plate 84. In the arrangement shown, as one example, first coupler 86 also connects to motor 80, thereby facilitating operable connection between first end plate 84 and motor 80.

In the arrangement shown, as one example, housing 78 also includes main tube 88. Main tube 88 is formed of any suitable size, shape, and design and is configured to help facilitate the hermetic sealing of motor 80 within housing 78. In the arrangement shown, as one example, main tube 88 is a generally cylindrical member which extends between opposing ends and has a hollow center. In the arrangement shown, as one example, the connection member 96 of first end plate 84, first coupler 86, motor 80, and the connection member 100 of second end plate 90 fit within the hollow center of main tube 88. In the arrangement shown, as one example, the opposing ends of main tube 88 connect to first end plate 84 and second end plate 90 in a manner which creates a hermetic (i.e. airtight) seal within the hollow center of main tube 88.

In the arrangement shown, as one example, housing 78 includes second end plate 90. Second end plate 90 is formed of any suitable size, shape, and design and is configured to help enclose and seal motor 80 within housing 78. In the arrangement shown, as one example, second end plate 90 is a generally square or rectangular member with an exterior side and an interior side. In the arrangement shown, as one example, a connection member 100 extends outward from the interior side of second end plate 90. In the arrangement shown, as one example, connection member 100 is configured to support a portion of motor 80 and also allow the adapter 110 of motor 80 to extend through second end plate 90. In this arrangement, a portion of motor 80 is connected to adapter 110 of motor 80 and the adapter 110 is extended through an open center extending through connection member 100 and second end plate 90.

In the arrangement shown, as one example, second end plate 90 also includes bearing 102 and seal member 104. In the arrangement shown, as one example, the adapter 110 of motor 80 extends through the open center of connection member 100 and second end plate 90. In the arrangement shown, as one example, the adapter 110 of motor 80 extends through bearing 102 and bearing 102 helps support adapter 110 while still allowing adapter 110 to rotate in order to facilitate rotation (or other motion) of cleaning attachment 46. In the arrangement shown, as one example, sealing member 104 is included in second end plate 90 in order to ensure the hermetic seal of housing 78. In the arrangement shown, as one example, the open center extending through connection member 100 and second end plate 90 may cause issues with the seal of housing 78, which would in turn affect the operability of motor 80. To ensure the proper seal of housing 78, second end plate 90 includes sealing member 104. In the arrangement shown, as one example, seal member 104 is comprised of a seal cover 105, two spring loaded shaft seals 106, and two O-rings 107. In the arrangement shown, as one example, the seal member 104 effectively creates a water-tight seal when seal member 104 is placed around the exterior of adapter 110 after adapter 110 has been extended through the opening in connection member 100 and second end plate 90.

Motor: In the arrangement shown, as one example, motor assembly 44 includes motor 80. Motor 80 is formed of any suitable size, shape, and design and is configured to facilitate movement of cleaning attachment 46. In the arrangement shown, as one example, motor 80 is an electric motor, however any other type of motor, engine, or power source may be used in order to facilitate movement of cleaning attachment 46, such as a gas engine, a diesel engine, a solar energy source, a wind powered energy source, or any other source of energy or power. In the arrangement shown, as one example motor 80 is attached to first coupler 86 which connects to connection member 96 of first end plate 84, thereby operably connecting motor 80 to housing 78.

In the arrangement shown, as one example, motor 80 includes a drive shaft 108 which extends outward from motor 80. Additionally, in the arrangement shown, as one example, motor 80 includes adapter 110. Adapter 110 is formed of any suitable size, shape, and design and is configured to connect to drive shaft 108, rotate with drive shaft 108, and extend outward a distance further than drive shaft 108. In this way, the rotation of drive shaft 108 is extended by adapter 110 so that the rotation can be translated to gear assembly 82 of motor assembly 44.

Gear Assembly: In the arrangement shown, as one example, motor assembly 44 includes gear assembly 82. Gear assembly 82 is formed of any suitable size, shape, and design and is configured to translate rotation of motor 80 to movement of cleaning attachment 46. In the arrangement shown, as one example, gear assembly 82 includes first sprocket 114, a chain (not shown), and second sprocket 118.

In the arrangement shown, as one example, first sprocket 114 is configured to connect to adapter 110. In the arrangement shown, as one example, adapter 110 extends through the middle of first sprocket 114 and is engaged with first sprocket 114 such that when adapter 110 rotates, first sprocket 114 also rotates. In the arrangement shown, as one example, first sprocket 114 includes teeth 120. In the arrangement shown, as one example, teeth 120 extend outward from first sprocket 114 and are configured to engage the chain of gear assembly 82.

In the arrangement shown, as one example, gear assembly 82 includes a chain. The chain of gear assembly 82 is formed of any suitable size, shape, and design and is configured to connect first sprocket 114 to second sprocket 118 in order to transfer rotation of first sprocket 114 to second sprocket 118. In the arrangement shown, as one example, the chain of gear assembly 82 is configured to extend around both first sprocket 114 and second sprocket 118. In this arrangement shown as one example, when the drive shaft 108 of motor 80 rotates, adapter 110 rotates, which causes first sprocket 114 to rotate. As first sprocket 114 rotates, the teeth 120 of first sprocket 114 engage the chain of gear assembly 82 and cause the chain of gear assembly 82 to rotate. In the arrangement shown, as one example, the chain of gear assembly 82 is also wrapped around second sprocket 118. In the arrangement shown, as one example, second sprocket 118 also includes teeth 122. When the chain of gear assembly 82 is caused to rotate by the rotation of first sprocket 114, the chain of gear assembly 82 engages with teeth 122 of second sprocket 118, thereby causing second sprocket 118 to rotate as well.

In the arrangement shown, as one example, second sprocket 118 engages with the chain of gear assembly 82 through teeth 122 of second sprocket 118 as described herein. In the arrangement shown, as one example, second sprocket 118 is also configured to allow the shaft 128 of cleaning attachment 46 (in this case auger member 48) to extend through second sprocket 118 and engage second sprocket 118 in close and tight tolerances. In this arrangement, shown as one example, when second sprocket 118 rotates, it also causes the rotation of shaft 128 of auger member 48. In this way, motor 80 causes the movement of cleaning attachment 46.

### Cleaning Attachment 46:

In the arrangement shown, as one example, head assembly 24 includes a cleaning attachment 46. Cleaning attachment 46 is formed of any suitable size, shape, and design and is configured to facilitate cleaning of the floor of an enclosed space. In the arrangement shown, as one example, the cleaning attachment 46 is auger member 48. In the arrangement shown, as one example, head assembly 24 is designed such that various cleaning attachments 46 may be used with system 10 and such cleaning attachments 46 are easily and quickly interchangeable. As such, in various alternative arrangements, as examples, cleaning attachment 46 may be a brush member, a rubber member, a water jet nozzle or nozzles, a squeegee member, a blade, or any other type of attachment which is beneficial to clean the applicable floor that system 10 is being used to clean. This gives greater flexibility to system 10 and allows system 10 to be used in more and various environments.

### Auger Member 48:

In the arrangement shown, as one example, the cleaning attachment 46 used in head assembly 24 is auger member 48. Auger member 48 is formed of any suitable size, shape, and design and is configured to disturb material on the floor of the enclosed space and move such material toward the outlet pipe 62 of frame 42 of head assembly 24. In the arrangement shown, as one example, auger member 48 includes flighting 126 and shaft 128 with bearings 130. In the arrangement shown, as one example, auger member 48 may be any type of auger head on the market and is similar to an auger used in a snowblower.

In the arrangement shown, as one example, auger member 48 includes flighting 126. Flighting 126 is formed of any suitable size, shape, and design and is configured to remove material from the floor of the enclosed space and move such material toward the opening 66 in rear plate 60 in order to be pulled through opening 66 by pump assembly 26. In the arrangement shown, as one example flighting 126 is comprised of various disks which are angled such that when the disks are rotated, material is moved toward the center of flighting 126 and toward opening 66 in rear plate 60. In the arrangement shown, as one example, flighting 126 includes an opening through the center of flighting 126. The opening through the center of flighting 126 is formed of any suitable size, shape, and design and is configured to allow shaft 128 to extend through flighting 126.

In the arrangement shown, as one example, shaft 128 extends through the opening in flighting 126 and engages flighting 126 within close and tight tolerances. In the arrangement shown, as one example, shaft 128 is connected to second sprocket 118 such that when second sprocket 118 rotates, shaft 128 also rotates. When shaft 128 rotates, the tight engagement between flighting 126 and shaft 128 causes flighting 126 to rotate with shaft 128. In the arrangement shown, as one example, when flighting 126 is rotated material is removed from the floor of the enclosed space and moved toward the opening 66 of rear plate 60.

In the arrangement shown, as one example, shaft 128 also includes bearings 130. Bearings 130 are formed of any suitable size, shape, and design and are configured to allow shaft 128 to operably connect to frame 42, thereby operably connecting frame 42 and cleaning member 46 (i.e. auger member 48 in the arrangement shown, as one example). In the arrangement shown, as one example, bearings 130 are flange bearings which are able to connect to the end plates 50 of frame 42 through fasteners which can be quickly and easily removed and installed. This arrangement, as one example, allows the type of cleaning attachment 46 to be quickly and efficiently switched.

While head assembly 24 and its various components have been described according the arrangement shown, as one example, it will be understood by those skilled in the art that any other configuration of head assembly 24 may be used in order to facilitate cleaning of the floor of an enclosed space.

In the arrangement shown, as one example, when cleaning attachment 46 of head assembly 24 is operated, material is removed from the floor of the enclosed space and sucked through opening 66 and outlet pipe 62 of frame 42 by pump assembly 26.

### Pump Assembly 26:

In the arrangement shown, as one example, system 10 includes pump assembly 26. Pump assembly 26 is formed of any suitable size, shape, and design and is configured to pull fluid through cleaning attachment 46 of head assembly 24. In the arrangement shown, as one example, pump assembly 26 has a forward end 140, a rearward end 142, opposing left and right sides 144 (or simply “sides 144”), a top side 146, and a bottom side 148. In the arrangement shown, as one example, pump assembly 26 includes a pump 150, an exhaust assembly 152, a motor assembly 154, and a pump frame 156, among other components described herein.

In the arrangement shown, as one example, pump assembly 26 attaches to head assembly 24 in order to pull fluid and waste material through the cleaning attachment 46 of head assembly 24. However, any type of pump assembly 26 may be used with system 10. In the arrangement shown, as one example, pump assembly 26 is an impeller pump powered by a motor and pump assembly 26 is configured to removably attach to drive member assemblies 28 and to head assembly 24 (more specifically, in the arrangement shown as one example, the outlet pipe 62 of frame 42 of head assembly 24). In various alternative arrangements, as examples, rather than pump assembly 26 being attached to drive member assemblies 28 and head assembly 24, a hose system may be attached to head assembly 24 which provides suction to pull material (liquid, gas, solids, fluid, air, waste material, etc.) through cleaning attachment 46. The hose system may be a suction hose attached at one end to head assembly 24 and at its other end to a vacuum truck, a pump, or any other mechanism capable of providing the suction to pull material (liquid, gas, solids, fluid, air, waste material, etc.) through cleaning attachment 46.

In this way, with pump assembly 26 being configured to removably attach to head assembly 24, system 10 may be used in various ways and various situations. In situations where system 10 is submerged in liquid, it is advantageous to have pump assembly 26 be positioned adjacent head assembly 24. This is because if pump assembly 26 is positioned closely to head assembly 24, and at the same elevation of head assembly 24, while system 10 is submerged in fluid, less suction is required to pull fluid and waste material through cleaning attachment 46. Comparatively, a system where a pump or other source of suction is positioned outside the liquid filled spaced and a hose is connected to head assembly 24 will need to create a much greater suction force in order to pull the same amount of material through cleaning attachment 46 and the hose system connected to head assembly 24.

In view of the foregoing, there are situations where it is advantageous to have pump assembly 26 positioned adjacent head assembly 24 such as in the arrangement shown, as one example. However, in other situations it may be more advantageous or easier to have a hose system connected to head assembly 24 such as situations where space is limited or a convenient source of suction is available and there is no need to submerge system 10. One such instance of using a hose system, rather than pump assembly 26, is when system 10 is used to clean a pipe. In situations where using a hose system is more advantageous, pump assembly 26 may be removed (or simply not attached) to head assembly 24 and a hose system may be attached to head assembly 24. In such alternative arrangements, as examples, the hose system may be a suction hose and the hose system may be connected to a vacuum truck, a pump, or any other mechanism capable of pulling material (liquid, gas, solids, fluid, air, waste material, etc.) through cleaning attachment 46.

### Pump 150:

In the arrangement shown, as one example, pump assembly 26 includes pump 150. Pump 150 is formed of any suitable size, shape, and design and is configured to create a suction force to pull fluid and waste material through cleaning attachment 46 of head assembly 24. In the arrangement shown, as one example, pump 150 is a centrifugal pump having a housing 160, an inlet 162, an impeller (not shown), an outlet 164, and an upper plate 166. In various other arrangements, pump 150 may be any other type of pump or mechanism capable of creating a suction force to move fluid through cleaning attachment 46.

In the arrangement shown, as one example, pump 150 includes a housing 160. Housing 160 is formed of any suitable size, shape, and design and is configured to house the components (mainly the impeller) of pump 150. In the arrangement shown, as one example, housing 160 includes inlet 162. Inlet 162 is formed of any suitable size, shape, and design and is configured to allow fluid and other material to flow into pump 150. In the arrangement shown, as one example, inlet 162 is a generally circular opening in housing 160 and inlet 162 is located near the center of pump 150. In the arrangement shown, as one example, inlet 162 is configured to connect to outlet pipe 62 of frame 42 of head assembly 24 such that liquid flowing through outlet pipe 62 will flow through inlet 162 and into pump 150.

In the arrangement shown, as one example, the fluid and other materials flowing into pump 150 through inlet 162 enters the general center of pump 150. When in operation, the impellers within pump 150 will be spinning and, when the material enters the general center of pump 150, one or more impeller blades will force the liquid or other material outward towards the walls of the interior of housing 160. Once the material is forced outward toward the walls of the interior of housing 160, the material will eventually exit pump 150 through outlet 164.

In the arrangement shown, as one example, pump 150 includes outlet 164. Outlet 164 is formed of any suitable size, shape, and design and is configured to allow fluid and other material to flow out of pump 150. In the arrangement shown, as one example, outlet 164 is a generally circular opening in housing 160 and outlet 164 is located at the top of pump 150. In the arrangement shown, as one example, outlet 164 is configured to connect to exhaust assembly 152 such that liquid flowing out of pump 150 through outlet 164 flows into exhaust assembly 152.

In the arrangement shown, as one example, pump 150 includes upper plate 166. Upper plate 166 is formed of any suitable size, shape, and design and is configured to facilitate connection between pump 150 and exhaust assembly 152. In the arrangement shown, as one example, upper plate 166 is a generally square or rectangular member which connects to pump 150 at top side 146. In the arrangement shown, as one example, outlet 164 extends through upper plate 166 such that material that exists outlet 164 passes through upper plate 166. In the arrangement shown, as one example, exhaust assembly 152 attaches to upper plate 166.

In the arrangement shown, as one example, the movement of material into, through, and eventually out of pump 150 creates a vacuum, which causes additional liquid and other material to be pulled through cleaning attachment 46.

### Exhaust Assembly 152:

In the arrangement shown, as one example, pump assembly 26 includes exhaust assembly 152. Exhaust assembly 152 is formed of any suitable size, shape, and design and is configured to provide a path of travel for fluid and other material leaving pump 150. In the arrangement shown, as one example, exhaust assembly 152 includes base plate 170, conduit 172, coupling 174, and connection member 176 with tabs 178.

In the arrangement shown, as one example, exhaust assembly 152 includes base plate 170. Base plate 170 is formed of any suitable size, shape, and design and is configured to facilitate connection between exhaust assembly 152 and pump 150. In the arrangement shown, as one example, base plate 170 is a generally square or rectangular, planar member which is generally shaped and sized to align with upper plate 166 of pump 150. In the arrangement shown, as one example, base plate 170 includes an opening extending through base plate 170 which allows the material exiting pump 150 through outlet 164 to flow through base plate 170. In the arrangement shown, as one example, base plate 170 is connected to upper plate 166 and is aligned such that the opening in base plate 170 is in fluid connection with outlet 164.

In the arrangement shown, as one example, exhaust assembly 152 includes conduit 172. Conduit 172 is formed of any suitable size, shape, and design and is configured to provide a path of travel for fluid or other material. In the arrangement shown, as one example, conduit 172 is a generally cylindrical pipe or tube with a hollow interior. In the arrangement shown, as one example, conduit 172 generally extends upward from base plate 170 and bends, curves, or angles toward the rearward end 142 of pump assembly 26. In the arrangement shown, as one example, the end of conduit 172 near rearward end 142 of pump assembly 26 connects to coupling 174.

Coupling 174 is formed of any suitable size, shape, and design and is configured to connect exhaust assembly 152 to a hose, pipe, tube, or other conduit which carries material pumped through pump 150 to another location to be handled appropriately. In the arrangement shown, as one example, coupling 174 is a hose coupling or similar hose fitting, however any other means of connecting conduit 172 of exhaust assembly 152 to a hose, pipe, tube, or other conduit may be used. In the arrangement shown, as one example, material that flows out of pump 150 flows through conduit 172, into and through coupling 174, and into the hose, pipe, tube, or other conduit connected to coupling 174 to another location.

In the arrangement shown, as one example, exhaust assembly 152 also includes connection member 176. Connection member 176 is formed of any suitable size, shape, and design and is configured to help securely attach exhaust assembly 152 to pump 150. In the arrangement shown, as one example, connection member 176 is generally shaped similar to a horseshoe and includes tabs 178 at each end of connection member 176. In the arrangement shown, as one example, connection member 176 is shaped to accommodate the shape of housing 160 of pump 150 and fasteners can be extended through tabs 178 in order to connect connection member 176 (and exhaust assembly 152) to pump 150.

### Motor Assembly 154:

In the arrangement shown, as one example, pump assembly 26 includes a motor assembly 154. Motor assembly 154 is formed of any suitable size, shape, and design and is configured to provide power to pump 150. In the arrangement shown, as one example, motor assembly 154 is connected to pump 150 and provides power to pump 150 in order to cause the rotation of the impellers within pump 150. In the arrangement shown, as one example, motor assembly 154 of pump assembly 26 includes a motor (not shown) within housing 180.

Motor: In the arrangement shown, as one example, motor assembly 154 includes a motor. The motor of motor assembly 154 is formed of any suitable size, shape, and design and is configured to provide power to facilitate operation of pump 150. In the arrangement shown, as one example, the motor of motor assembly 154 is configured to facilitate the rotation of the impellers within pump 150 which, in turn, causes fluid and other material to be pulled through cleaning attachment 46 of head assembly 24. In the arrangement shown, as one example, the motor of motor assembly 154 is an electric motor, however any other type of motor, engine, or power source may be used in order to provide power to facilitate operation of pump 150, such as a gas engine, a diesel engine, a solar energy source, a wind powered energy source, or any other source of energy or power.

In the arrangement shown, as one example, the motor of motor assembly 154 includes a drive shaft (not shown) which extends outward from the motor and operably connects to the impellers of pump 150. In the arrangement shown, as one example, when the motor of motor assembly 154 is turned on, the motor will cause the drive shaft to rotate, which will, in turn, cause rotation of the impellers in pump 150. In this way, the motor of motor assembly 154 provides power to facilitate operation of pump 150.

Housing: In the arrangement shown, as one example, the motor of motor assembly 154 is hermetically sealed within housing 180. Housing 180 is formed of any suitable size, shape, and design and is configured to hermetically seal the motor of motor assembly 154 in order to allow the motor of motor assembly 154 to function while system 10 is submerged under a liquid or other material. In the arrangement shown, as one example, housing 180 is configured to operably connect to the rearward side of pump 150 such that the motor of motor assembly 154 is hermetically sealed within housing 180 and still able to operably connect to pump 150 to cause rotation of the impellers of pump 150. In the arrangement shown, as one example, housing 180 is also configured to facilitate electrical connection between single electrical cable 380 and the motor of motor assembly 154 in order to provide electricity to the motor of motor assembly 154.

### Pump Frame 156:

In the arrangement shown, as one example, pump 150 and motor assembly 154 are supported by pump frame 156. Pump frame 156 is formed of any suitable size, shape, and design and is configured to support pump 150 and motor assembly 154 and facilitate operable connection between pump assembly 26 and drive member assemblies 28. In the arrangement shown, as one example, pump frame 156 is formed of brackets 182 and a bottom plate 184.

In the arrangement shown, as one example, pump frame 156 includes brackets 182. Brackets 182 are formed of any suitable size, shape, and design and are configured to help support components of pump assembly 26. In the arrangement shown, as one example, brackets 182 are generally L-shaped and connect at their upper end to the housing 180 of motor assembly 154 and at their lower end to bottom plate 184.

In the arrangement shown, as one example, pump frame 156 includes bottom plate 184. Bottom plate 184 is formed of any suitable size, shape, and design and is configured to help support components of pump assembly 26. In the arrangement shown, as one example, bottom plate 184 is a generally rectangular, planar member which extends a width between opposing ends and a length between opposing sides. In the arrangement shown, as one example, bottom plate 184 connects to a bracket 182 at each of the opposing sides of bottom plate 184. In the arrangement shown, as one example, pump frame 156 is also configured to operably attach to drive member assemblies 28, thereby connecting pump assembly 26 to drive member assemblies 28.

While pump assembly 26 and its various components have been described according the arrangement shown, as one example, it will be understood by those skilled in the art that any other configuration of pump assembly 26 may be used in order to facilitate cleaning of the floor of an enclosed space.

### Drive Member Assemblies 28:

In the arrangement shown, as one example, system 10 includes drive member assemblies 28. Drive member assemblies 28 are formed of any suitable size, shape, and design and are configured to facilitate the movement of system 10. In the arrangement shown, as one example, there are two drive member assemblies 28. That is, in the arrangement shown, as one example, there is a first drive member assembly 28 and a second drive member assembly 28. However, in various alternative arrangements, as examples, any number of drive member assemblies 28 may be used on system 10.

In the arrangement shown, as one example, drive member assemblies 28 are track assemblies 190. In the arrangement shown, as one example, track assemblies 190 include a frame 192, a motor assembly 194, and a track system 196. While drive member assemblies 28 are track assemblies 190 in the arrangement shown, as one example, in various alternative arrangements any other type of drive member may be used as drive member assemblies 28 including, but not limited to, wheels.

### Frame 192:

In the arrangement shown, as one example, track assemblies 190 include frame 192. Frame 192 is formed of any suitable size, shape, and design and is configured to support the various components of track assemblies 190. In the arrangement shown, as one example, frame 192 is generally in the shape of a stadium, with elongated top and bottom sides and rounded forward and rearward sides. In the arrangement shown, as one example, frame 192 includes an interior wall 200, an exterior wall 202, a top wall 204, and a bottom wall 206.

In various arrangements, as examples, frame 192 of track assemblies 190 is formed of a single, unitary member that is formed in a manufacturing process such as machining. More specifically, in various arrangements, as examples, frame 192 of track assemblies 190 is formed by using a CNC milling machine or CNC laser machine which removes portions from a solid block of material to form frame 192. Once frame 192 of track assemblies 190 is completed, then additional components of track assemblies 190, such as the motor assembly 194 and track system 196, may be connected to frame 192. Alternatively, frame 192 may be formed of multiple pieces that are connected or assembled to one another through welding or any other means of connecting or assembling the multiple pieces of frame 192 including bolting, screwing, friction fitting, adhesion, or the like. In the arrangement shown, as one example, frame 192 is formed primarily of aluminum, however any other metallic material may be used such as steel, stainless steel, brass, copper, chromium, or any other metallic material, alloy, and/or composite thereof. Alternatively, frame 192 may be formed of a non-metallic material such as a plastic material, a fiberglass material, or any other non-metallic material and/or composite thereof.

Interior Wall: In the arrangement shown, as one example, frame 192 includes an interior wall 200. Interior wall 200 is formed of any suitable size, shape, and design and is configured to help support various components of track assemblies 190. In the arrangement shown, as one example, interior wall 200 is a generally planar member in the shape of a stadium, with elongated top and bottom sides and rounded forward and rearward sides. In the arrangement shown, as one example, interior wall 200 is configured to connect to top wall 204 and bottom wall 206.

In the arrangement shown, as one example, interior wall 200 includes a first opening 210 and fastener openings. In the arrangement shown, as one example, first opening 210 is a generally circular opening extending through interior wall 200. In the arrangement shown, as one example, first opening 210 is configured to allow components of track system 196 to extend through interior wall 200. In the arrangement shown, as one example, fastener openings also extend through interior wall 200 and are positioned near first opening 210. The fastener openings are formed of any suitable, size, shape, and design and are configured to receive fasteners in order to connect bearings 360 of drive wheel 346 of track system 196 to frame 192.

In the arrangement shown, as one example, interior wall 200 also includes a first slot 214 and fastener slots. In the arrangement shown, as one example, first slot 214 is a generally ovular or stadium-shaped opening extending through interior wall 200. In the arrangement shown, as one example, first slot 214 is configured to allow components of track system 196 to extend through interior wall 200. In the arrangement shown, as one example, first slot 214 is elongated such that the axle 374 of idler wheel 350 can be positioned and adjusted along the length of first slot 214 to ensure proper tension is placed on track 348 while track 348 extends around both drive wheel 346 and idler wheel 350. In the arrangement shown, as one example, fastener slots also extend through interior wall 200 and are positioned near first slot 214. The fastener slots are formed of any suitable size, shape, and design and are configured to receive fasteners in order to connect bearing 376 of idler wheel 350 of track system 196 to frame 192. Similar to first slot 214, fastener slots are elongated such that the bearing 376 of idler wheel 350 can be positioned and adjusted along the length of fastener slots to ensure proper tension is placed on track 348 while track 348 extends around both drive wheel 346 and idler wheel 350.

In the arrangement shown, as one example, interior wall 200 also includes an open center 218. Open center 218 is formed of any suitable size, shape, and design and is configured to allow motor assembly 194 of track assemblies 190 to rest within frame 192. In the arrangement shown, as one example, open center 218 is a generally rectangular opening extending through interior wall 200. In the arrangement shown, as one example, the lower edge created by open center 218 also helps provide support to motor assembly 194.

Top Wall and Bottom Wall: In the arrangement shown, as one example, frame 192 includes top wall 204 and bottom wall 206. Top wall 204 and bottom wall 206 are formed of any suitable size, shape, and design and are configured to help support various components of track assemblies 190, and provide rigidity and support to, and connection between, interior wall 200 and exterior wall 202. In the arrangement shown, as one example, top wall 204 and bottom wall 206 are generally rectangular, planar members which extend a length between opposing ends and a width between opposing sides. In the arrangement shown, as one example, one opposing side of each of the top wall 204 and bottom wall 206 connects to interior wall 200 and the other opposing side of top wall 204 and bottom wall 206 connects to exterior wall 202.

Exterior Wall: In the arrangement shown, as one example, frame 192 includes an exterior wall 202. Exterior wall 202 is formed of any suitable size, shape, and design and is configured to help support various components of track assemblies 190. In the arrangement shown, as one example, exterior wall 202 is a generally planar member in the shape of a stadium, with elongated top and bottom sides and rounded forward and rearward sides. In the arrangement shown, as one example, exterior wall 202 is configured to connect to top wall 204 and bottom wall 206.

In the arrangement shown, as one example, exterior wall 202 includes a first opening 220 and fastener openings. In the arrangement shown, as one example, first opening 220 is a generally circular opening extending through exterior wall 202. In the arrangement shown, as one example, first opening 220 is configured to allow components of track system 196 to extend through exterior wall 202. In the arrangement shown, as one example, first opening 220 of exterior wall 202 is in alignment with first opening 210 of interior wall 200, such that the axle 358 of drive wheel 346 of track system 196 may extend through both first opening 210 of interior wall 200 and first opening 220 of exterior wall 202. In the arrangement shown, as one example, fastener openings also extend through exterior wall 202 and are positioned near first opening 220. The fastener openings are formed of any suitable size, shape, and design and are configured to receive fasteners in order to connect bearing 360 of drive wheel 346 of track system 196 to frame 192.

In the arrangement shown, as one example, exterior wall 202 also includes a first slot 224 and bearing fastener slots. In the arrangement shown, as one example, first slot 224 is a generally ovular or stadium-shaped opening extending through exterior wall 202. In the arrangement shown, as one example, first slot 224 is configured to allow components of track system 196 to extend through exterior wall 202. In the arrangement shown, as one example, first slot 224 is elongated such that the axle 374 of idler wheel 350 can be positioned and adjusted along the length of first slot 224 to ensure proper tension is placed on track 348 while track 348 extends around both drive wheel 346 and idler wheel 350. In the arrangement shown, as one example, first slot 224 of exterior wall 202 is in alignment with first slot 214 of interior wall 200, such that the axle 374 of idler wheel 350 of track system 196 may extend through both first slot 214 of interior wall 200 and first slot 224 of exterior wall 202.

In the arrangement shown, as one example, bearing fastener slots also extend through exterior wall 202 and are positioned near first slot 224. The bearing fastener slots are formed of any suitable size, shape, and design and are configured to receive fasteners in order to connect bearing 376 of idler wheel 350 of track system 196 to frame 192. Similar to first slot 224, bearing fastener slots are elongated such that the bearing 376 of idler wheel 350 can be positioned and adjusted along the length of fastener slots to ensure proper tension is placed on track 348 while track 348 extends around both drive wheel 346 and idler wheel 350.

In the arrangement shown, as one example, exterior wall 202 also includes a second slot 228 and motor fastener slots. In the arrangement shown, as one example, second slot 228 is a generally ovular or stadium-shaped opening extending through exterior wall 202. In the arrangement shown, as one example, second slot 228 is configured to allow components of motor assembly 194 to extend through exterior wall 202. In the arrangement shown, as one example, second slot 228 is elongated in order to accommodate potential variations in the length of motor assembly 194. In the arrangement shown, as one example, motor fastener slots also extend through exterior wall 202 and are positioned near second slot 228. The motor fastener slots are formed of any suitable size, shape, and design and are configured to receive fasteners in order to help connect motor assembly 194 to frame 192. Similar to second slot 228, motor fasteners slots are elongated in order to accommodate potential variations in the length of motor assembly 194.

### Motor Assembly 194:

In the arrangement shown, as one example, track assemblies 190 include motor assembly 194. Motor assembly 194 is formed of any suitable size, shape, and design and is configured to provide power to track assemblies 190 and/or any other drive member assemblies 28. In the arrangement shown, as one example, motor assembly 194 includes a housing 234, a motor 236, and a gear assembly 238, among other components described herein.

Housing: In the arrangement shown, as one example, motor assembly 194 includes housing 234. Housing 234 is formed of any suitable size, shape, and design and is configured to enclose motor 236 and facilitate operable connection to frame 192. More specifically, in the arrangement shown, as one example, housing 234 is configured to hermetically seal motor 236 therein in order to allow motor 236 to function while system 10 is submerged under a liquid or other material, and housing 234 is configured to operably connect to exterior wall 202 of frame 192. In the arrangement shown, as one example, housing 234 of motor assembly 194 of track assemblies 190 is similar to housing 78 of motor assembly 44 of head assembly 24. That is, in the arrangement shown, as one example, housing 234 includes a first end plate 240, a first coupler 242, a main tube 244, and a second end plate 246, among other components described herein.

In the arrangement shown, as one example, housing 234 includes a first end plate 240. First end plate 240 is formed of any suitable size, shape, and design and is configured to help enclose and seal motor 236 within housing 234. In the arrangement shown, as one example, first end plate 240 is a generally square or rectangular member with an exterior side and an interior side, and an aperture extending through first end plate 240 from the exterior side to the interior side. In the arrangement shown, as one example, the exterior side of first end plate 240 includes an electrical connector 248. Electrical connector 248 is formed of any suitable size, shape, and design and is configured to connect to single electrical cable 380 and to motor 236 in order to transfer the electricity moving through single electrical cable 380 to motor 236.

In the arrangement shown, as one example, first end plate 240 has a connection member 250 extending outward from the interior side of first end plate 240. Connection member 250 is formed of any suitable size, shape, and design and is configured to facilitate operable connection between first end plate 240 and motor 236. In the arrangement shown, as one example, connection member 250 is a generally cylindrical member extending outward from the interior side of first end plate 240. In the arrangement shown, as one example, connection member 250 includes a threaded portion 252. In the arrangement shown, as one example, connection member 250 is generally sized such that first coupler 242 may be threaded onto the threaded portion 252 of connection member 250 and the threaded portion 252 is able to rest within close and tight tolerances in the hollow center of first coupler 242.

In the arrangement shown, as one example, housing 234 includes first coupler 242. First coupler 242 is formed of any suitable size, shape, and design and is configured to facilitate operable connection between first end plate 240 and motor 236. In the arrangement shown, as one example, first coupler 242 is a generally cylindrical member that has a hollow center and an internally threaded portion (not shown). In this arrangement, first coupler 242 may be threaded onto connection member 250 of first end plate 240. In the arrangement shown, as one example, first coupler 242 also connects to motor 236, thereby helping to facilitate connection between first end plate 240 and motor 236.

In the arrangement shown, as one example, housing 234 also includes main tube 244. Main tube 244 is formed of any suitable size, shape, and design and is configured to help facilitate the hermetic sealing of motor 236 within housing 234. In the arrangement shown, as one example, main tube 244 is a generally cylindrical member which extends between opposing ends and has a hollow center. In the arrangement shown, as one example, the connection member 250 of first end plate 240, first coupler 242, motor 236, and the connection member 254 of second end plate 246 fit within the hollow center of main tube 244. In the arrangement shown, as one example, the opposing ends of main tube 244 connect to first end plate 240 and second end plate 246 in a manner which creates a hermetic (i.e. airtight) seal within the hollow center of main tube 244.

In the arrangement shown, as one example, housing 234 includes second end plate 246. Second end plate 246 is formed of any suitable size, shape, and design and is configured to help enclose and seal motor 236 within housing 234. In the arrangement shown, as one example, second end plate 246 is a generally square or rectangular member with an exterior side and an interior side. In the arrangement shown, as one example, a connection member 254 extends outward from the interior side of second end plate 246. In the arrangement shown, as one example, connection member 254 is configured to support a portion of motor 236 and also allow the adapter 266 of motor 236 to extend through second end plate 246. In this arrangement, a portion of motor 236 is connected to adapter 266 of motor 236 and the adapter 266 is extended through an open center extending through connection member 254 and second end plate 246.

In the arrangement shown, as one example, second end plate 246 also includes bearing 258 and seal member 260. In the arrangement shown, as one example, the adapter 266 of motor 236 extends through the open center of connection member 254 and second end plate 246. In the arrangement shown, as one example, the adapter 266 of motor 236 extends through bearing 258 and bearing 258 helps support adapter 266 while still allowing adapter 266 to rotate in order to facilitate rotation of drive member assemblies 28. In the arrangement shown, as one example, sealing member 260 is included in second end plate 246 in order to ensure the hermetic seal of housing 234. In the arrangement shown, the open center extending through connection member 254 and second end plate 246 may cause issues with the seal of housing 234, which would in turn affect the operability of motor 236. To ensure the proper seal of housing 234, second end plate 246 includes seal member 260. In the arrangement shown, as one example, seal member 260 is comprised of a seal cover 261, two spring loaded shaft seals 262, and two O-rings 263. In the arrangement shown, as one example, the seal member 260 effectively creates a water-tight seal when seal member 260 is placed around the exterior of adapter 266 of motor 236 after adapter 266 has been extended through the opening in connection member 254 and second end plate 246.

Motor: In the arrangement shown, as one example, motor assembly 194 includes motor 236. Motor 236 is formed of any suitable size, shape, and design and is configured to facilitate movement of drive member assemblies 28. In the arrangement shown, as one example, motor 236 is an electric motor, however any other type of motor, engine, or power source may be used in order to facilitate movement of drive member assemblies 28, such as a gas engine, a diesel engine, a solar energy source, a wind powered energy source, or any other source of energy or power. In the arrangement shown, as one example motor 236 is attached to first coupler 242 which connects to connection member 250 of first end plate 240, thereby operably connecting motor 236 to housing 234.

In the arrangement shown, as one example, motor 236 includes a drive shaft 264 which extends outward from motor 236. Additionally, in the arrangement shown, as one example, motor 236 includes adapter 266. Adapter 266 is formed of any suitable size, shape, and design and is configured to connect to drive shaft 264, rotate with drive shaft 264, and extend outward a distance further than drive shaft 264. In this way, the rotation of drive shaft 264 is extended by adapter 266 so that the rotation can be translated to gear assembly 238 of motor assembly 194.

Gear Assembly: In the arrangement shown, as one example, motor assembly 194 includes gear assembly 238. Gear assembly 238 is formed of any suitable size, shape, and design and is configured to translate rotation of motor 236 to movement of drive member assemblies 28. In the arrangement shown, as one example, gear assembly 238 includes a gear box housing 270, first sprocket 272, a chain, and second sprocket 276.

In the arrangement shown, as one example, the rotation of drive member assemblies 28 (in this instance, track assemblies 190) is perpendicular to the rotation of drive shaft 264 and adapter 266 of motor 236, therefore the rotation of drive shaft 264 and adapter 266 is translated 90 degrees in order to properly rotate drive member assemblies 28. In the arrangement shown, as one example, gear assembly 238 accomplishes translation of the rotation of drive shaft 264 and adapter 266 90 degrees in order to facilitate rotation of drive member assemblies 28. More specifically, the components of gear box housing 270 operate to cause the rotation of drive shaft 264 and adapter 266 to be translated 90 degrees to facilitate rotation of drive member assemblies 28.

In the arrangement shown, as one example, gear assembly 238 includes gear box housing 270. Gear box housing 270 is formed of any suitable size, shape, and design and is configured to facilitate the translation of the rotation of shaft 264 and adapter 266 90 degrees to facilitate rotation of drive member assemblies 28. In the arrangement shown, as one example, gear box housing 270 includes a first half 280, a second half 282, a first miter gear 284, a second miter gear 286, and a shaft 288, among other components described herein.

First Half of Gear Box Housing: In the arrangement shown, as one example, the gear box housing 270 is positioned adjacent second end plate 246 of housing 234 of motor assembly 194. In the arrangement shown, as one example, gear box housing 270 includes first half 280 and second half 282. First half 280 is formed of any suitable size, shape, and design and is configured to help enclose portions of gear assembly 238. In the arrangement shown, as one example, first half 280 is a generally rectangular member which extends a width between an exterior side and an interior side 292, a length between a front end and a back end, and a height between a top side 298 and a bottom side. In the arrangement shown, as one example, first half 280 includes a channel 302, a protrusion 304, and a bearing 306.

In the arrangement shown, as one example, first half 280 of gear box housing 270 includes a channel 302. Channel 302 is formed of any suitable size, shape, and design and is configured to provide a space where internal components of gear box housing 270 are located. In the arrangement shown, as one example, channel 302 is an open space in first half 280. In the arrangement shown, as one example, channel 302 extends forward a distance from the back end to near the front end, without reaching the front end. Additionally, the channel 302 extends a depth inward from interior side 292 a distance to near the exterior side, without reaching the exterior side. This leaves an open area in first half 280 where adapter 266 of motor 236 of motor assembly 194 can extend into first half 280.

In the arrangement shown, as one example, first half 280 also includes a protrusion 304 and a bearing 306. Protrusion 304 is formed of any suitable size, shape, and design and is configured to allow space for bearing 306 to be positioned within first half 280. In the arrangement shown, as one example, protrusion 304 extends outward from the exterior side of first half 280 and creates a further open space (in addition to the open space created by channel 302) within first half 280. In the arrangement shown, as one example, bearing 306 rests within the open space created by protrusion 304. In the arrangement shown, as one example, bearing 306 is positioned such that an opening extending through bearing 306 is perpendicular to the exterior side of first half 280. In the arrangement shown, as one example, shaft 288 is placed through the opening in bearing 306 and extends outward from bearing 306 a distance past the interior side 292 of first half 280 and past the exterior side 310 of second half 282.

Second Half of Gear Box Housing: In the arrangement shown, as one example, gear box housing 270 also includes second half 282. Second half 282 is formed of any suitable size, shape, and design and is configured to help enclose portions of gear assembly 238. In the arrangement shown, as one example, second half 282 is a generally rectangular member which extends a width between an exterior side 310 and an interior side, a length between a front end and a back end, and a height between a top side 318 and a bottom side. In the arrangement shown, as one example, second half 282 includes a channel 322, a recess 324, a bearing 326, a seal member 328, a seal housing 330, an O-ring 332, a spring loaded shaft seal 334, and a seal cover 336.

In the arrangement shown, as one example, second half 282 of gear box housing 270 includes a channel 322. Channel 322 is formed of any suitable size, shape, and design and is configured to provide a space where internal components of gear box housing 270 are located. In the arrangement shown, as one example, channel 322 is an open space in second half 282. In the arrangement shown, as one example, channel 322 extends forward a distance from the back end to near the front end, without reaching the front end. Additionally, the channel 322 extends a depth inward from the interior side a distance to near exterior side 310, without reaching exterior side 310. This leaves an open area in second half 282 where adapter 266 of motor 236 of motor assembly 194 can extend into second half 282.

In the arrangement shown, as one example, second half 282 also includes a recess 324 and a bearing 326. Recess 324 is formed of any suitable size, shape, and design and is configured to allow space for bearing 326 to be positioned in second half 282. In the arrangement shown, as one example, recess 324 extends inward from the exterior side 310 of second half 282 and creates a space within which bearing 326 rests. In the arrangement shown, as one example, bearing 326 rests within the open space created by recess 324. In the arrangement shown, as one example, bearing 326 is positioned such that an opening extending through bearing 326 is perpendicular to the exterior side 310 of second half 282. In the arrangement shown, as one example, second half 282 also includes an opening 327 which extends through second half 282 and allows shaft 288 to extend out from gear box housing 270. In the arrangement shown, as one example, shaft 288 extends through the opening in bearing 326 and through opening 327 a distance past the exterior side 310 of second half 282.

In the arrangement shown, as one example, second half 282 of gear box housing 270 includes seal member 328. In the arrangement shown, as one example, the opening in bearing 326 and opening 327 of second half 282 may cause issues with the seal of gear box housing 270, which in turn may cause issues with the seal of housing 234 of motor assembly 194. To ensure the proper seal, second half 282 of gear box housing 270 includes seal member 328. In the arrangement shown, as one example, seal member 328 is comprised of a seal housing 330 which is configured to receive O-ring 332 and spring loaded shaft seal 334 of seal member 328. In the arrangement shown, as one example, with O-ring 332 and spring loaded shaft seal 334 positioned in seal housing 330, seal cover 336 is then placed over O-ring 332 and spring loaded shaft seal 334, and at least partially in seal housing 330. In the arrangement shown, as one example, seal member 328 effectively creates a water-tight seal when seal member 328 is placed around the exterior of shaft 288 after shaft 288 has been extended through the opening in bearing 326 and through opening 327 in second half 282.

Shaft: In the arrangement shown, as one example, gear box housing 270 includes shaft 288. Shaft 288 is formed of any suitable size, shape, and design and is configured to cause rotation of drive member assemblies 28. In the arrangement shown, as one example, shaft 288 is configured to facilitate the rotation of drive wheel 346 of track system 196 of track assemblies 190. In the arrangement shown, as one example, shaft 288 is an elongated cylindrical member which extends a length between opposing ends. In the arrangement shown, as one example, at least a portion of shaft 288 is housed within gear box housing 270 and at least a portion of shaft 288 extends outward from gear box housing 270 in order to connect to first sprocket 272 of gear assembly 238.

In the arrangement shown, as one example, shaft 288 rotates about an axis of rotation which is perpendicular to the axis of rotation of adapter 266 of motor 236. In this arrangement, as one example, the rotation of adapter 266 is translated 90-degrees before motor 236 can power the rotation of shaft 288. In the arrangement shown, as one example, shaft 288 is caused to rotate due to the interaction between adapter 266, first miter gear 284, and second miter gear 286.

First Miter Gear and Second Miter Gear: In the arrangement shown, as one example, first half 280 and second half 282 are configured to be brought together to form a box-like structure which attaches to the exterior side of second end plate 246 of housing 234 of motor assembly 194. In the arrangement shown, as one example, channel 302 of first half 280 and channel 322 of second half 282 fit together to form a channel which allows adapter 266 of motor 236 to extend into the interior of the box-like structure. In the arrangement shown, as one example, first miter gear 284 and second miter gear 286 are present within gear box housing 270 and operate to translate rotation of adapter 266 of motor 236 90-degrees to allow for the proper rotation of drive member assemblies 28.

First miter gear 284 and second miter gear 286 are formed of any suitable size, shape, and design and are configured to translate the rotation of adapter 266 of motor 236 90-degrees to allow for proper rotation of drive member assemblies 28. In the arrangement shown, as one example, first miter gear 284 and second miter gear 286 are 20 tooth miter gears with a ¾″ bore, however any other type of miter gear, or any other type of gear, may be used to translate the rotation of adapter 266 90-degrees.

In the arrangement shown, as one example, first miter gear 284 is configured to operably connect to adapter 266 of motor 236 at a location along adapter 266 such that first miter gear 284 is positioned within gear box housing 270 when adapter 266 is extended at least partially into gear box housing 270. In the arrangement shown, as one example, first miter gear 284 is held on adapter 266 within close and tight tolerances such that when adapter 266 rotates, first miter gear 284 rotates as well. In the arrangement shown, as one example, the axis of rotation of first miter gear 284 is colinear with the axis of rotation of adapter 266 and drive shaft 264 of motor 236.

In the arrangement shown, as one example, second miter gear 286 is configured to operably connect to shaft 288 of gear box housing 270 at a location along shaft 288 such that second miter gear 286 is positioned within gear box housing 270. In the arrangement shown, as one example, second miter gear 286 is held on shaft 288 within close and tight tolerances such that when shaft 288 rotates, second miter gear 286 rotates as well. In the arrangement shown, as one example, the axis of rotation of second miter gear 286 is colinear with the axis of rotation of shaft 288, which is perpendicular to the axis of rotation of adapter 266 and first miter gear 284.

In the arrangement shown, as one example, when first miter gear 284 and second miter gear 286 are positioned within gear box housing 270, the teeth of first miter gear 284 fit between the teeth of second miter gear 286 and likewise, the teeth of second miter gear 286 fit within the teeth of first miter gear 284. In this arrangement, as one example, when motor 236 causes drive shaft 264 to rotate, which subsequently causes adapter 266 to rotate, adapter 266 causes first miter gear 284 to rotate. When first miter gear 284 rotates, the teeth of first miter gear 284 will contact the teeth of second miter gear 286, thereby causing rotation of second miter gear 286 and shaft 288. In the arrangement shown, as one example, because the axis of rotation of second miter gear 286 is perpendicular to the axis of rotation of first miter gear 284, the rotation of adapter 266 is translated 90-degrees to allow shaft 288 to rotate with an axis of rotation that is perpendicular to the axis of rotation of adapter 266. The rotation of shaft 288 is then translated to gear assembly 238 and subsequently drive member assemblies 28. The end result is that drive member assemblies 28 are able to rotate even though their axis of rotation is perpendicular to the axis of rotation of drive shaft 264 and adapter 266 of motor 236.

In the arrangement shown, as one example, shaft 288 extends out from gear box housing 270. In order to facilitate the rotation of drive member assemblies 28, the rotation of shaft 288 is transferred to drive member assemblies 28 through the use of first sprocket 272, the chain, and second sprocket 276 of gear assembly 238.

First Sprocket: In the arrangement shown, as one example, first sprocket 272 is configured to connect to shaft 288. In the arrangement shown, as one example, shaft 288 extends through the middle of first sprocket 272 and is engaged with first sprocket 272 in close and tight tolerances such that when shaft 288 rotates, first sprocket 272 also rotates. In the arrangement shown, as one example, first sprocket 272 includes teeth. In the arrangement shown, as one example, the teeth extend outward from first sprocket 272 and are configured to engage the chain of gear assembly 238.

Chain: In the arrangement shown, as one example, gear assembly 238 includes the chain. The chain of gear assembly 238 is formed of any suitable size, shape, and design and is configured to connect first sprocket 272 to second sprocket 276 in order to transfer rotation of first sprocket 272 to second sprocket 276. In the arrangement shown, as one example, the chain of gear assembly 238 is configured to extend around both first sprocket 272 and second sprocket 276. In this arrangement, shown as one example, when the shaft 288 of gear box housing 270 rotates, first sprocket 272 is forced to rotate. As first sprocket 272 rotates, the teeth of first sprocket 272 engage the chain of gear assembly 238 and cause the chain of gear assembly 238 to rotate. In the arrangement shown, as one example, the chain of gear assembly 238 is also wrapped around second sprocket 276. In the arrangement shown, as one example, second sprocket 276 also includes teeth. When the chain of gear assembly 238 is caused to rotate by the rotation of first sprocket 272, the chain of gear assembly 238 engages with the teeth of second sprocket 276, thereby causing second sprocket 276 to rotate as well.

Second Sprocket: In the arrangement shown, as one example, second sprocket 276 engages with the chain of gear assembly 238 through the teeth of second sprocket 276 as described herein. In the arrangement shown, as one example, second sprocket 276 is also configured to allow the axle 358 of drive member assemblies 28, and more specifically axle 358 of drive wheel 346 of track system 196 of track assemblies 190, to extend through second sprocket 276 and engage second sprocket 276 in close and tight tolerances. In this arrangement, shown as one example, when second sprocket 276 rotates, it also causes the rotation of axle 358 of drive member assemblies 28. In this way, motor assembly 194 of track assemblies 190 facilitates rotation of drive member assemblies 28 which, in the arrangement shown as one example, are track assemblies 190.

### Track System 196:

In the arrangement shown, as one example, track assemblies 190 include track system 196. Track system 196 is formed of any suitable size, shape, and design and is configured to contact the ground or floor where system 10 is located and drive system 10 around the ground or floor in that location. In the arrangement shown, as one example, track system 196 includes a drive wheel 346, tracks 348, and an idler wheel 350.

Drive Wheel: In the arrangement shown, as one example, track system 196 includes drive wheel 346. Drive wheel 346 is formed of any suitable size, shape, and design and is configured to facilitate rotation of track system 196. In the arrangement shown, as one example, drive wheel 346 is a wheel which forces tracks 348 to rotate when drive wheel 346 rotates. In the arrangement shown, as one example, drive wheel 346 is a generally round member with teeth 354 extending outward from the round body of drive wheel 346. In the arrangement shown, as one example, drive wheel 346 also includes an opening 356, an axle 358, and bearings 360.

In the arrangement shown, as one example, drive wheel 346 includes opening 356. In the arrangement shown, as one example, opening 356 is generally circular in shape and extends through drive wheel 346 from one side to the other side of drive wheel 346. In the arrangement shown, as one example, opening 356 is located approximately at the center of drive wheel 346 and is configured to receive axle 358 therein and engage axle 358 in close and tight tolerances.

In the arrangement shown, as one example, axle 358 is a generally cylindrical member which is configured to extend through bearings 360 and the opening 356 in drive wheel 346. In the arrangement shown, as one example, axle 358 is held within close and tight tolerances in opening 356 such that when axle 358 rotates, drive wheel 346 rotates. In the arrangement shown, as one example, axle 358 is also held within close and tight tolerances in the opening of second sprocket 276 of gear assembly 238. In the arrangement shown, as one example, when second sprocket 276 rotates (as further described herein), axle 358 is forced to rotate as well, which in turn forces drive wheel 346 to rotate.

In the arrangement shown, as one example, bearings 360 are provided to help support axle 358 and allow axle 358 to cause rotation of drive wheel 346. In the arrangement shown, as one example, bearings 360 are flange bearings which connect to the interior wall 200 and exterior wall 202 of frame 192. More specifically, in the arrangement shown as one example, bearings 360 are connected to interior wall 200 and exterior wall 202 such that axle 358 extends through first opening 210 of interior wall 200 and first opening 220 of exterior wall 202. In this way, bearings 360 also help to secure the connection between frame 192 and track system 196.

Tracks: In the arrangement shown, as one example, track system 196 includes tracks 348. Tracks 348 are formed of any suitable size, shape, and design and are configured to rotate around drive wheel 346 and idler wheel 350 and engage the ground or floor where system 10 is located in order to drive system 10 around the ground or floor. In the arrangement shown, as one example, track 348 is a rubber track which forms a continuous loop such as, by way of example and not limitation, the rubber tracks commonly used on skid steers. However, it is hereby contemplated that any other type of track, or any track formed of another material can be used as track 348.

In the arrangement shown, as one example, track 348 includes inner teeth and outer teeth. In the arrangement shown, as one example, the inner teeth extend outward from the interior surface of track 348. In the arrangement shown, as one example, the inner teeth of track 348 are configured to engage with teeth 354 of drive wheel 346 and with teeth 370 of idler wheel 350. In the arrangement shown, as one example, the outer teeth of track 348 extend outward from the exterior surface of track 348. In the arrangement shown, as one example, the outer teeth of track 348 are configured to engage the ground or floor where system 10 is located and cause system 10 to be driven around the ground or floor.

In the arrangement shown, as one example, track 348 forms a loop which extends around both drive wheel 346 and idler wheel 350. In the arrangement shown, as one example, drive wheel 346 is effectively fixed in place due to the limited ability to adjust when axle 358 of drive wheel 346 is extended through first opening 210 of interior wall 200 and first opening 220 of exterior wall 202. For this reason, in order to keep track 348 tightly extended around both drive wheel 346 and idler wheel 350, idler wheel 350 is adjustable along the length of first slot 214 of interior wall 200 and first slot 224 of exterior wall 202. That is, idler wheel 350 may be positioned anywhere along the length of first slot 214 of interior wall 200 and first slot 224 of exterior wall 202 in order to keep track 348 pulled tight.

Idler Wheel: In the arrangement shown, as one example, track system 196 includes idler wheel 350. Idler wheel 350 is formed of any suitable size, shape, and design and is configured to help keep track 348 tight and rotating properly when system 10 is being driven around the ground or floor. In the arrangement shown, as one example, idler wheel 350 is a generally round member with teeth 370 extending outward from the round body of idler wheel 350. In the arrangement shown, as one example, idler wheel 350 also includes an opening 372, an axle 374, and bearings 376.

In the arrangement shown, as one example, idler wheel 350 includes opening 372. In the arrangement shown, as one example, opening 372 is generally circular in shape and extends through idler wheel 350 from one side to the other side of idler wheel 350. In the arrangement shown, as one example, opening 372 is located approximately at the center of idler wheel 350 and is configured to receive axle 374 therein.

In the arrangement shown, as one example, axle 374 is a generally cylindrical member which is configured to extend through bearings 376 and the opening 372 in idler wheel 350. In the arrangement shown, as one example, axle 374 is held within close and tight tolerances in opening 372 such that when idler wheel 350 is forced to rotate by track 348, axle 374 also rotates. In the arrangement shown, as one example, bearings 376 are provided to help support axle 374. In the arrangement shown, as one example, bearings 376 are flange bearings which connect to the interior wall 200 and exterior wall 202 of frame 192. More specifically, in the arrangement shown as one example, bearings 376 are connected to interior wall 200 and exterior wall 202 such that axle 374 extends through first slot 214 of interior wall 200 and first slot 224 of exterior wall 202. In this way, bearings 376 also help to secure the connection between frame 192 and track system 196. In the arrangement shown, as one example, bearings 376 may be positioned at any location along the length of first slot 214 of interior wall 200 and first slot 224 of exterior wall 202, such that axle 374 and idler wheel 350 are positioned at a location which allows track 348 to be kept tight when it extends around drive wheel 346 and idler wheel 350.

In the arrangement shown, as one example, when drive wheel 346 is caused to rotate via gear assembly 238 of motor assembly 194 (as described herein), teeth 354 of drive wheel 346 engage the inner teeth of track 348. When teeth 354 of drive wheel 346 engage the inner teeth of track 348, track 348 is caused to rotate. When track 348 rotates, the inner teeth of track 348 also engage with teeth 370 of idler wheel 350 and cause idler wheel 350 to rotate as well. In the arrangement shown, as one example, when drive wheel 346 causes track 348 to rotate, the outer teeth of track 348 engage with the ground or floor where system 10 is located and this engagement with the ground or floor causes system 10 to move. In this way, track assemblies 190 facilitate the movement of system 10 and allow system 10 to clean the floor or ground where system 10 is located.

### Electrical Cable 380:

In the arrangement shown, as one example, motor 80 of motor assembly 44 of head assembly 24, the motor (not shown) of motor assembly 154 of pump assembly 26, and the motors 236 of motor assemblies 194 of track assemblies 190 (or drive member assemblies 28) are connected by a single electrical cable 380. Single electrical cable 380 is formed of any suitable size, shape, and design and is configured to extend from system 10 to an external electricity source in order to provide electricity to motor 80 of head assembly 24, the motor of motor assembly 154 of pump assembly 26, and the motors 236 of drive member assemblies 28. In the arrangement shown, as one example, the external electricity source could be any source of electricity capable of being electrically connected to single electrical cable 380.

In the arrangement shown, as one example, the single electrical cable 380 extends from the external electricity source, operably connects to control assembly 30, and extends to system 10 in order to operably connect to motor 80 of head assembly 24, the motor of motor assembly 154 of pump assembly 26, and the motors 236 of drive member assemblies 28. In the arrangement shown, as one example, single electrical cable 380 extends to system 10 through the hose system shown in FIGS. 4 and 5 and shown and disclosed in further detail in the '130 application. In the arrangement shown, as one example, the hose system shown in FIGS. 4 and 5 allows electrical cable 380 to extend within the outer hose of the hose system while still being located outside the inner hose of the hose system until the point where hose system reaches system 10. At the point where hose system reaches system 10, electrical cable 380 then extends out of the outer hose of the hose system in order to connect to motor 80 of head assembly 24, the motor of motor assembly 154 of pump assembly 26, and the motors 236 of drive member assemblies 28. In this way, the electrical cable 380 is insulated from the liquid or other material system 10 may be submerged in, while still allowing electricity to flow to system 10.

In the arrangement shown, as one example, it is advantageous to have a single electrical cable 380 rather than multiple electrical cables extending to system 10. This is because if multiple electrical cables are extending to system 10, those electrical cables can and will easily become tangled as system 10 drives around to clean the ground or floor where system 10 is cleaning. If the cables get tangled, system 10 may become stuck, or system 10 will need to be removed from the space where it is cleaning in order for a user to untangle the cables. Because of this, it is advantageous to use single electrical cable 380 in connection with system 10.

### Control Assembly 30:

In the arrangement shown, as one example, system 10 includes control assembly 30. Control assembly 30 is formed of any suitable size, shape, and design and is configured to control operation of system 10 and its components. In the arrangement shown, as one example, control assembly 30 includes a robot control box 384, a pump control box 386, and a remote controller 388, among other components described herein. In the arrangement shown, as one example, control assembly 30, and more specifically, robot control box 384 and pump control box 386 of control assembly 30, is operably connected to the remainder of system 10 through electrical cable 380. That is, electrical cable 380 operably connects to both robot control box 384 and pump control box 386, as well as to system 10, and the commands from control assembly 30 are communicated to various components of system 10 through electrical cable 380.

### Robot Control Box 384:

In the arrangement shown, as one example, control assembly 30 includes a robot control box 384. Robot control box 384 is formed of any suitable size, shape, and design and is configured to control the power delivered to motor 80 of head assembly 24 and the motors 236 of drive member assemblies 28. In the arrangement shown, as one example, robot control box 384 includes a first drive member assembly motor controller 390, a second drive member assembly motor controller 392, and a cleaning attachment motor controller 394.

In the arrangement shown, as one example, robot control box 384 includes first drive member assembly motor controller 390. First drive member assembly motor controller 390 is formed of any suitable size, shape, and design and is configured to control the amount of power delivered to the first drive member assembly 28 which, in the arrangement shown as one example, is first track assembly 190. In the arrangement shown, as one example, first drive member assembly motor controller 390 is configured to receive commands from the remote controller 388 and process those commands, and then increase or decrease the amount of power provided to first drive member assembly 28/first track assembly 190 based on the commands from the remote controller 388. In the arrangement shown, as one example, the amount of power delivered to first drive member assembly 28/first track assembly 190 controls the speed of rotation of first drive member assembly 28/first track assembly 190, which controls the speed and steering of system 10.

In the arrangement shown, as one example, robot control box 384 includes second drive member assembly motor controller 392. Second drive member assembly motor controller 392 is formed of any suitable size, shape, and design and is configured to control the amount of power delivered to the second drive member assembly 28 which, in the arrangement shown as one example, is second track assembly 190. In the arrangement shown, as one example, second drive member assembly motor controller 392 is configured to receive commands from the remote controller 388 and process those commands, and then increase or decrease the amount of power provided to second drive member assembly 28/second track assembly 190 based on the commands from the remote controller 388. In the arrangement shown, as one example, the amount of power delivered to second drive member assembly 28/second track assembly 190 controls the speed of rotation of second drive member assembly 28/second track assembly 190, which controls the speed and steering of system 10.

In the arrangement shown, as one example, robot control box 384 includes cleaning attachment motor controller 394. Cleaning attachment motor controller 394 is formed of any suitable size, shape, and design and is configured to control the amount of power delivered to the cleaning attachment 46 which, in the arrangement shown as one example, is auger member 48. In the arrangement shown, as one example, cleaning attachment motor controller 394 is configured to receive commands from the remote controller 388 and process those commands, and then increase or decrease the amount of power provided to cleaning attachment 46 based on the commands from the remote controller 388. In the arrangement shown, as one example, with cleaning attachment 46 being auger member 48, the amount of power delivered to auger member 48 controls the speed of rotation of shaft 128 and flighting 126 of auger member 48.

In the arrangement shown, as one example, robot control box 384 includes various ammeters 396. Ammeters 396 are formed of any suitable size, shape, and design and are configured to measure and display the amount of current flowing through motor 80 of head assembly 24 and the motors 236 of drive member assemblies 28. In the arrangement shown, as one example, ammeters 396 are digital ammeters, however any other type of ammeter, and any brand or style of ammeter may be used as ammeters 396.

In the arrangement shown, as one example, ammeters 396 help a user determine if there is a problem with system 10, such as something blocking system 10 from moving. In the arrangement shown, as one example, if system 10 is being blocked from moving by an object on the ground or floor where system 10 is located, power is still being provided to drive member assemblies 28 but drive member assemblies 28 are simply spinning and not moving, and this may cause the current flowing through drive member assemblies 28 to spike. The ammeters 396 allow a user to see this spike in current and adjust the controls it is sending to system 10 in order to address the issue.

### Pump Control Box 386:

In the arrangement shown, as one example, control assembly 30 includes a pump control box 386. Pump control box 386 is formed of any suitable size, shape, and design and is configured to control the power delivered to the motor of pump assembly 26. In the arrangement shown, as one example, the amount of power delivered to the motor of pump assembly 26 will control the speed of rotation of the impellers in pump 150. In the arrangement shown, as one example, when impellers in pump 150 spin faster, they pull fluid through head assembly 24 at a faster rate, which helps facilitate the cleaning of the ground or floor where system 10 is located. In the arrangement shown, as one example, there may be situations where a faster rate of pulling fluid through head assembly 24 is required because pulling fluid through head assembly 24 creates stronger suction, so more material, or material which is stuck strongly on the ground or floor where system 10 is located, is able to be pulled through head assembly 24.

### Remote Controller 388:

In the arrangement shown, as one example, control assembly 30 includes remote controller 388. Remote controller 388 is formed of any suitable size, shape, and design and is configured to control the amount of power being delivered to motor 80 of head assembly 24, the motor of motor assembly 154 of pump assembly 26, and the motors 236 of drive member assemblies 28 from a location remote from robot control box 384 and/or pump control box 386. In the arrangement shown, as one example, remote controller 388 is connected to robot control box 384 and pump control box 386 through an electrical cable 398. In the arrangement shown, as one example, remote controller 388 includes four knobs 400, with one knob 400 associated with each of the motor 80 of head assembly 24, the motor of motor assembly 154 of pump assembly 26, the motor 236 of the first drive member assembly 28, and the motor 236 of the second drive member assembly 28. In the arrangement shown, as one example, as the knobs 400 are turned either clockwise or counterclockwise, a command is sent to robot control box 384 or pump control box 386 which will result in more or less power being provided to the motor associated with such knob.

While remote controller 388 has been described according to the arrangement shown, as one example, remote controller 388 is not so limited. In various other arrangements, as examples, remote controller 388 may be connected to robot control box 384 and/or pump control box 386 through wireless communication means. In various arrangements, as examples, remote controller 388 may be a phone, iPad, tablet, computer, or similar device which is in wireless communication with robot control box 384 and/or pump control box 386 and the power supplied to motor 80 of head assembly 24, the motor of motor assembly 154 of pump assembly 26, the motor 236 of the first drive member assembly 28, and the motor 236 of the second drive member assembly 28 may be controlled from the phone, iPad, computer, tablet, or similar device.

### Additional Control Assembly Components:

In one or more arrangements, as examples, control assembly 30 may also include additional components such as sonar and/or a side scan sonar mount. In the arrangement shown, as one example, the sonar and/or side scan sonar mounts are configured to provide information on the position of system 10 when it is in an enclosed space and/or submerged in fluid or other materials. In one or more arrangements, as examples, there are four sonars placed in each of the four corners of a tank in which system 10 will be or is submerged. In the arrangement shown, as one example, the sonars send a signal out and, from that signal, the position of system 10 within the tank can be determined, or at least closely estimated, based on the sonar readings. In this arrangement, as one example, the sonar readings can be sent to a display which will visually display the approximate location of system 10 within the tank.

Additionally or alternatively, in one or more arrangements as examples, control assembly 30 may include a side scan sonar mount. In this arrangement, as one example, the side scan sonar mount is placed at or near the forward end 12 of system 10 and sends out a signal in front of system 10 which will show if there is material located in front of system 10. In this arrangement, the signal from side scan sonar mount can be sent to a display which will visually display what is in front of system 10 and the visual display will show different materials as different colors, depending on the thickness or density of the material. From these different colored shapes a user can determine what it is that is in front of system 10. For example, sludge which should be removed from the floor where system 10 is located may be displayed as, by way of example and not limitation, a dark orange/dark red color while a solid object, such as a concrete wall, may be displayed as, by way of example and not limitation, purple. In this way, the side scan sonar mount can help a user determine which direction to move system 10.

While control assembly 30 and its various components have been described according the arrangement shown, as one example, it will be understood by those skilled in the art that any other configuration of control assembly 30 and its components may be used in order to facilitate the remote operation and control of system 10 and its various components.

### Assembly:

In the arrangement shown, as one example, system 10 is assembled by first assembling the individual components of head assembly 24, pump assembly 26, and drive member assemblies 28, then connecting these together, and connecting the assembled robot to control assembly 30 through single electrical cable 380.

Head Assembly 24: In the arrangement shown, as one example, head assembly 24 is assembled as follows. Frame 42 is connected to motor assembly 44 by fastening first end plate 84 and second end plate 90 of housing 78 of motor assembly 44 to mounting plate 64 of frame 42. Then, motor assembly 44 is connected to cleaning attachment 46 and, more specifically in the arrangement shown as one example, auger member 48. In the arrangement shown, as one example, motor assembly 44 includes gear assembly 82, which is comprised of first sprocket 114, the chain of gear assembly 82, and second sprocket 118. In the arrangement shown, as one example, the adapter 110 of motor 80 is extended through first sprocket 114 and the chain of gear assembly 82 is extended around first sprocket 114 and second sprocket 118. The shaft 128 of cleaning attachment 46 (in this case auger member 48) is then extended through second sprocket 118 and cleaning attachment 46 and motor assembly 44 are operably connected. Additionally, shaft 128 is extended through the openings in the end plates 50 of frame 42 and through bearings 130 of cleaning attachment 46, which are fastened to the end plates 50 of frame 42. In this way, frame 42 is also connected to cleaning attachment 46 and assembly of head assembly 24 is complete.

Pump Assembly 26: In the arrangement shown, as one example, pump assembly 26 is assembled as follows. Pump 150 and motor assembly 154 are connected such that the motor of motor assembly 154 is in operable connection with the impellers of pump 150. Next, motor assembly 154 and pump 150 are lowered onto pump frame 156 and the brackets 182 of pump frame 156 are fastened to a portion of the housing 180 of motor assembly 154. Additionally, exhaust assembly 152 is connected by fastening base plate 170 of exhaust assembly 152 to upper plate 166 of pump 150, thereby placing exhaust assembly 152 and outlet 164 of pump 150 in fluid connection. With pump 150, exhaust assembly 152, motor assembly 154, and pump frame 156 in operable connection with one another, the assembly of pump assembly 26 is complete.

Drive Member Assemblies 28: In the arrangement shown, as one example, drive member assemblies 28 are assembled as follows. Motor assembly 194 is connected to frame 192 by fastening first end plate 240 and second end plate 246 of housing 234 to exterior wall 202 of frame 192. Then drive wheel 346 of track system 196 is positioned such that the opening 356 of drive wheel 346 is in alignment with first opening 210 of interior wall 200 of frame 192 and with first opening 220 of exterior wall 202 of frame 192. Then the axle 358 of drive wheel 346 is extended through each of the second sprocket 276 of gear assembly 238 of motor assembly 194, the opening 356 of drive wheel 346, the first opening 210 of interior wall 200, the first opening 220 of exterior wall 202, and the openings of bearings 360, and bearings 360 can be fastened to the interior wall 200 and the exterior wall 202. Once this is completed, the drive wheel 346 is operably connected to frame 192 and motor assembly 194.

Next, track 348 of track system 196 is extended around drive wheel 346 and idler wheel 350, and idler wheel 350 of track system 196 is positioned such that the opening 372 of idler wheel 350 is in alignment with a portion of first slot 214 of interior wall 200 of frame 192 and with first slot 224 of exterior wall 202 of frame 192. Idler wheel 350 can then be adjusted along the length of first slot 214 of interior wall 200 and first slot 224 of exterior wall 202 in order for track 348 to be extended tightly around drive wheel 346 and idler wheel 350. Once track 348 is tightly extended around drive wheel 346 and idler wheel 350, the axle 374 of idler wheel 350 can be extended through each of the opening 372 of idler wheel 350, the first slot 214 of interior wall 200 and first slot 224 of exterior wall 202, and through the openings of bearings 376 of idler wheel 350, and the bearings 376 can be fastened to interior wall 200 and exterior wall 202 at the proper position for track 348 to be extended tightly around drive wheel 346 and idler wheel 350.

System 10: Once head assembly 24, pump assembly 26, and drive member assemblies 28 have been individually assembled, they can be brought together to form system 10. In the arrangement shown, as one example, head assembly 24 and pump assembly 26 are assembled by aligning outlet pipe 62 of frame 42 of head assembly 24 with inlet 162 of pump 150 of pump assembly 26 and connecting the flange 74 of second end 72 of outlet pipe 62 to inlet 162 through any means of connection including, but not limited to welding, screwing, bolting, adhesion, friction fitting, or any other means of connection. In this way, head assembly 24 and pump assembly 26 are operably connected.

Next, pump assembly 26 and drive member assemblies 28 can be connected by connecting pump frame 156 to the interior wall 200 of frame 192 of track assemblies 190/drive member assemblies 28 through any means of connection including, but not limited to welding, screwing, bolting, adhesion, friction fitting, or any other means of connection.

Finally, head assembly 24 and drive member assemblies 28 are connected by bolting, screwing, fastening, or otherwise connecting connection plates 65 of frame 42 of head assembly 24 to interior wall 200 of frame 192 of each of the track assemblies 190/drive member assemblies 28.

Control Assembly 30: With head assembly 24, pump assembly 26, and drive member assemblies 28 operably connected to each other, single electrical cable 380 is then operably connected to each of motor 80 of head assembly 24, the motor of motor assembly 154 of pump assembly 26, and the motors 236 of drive member assemblies 28. With single electrical cable 380 in operably connection with each of these motors, single electrical cable 380 can then be connected to the robot control box 384 and pump control box 386 of control assembly 30. Additionally, remote controller 388 can be connected to robot control box 384 and pump control box 386 through electrical cable 398. In this way, each of the components of head assembly 24, pump assembly 26, and drive member assemblies 28 are physically connected and also communicatively connected to control assembly 30 and system 10 is ready to operate.

### In Operation:

System 10 may be operated through the use of control assembly 30. In the arrangement shown, as one example, control assembly 30 includes controller assembly 388 with knobs 400, and each knob 400 is associated with one of the motor 80 of head assembly 24, the motor of motor assembly 154 of pump assembly 26, the motor 236 of the first drive member assembly 28, and the motor 236 of the second drive member assembly 28. By way of example and not limitation, when system 10 is stationary and the user desires to move system 10, the user can rotate the knob 400 associated with the motor 236 of the first drive member assembly 28 and the knob 400 associated with the second drive member assembly 28 clockwise. When the user rotates these knobs 400 clockwise, a signal to provide power to the motors 236 of first and second drive member assemblies 28 is sent to the first drive member assembly motor controller 390 and the second drive member assembly motor controller 392 of robot control box 384. When the first drive member assembly motor controller 390 and the second drive member assembly motor controller 392 receive this signal, they increase the amount of electricity sent to the motors 236, which will cause the motors 236 to rotate the drive shaft 264 of each motor 236. As each of the drive shafts 264 rotate, the adapters 266 of each motor 236 will also rotate, causing first miter gear 284 of gear box housing 270 for both first and second drive member assemblies 28 to rotate. As first miter gear 284 rotates, second miter gear 286 is caused to rotate as well, which in turn causes rotation of shaft 288 of gear box housing 270. As shaft 288 rotates, first sprocket 272 of gear assembly 238 for each of the first and second drive member assemblies 28 rotate, which causes rotation of the chain of gear assembly 238 and second sprocket 276 of gear assembly 238. When second sprocket 276 of gear assembly 238 of each of the first and second drive members 28 rotate, this causes rotation of the axles 358 of drive wheel 346 of track system 196 for each of the first and second drive members 28 (i.e. track assemblies 190) to rotate as well. As the axles 358 of drive wheel 346 rotate, so do the drive wheels 346 for each of the first and second drive members 28. As the drive wheels 346 rotate, the teeth 354 of drive wheels 346 engage the inner teeth of tracks 348, which in turn engage the teeth 370 of idler wheels 350. As teeth 354 of drive wheels 346 engage inner teeth of tracks 348, tracks 348 begin to rotate and the outer teeth of tracks 348 engage the ground or floor where system 10 is located, causing system 10 to move.

In the arrangement shown, as one example, when a user desires to turn system 10, the user can increase or decrease the speed of rotation of one of the first or second drive member assemblies 28 by rotating the knob 400 associated with the motor 236 of such first or second drive member assembly 28 clockwise or counterclockwise. As the speed of rotation of one of the first or second drive member assemblies 28 is sped up or slowed down while the speed of rotation of the other first or second drive member assembly stays constant, the difference in speed or rotation will cause system 10 to turn. As an example, if the first drive member assembly 28 is located on the left side of system 10 and second drive member assembly 28 is located on the right side of system 10 and the user desires system 10 to turn left, the user can either slow down the rate of rotation of the first drive member assembly 28, or speed up the rate of rotation of the second drive member assembly 28, or both, resulting in second drive member assembly 28 rotating faster than first drive member assembly 28. This difference in rotation will cause the right side of system 10 to move faster than the left side of system 10, which will cause system 10 to turn to the left. Likewise, if the user wanted to turn system 10 to the right, the user can either slow down the rate of rotation of the second drive member assembly 28, or speed up the rate of rotation of the first drive member assembly 28, or both, resulting in the first drive member assembly 28 rotating faster than second drive member 28. This difference in rotation will cause the left side of system 10 to move faster than the right side of system 10, which will cause system 10 to turn to the right.

In the arrangement shown, as one example, if the user wants to speed up the rate at which system 10 is moving, the user can further rotate the knob 400 associated with the motor 236 of the first drive member assembly 28 and the knob 400 associated with the second drive member assembly 28 clockwise. As the knobs 400 are rotated further clockwise, a signal to provide more power to the motors 236 of first and second drive member assemblies 28 is sent to the first drive member assembly motor controller 390 and the second drive member assembly motor controller 392 of robot control box 384. This signal or command is processed by the first drive member assembly motor controller 390 and the second drive member assembly motor controller 392, respectively, and the first drive member assembly motor controller 390 and the second drive member assembly motor controller 392 operate to increase the amount of electricity sent to the motors 236, which will cause the motors 236 to rotate the drive shaft 264 of each motor 236 faster. This will, in turn, cause the first and second drive member assemblies 28 to rotate faster, which will cause system 10 to move faster.

Likewise, if the user wants to slow down the rate at which system 10 is moving, the user can rotate the knob 400 associated with the motor 236 of the first drive member assembly 28 and the knob 400 associated with the second drive member assembly 28 counterclockwise. As the knobs 400 are rotated counterclockwise, a signal to provide less power to the motors 236 of first and second drive member assemblies 28 is sent to the first drive member assembly motor controller 390 and the second drive member assembly motor controller 392 of robot control box 384. This signal or command is processed by the first drive member assembly motor controller 390 and the second drive member assembly motor controller 392, respectively, and the first drive member assembly motor controller 390 and the second drive member assembly motor controller 392 operate to decrease the amount of electricity sent to the motors 236, which will cause the motors 236 to rotate the drive shaft 264 of each motor 236 slower. This will, in turn, cause the first and second drive member assemblies 28 to rotate slower, which will cause system 10 to move slower. And, if the user wants to stop movement of system 10 altogether, the user can rotate the knob 400 associated with the motor 236 of the first drive member assembly 28 and the knob 400 associated with the second drive member assembly 28 back to their original, neutral positions. This will signal to first drive member assembly motor controller 390 and the second drive member assembly motor controller 392 of robot control box 384 to stop providing power to the motors 236 of drive member assemblies 28, which will cause drive member assemblies 28 to stop rotating and system 10 will be stopped.

In the arrangement shown, as one example, when system 10 is in use and the user wants to clean the floor or ground of an area or enclosed space, the user can rotate the knob 400 associated with the motor 80 of head assembly 24 and the knob 400 associated with the motor of motor assembly 154 of pump assembly 26. In the arrangement shown, as one example, when the user rotates the knob 400 associated with motor 80 of head assembly 24, a signal to provide power to motor 80 will be sent to cleaning attachment motor controller 394 of robot control box 384. This signal or command is processed by the cleaning attachment motor controller 394 and the cleaning attachment motor controller 394 operates to increase the amount of electricity sent to motor 80, which will cause motor 80 to rotate the drive shaft 108 of motor 80 to rotate. As the drive shaft 108 rotates, the adapter 110 of motor 80 also rotates, causing first sprocket 114 of gear assembly 82 of motor assembly 44 to rotate. The rotation of first sprocket 114 causes the rotation of the chain of gear assembly 82 and second sprocket 118 of gear assembly 82. As second sprocket 118 rotates, shaft 128 of cleaning attachment 46 is caused to rotate. In the arrangement shown, as one example, as shaft 128 rotates, flighting 126 of auger member 48 also rotates, which causes waste material on the ground or floor where system 10 is operating to move inward and towards the opening 66 in rear plate 60 of frame 42 of head assembly 24. In the arrangement shown, as one example, when the waste material is moved toward opening 66, it is ready to be pulled through outlet pipe 62, and this suction force to pull the material through outlet pipe 62 is provided by pump 150. The rotation of flighting 126 of auger member 48 will continue until motor 80 is turned off, which is caused by the user rotating the knob 400 associated with motor 80 of head assembly 24 to its original position.

In the arrangement shown, as one example, when the user rotates the knob 400 associated with motor of motor assembly 154 of pump assembly 26, pump 150 operates to pull fluid, as well as the waste material moved by flighting 126 of auger member 48, through outlet pipe 62 and into pump 150. In the arrangement shown, as one example, when the user rotates the knob 400 associated with the motor of motor assembly 154 of pump assembly 26, a signal to provide power to the motor of motor assembly 154 is sent to the pump control box 386. This signal or command is processed by the pump control box 386 and the pump control box 386 operates to increase the amount of electricity sent to the motor of motor assembly 154, which will cause the shaft of the motor to rotate. In the arrangement shown, as one example, the shaft of the motor of motor assembly 154 is operably connected to the impellers of pump 150 such that when the shaft of the motor of motor assembly 154 rotates, the impellers of pump 150 also rotate. When the impellers of pump 150 rotate, the impellers move fluid and waste material entering pump 150 through inlet 162 outward toward the interior walls of pump 150 and eventually out of pump 150 through outlet 164 of pump 150. As the material moves out of pump 150, more fluid is pulled through the opening 66 in rear plate 60 of frame 42, through outlet pipe 62, and into pump 150 through inlet 162. Once the fluid and other waste material is pulled in through inlet 162, the impellers continue to operate (rotate) as described above and pump 150 continues to pull material through head assembly 24 until the motor of motor assembly 154 of pump assembly 26 is turned off due to the user rotating the knob 400 associated with the motor of motor assembly 154 to its original position.

There may be times when the pull of fluid and waste material through head assembly 24 is desired to be slower or faster, and times when the speed at which auger member 48 rotates is desired to be higher or lower. The user can control the speed or rotation of the auger member 48, and the speed at which the impellers of pump 150 rotate (thereby affecting how fast or slow fluid and waste material is pulled through head assembly 24). In order to effectuate this, the user can simply rotate the knob 400 associated with motor 80 of head assembly 24 clockwise (if faster rotation is desired) or counterclockwise (if slower rotation is desired) in order to control the speed of rotation of auger member 48. This will send a signal to the cleaning attachment motor controller 394 of remote control box 384 to increase or decrease the amount of electricity sent to motor 80, thereby increasing or decreasing the rate of rotation of auger member 48.

Likewise, the user can rotate the knob 400 associated with the motor of motor assembly 154 of pump assembly 26 clockwise (if faster pull of fluid and waste material through head assembly 24 is desired) or counterclockwise (if slower pull of fluid and waste material through head assembly 24 is desired). This will send a signal to pump control box 386 to increase or decrease the among of electricity sent to the motor of motor assembly 154, thereby increasing or decreasing the rate of rotation of the impellers in pump 150, which will increase or decrease the rate at which fluid and waste material is pulled through head assembly 24.

Once the user is done cleaning the floor or ground of an enclosed system or other space, the user can turn off auger member 48 by rotating the knob 400 associated with motor 80 of head assembly 24 to its original position. Additionally, the user can turn off pump 150, thereby stopping fluid and waste material from being pulled through head assembly 24, by rotating the knob 400 associated with the motor of motor assembly 154 to its original position. If system 10 is submerged in a liquid or other material, system 10 can be navigated back to a position where system 10 can be retrieved and removed from the material. In the arrangement shown, as one example, this can be done by moving and steering system 10 using first and second track assemblies 190 (i.e. first and second drive member assemblies 28) through the method of operation with control assembly 30 as described previously herein. Once system 10 is at the desired retrieval position, system 10 can be retrieved and either taken away or stored, as desired.

### Alternative Arrangement:

In an alternative arrangement, as one example, system 10 may be used to clean out a pipe. In various arrangements, as examples, the pipe may have liquid within it and system 10 may include head assembly 24 (which, by way of example and not limitation, may be auger member 48), pump assembly 26, drive member assemblies 28, and control assembly 30 as described herein. However, in various other arrangements, as examples, the pipe may have solid, or primarily solid, waste material, rather than liquid, within it and system 10 will not be submerged. In this arrangement, system 10 may be used without pump assembly 26, as described herein. That is, pump assembly 26 may be removed (or simply not attached) to head assembly 24 and drive member assemblies 28, and in its place a hose system may be attached to head assembly 24, which provides suction to pull material (liquid, gas, solids, fluid, air, waste material, etc.) through cleaning attachment 46. The hose system may be a suction hose attached at one end to head assembly 24 and at its other end to a vacuum truck, a pump, or any other mechanism capable of providing the suction to pull material (liquid, gas, solids, fluid, air, waste material, etc.) through cleaning attachment 46. In this arrangement, the system 10 connected to the hose system can enter into the pipe and the hose system will provide the suction to remove the waste material from the pipe.

In one or more arrangements, as examples, a camera may also be provided on system 10. The camera may be formed of any suitable size, shape, and design and is configured to allow a user to view the interior of the pipe and inspect the pipe while system 10 may or may not be cleaning the pipe at the same time. In this arrangement, as one example, the camera is configured to be controlled through a control assembly, such as control assembly 30, and the camera may be maneuvered while system 10 is in the pipe. That is, the camera may be moved side to side, up and down, or in any direction which allows the user to inspect the interior of the pipe while system 10 is in the pipe. In one or more arrangements, as examples, the camera may also create light (visible light, infrared light, or any other type of light) which allows a user to see the interior of the pipe despite no (or very little) ambient lighting available within the pipe. In this arrangement, as one example, placing a camera on system 10 when system 10 is inserted into a pipe allows system 10 to be used simultaneously, or separately, as a clean-out robot and an inspection robot for the pipe. The simultaneous, or separate, use of a robot as a clean-out robot and an inspection robot for a pipe is a new, novel, and advantageous configuration which system 10 is capable of providing.

From the above discussion it will be appreciated that the system 10 presented herein improves upon the state of the art. Specifically, in one or more arrangements, a system 10 is presented which: improves upon the state of the art; is safe to operate; is relatively easy to build; is relatively friendly to build; can be built relatively quickly and efficiently; is easy to operate; is relatively cost friendly to manufacture; is relatively easy to transport; is aesthetically appealing; is robust; is relatively inexpensive; is not easily susceptible to wear and tear; has a long useful life; is efficient to use and operate.

What is claimed:

1. A submersible robot system comprising:
a pump assembly;
the pump assembly having a motor;
a head assembly;
the head assembly having a motor;
a first drive member assembly;
the first drive member assembly having a motor;
a second drive member assembly;
the second drive member assembly having a motor;
wherein the pump assembly is configured to pull material through the head assembly;
wherein the first drive member assembly and the second drive member assembly are configured to drive the submersible robot around a floor of an enclosed system thereby cleaning the floor of the enclosed system;
wherein the submersible robot system is configured to enter the enclosed system through an opening in a wall of the enclosed system.

2. The system of claim 1, wherein the opening in the wall of the enclosed system is circular and the opening is 24 inches in diameter.

3. The system of claim 1, wherein the motor of the pump assembly is sealed within a housing.

4. The system of claim 1, wherein the motor of the head assembly is sealed within a housing.

5. The system of claim 1, wherein the motor of the first drive member assembly is sealed within a housing.

6. The system of claim 1, wherein the motor of the second drive member assembly is sealed within a housing.

7. The system of claim 1, wherein a single electrical cable provides power to each of the motor of the pump assembly, the motor of the head assembly, the motor of the first drive member assembly, and the motor of the second drive member assembly.

8. The system of claim 1, wherein the motor of the first drive member includes a drive shaft and the motor of the second drive member includes a drive shaft;
wherein an axis of rotation of the drive shaft of the motor of the first drive member is perpendicular to an axis of rotation of the first drive member; and
wherein an axis of rotation of the drive shaft of the motor of the second drive member is perpendicular to an axis of rotation of the second drive member.

9. The system of claim 1, wherein the pump assembly is removably attached to each of the head assembly, the first drive member, and the second drive member; and wherein when the pump assembly is removed from the head assembly, the first drive member, and the second drive member, a hose may be attached to the head assembly in order to pull material through the head assembly.

10. The system of claim 1, further comprising:
a controller assembly;
wherein the controller assembly is configured to control operation of the submersible robot.

11. The system of claim 1, further comprising:
a hose system;
the hose system having an inner hose;
the hose system having an outer hose;
wherein the inner hose is positioned within the outer hose;
wherein a single electrical cable extends through the hose system;
wherein the single electrical cable is at least partially positioned outside the inner hose and within the outer hose;
wherein the inner hose is configured to fluidly connect to the pump assembly;
wherein the outer hose is configured to be filled with a gas to allow the hose system to be at least partially buoyant.

12. A submersible robot system comprising:
a pump assembly;
the pump assembly having a motor;
a head assembly;
the head assembly having a motor;
a first drive member assembly;
the first drive member assembly having a motor;
a second drive member assembly;
the second drive member assembly having a motor;
wherein the pump assembly is configured to pull material through the head assembly;
wherein the first drive member assembly and the second drive member assembly are configured to drive the submersible robot around a floor of an enclosed system thereby cleaning the floor of the enclosed system;
wherein the submersible robot system is configured to enter the enclosed system through a 24-inch diameter opening in a wall of the enclosed system.

13. The system of claim 12, wherein the motor of the pump assembly is sealed within a first housing, the motor of the head assembly is sealed within a second housing, the motor of the first drive member assembly is sealed within a third housing, and the motor of the second drive member assembly is sealed within a fourth housing.

14. The system of claim 12, wherein a single electrical cable provides power to each of the motor of the pump assembly, the motor of the head assembly, the motor of the first drive member assembly, and the motor of the second drive member assembly.

15. The system of claim 12, wherein the motor of the first drive member includes a drive shaft and the motor of the second drive member includes a drive shaft;
wherein an axis of rotation of the drive shaft of the motor of the first drive member is perpendicular to an axis of rotation of the first drive member; and
wherein an axis of rotation of the drive shaft of the motor of the second drive member is perpendicular to an axis of rotation of the second drive member.

16. The system of claim 12, wherein the pump assembly is removably attached to each of the head assembly, the first drive member, and the second drive member; and wherein when the pump assembly is removed from the head assembly, the first drive member, and the second drive member, a hose may be attached to the head assembly in order to pull material through the head assembly.

17. The system of claim 12, further comprising:
a controller assembly;
wherein the controller assembly is configured to control operation of the submersible robot.

18. The system of claim 12, further comprising:
a hose system;
the hose system having an inner hose;
the hose system having an outer hose;
wherein the inner hose is positioned within the outer hose;
wherein a single electrical cable extends through the hose system;
wherein the single electrical cable is at least partially positioned outside the inner hose and within the outer hose;
wherein the inner hose is configured to fluidly connect to the pump assembly;
wherein the outer hose is configured to be filled with a gas to allow the hose system to be at least partially buoyant.

19. A submersible robot system comprising:
a pump assembly;
the pump assembly having a motor;
a head assembly;
the head assembly having a motor;
a first drive member assembly;
the first drive member assembly having a motor;
a second drive member assembly;
the second drive member assembly having a motor;
wherein a single electrical cable provides electricity to each of the motor of the pump assembly, the motor of the head assembly, the motor of the first drive member assembly, and the motor of the second drive member assembly;
wherein the pump assembly is configured to pull material through the head assembly;
wherein the first drive member assembly and the second drive member assembly are configured to drive the submersible robot around a floor of an enclosed system thereby cleaning the floor of the enclosed system;
wherein the submersible robot system is configured to enter the enclosed system through an opening in a wall of the enclosed system.

20. The system of claim 19, wherein the opening in the wall of the enclosed system is circular and the opening is 24 inches in diameter.

21. The system of claim 19, wherein the motor of the pump assembly is sealed within a first housing; the motor of the head assembly is sealed within a second housing; the motor of the first drive member assembly is sealed within a third housing; and the motor of the second drive member assembly is sealed within a fourth housing.

22. The system of claim 19, wherein the motor of the first drive member includes a drive shaft and the motor of the second drive member includes a drive shaft;
wherein an axis of rotation of the drive shaft of the motor of the first drive member is perpendicular to an axis of rotation of the first drive member; and
wherein an axis of rotation of the drive shaft of the motor of the second drive member is perpendicular to an axis of rotation of the second drive member.

23. The system of claim 19, wherein the pump assembly is removably attached to each of the head assembly, the first drive member, and the second drive member; and wherein when the pump assembly is removed from the head assembly, the first drive member, and the second drive member, a hose may be attached to the head assembly in order to pull material through the head assembly.

24. The system of claim 19, further comprising:
a controller assembly;
wherein the controller assembly is configured to control operation of the submersible robot.

25. The system of claim 19, further comprising:
a hose system;
the hose system having an inner hose;
the hose system having an outer hose;
wherein the inner hose is positioned within the outer hose;
wherein the single electrical cable extends through the hose system;
wherein the single electrical cable is at least partially positioned outside the inner hose and within the outer hose;
wherein the inner hose is configured to fluidly connect to the pump assembly;
wherein the outer hose is configured to be filled with a gas to allow the hose system to be at least partially buoyant.
